(19) United States
(12) Patent Application Publication
(10) Pub. No.: US 2007/0198547 A1
(43) Pub. Date: Aug. 23, 2007

(54) Computational device for the management of sets

(76) Inventors: Suzanne Joy Sullivan, Auckland (NZ); David Gray Hughes, Auckland (NZ); Adrian Laurence Meekings, Auckland (NZ); Michael James Blyth, Auckland (NZ)

Correspondence Address: MCDERMOTT, WILL & EMERY LLP, 227 WEST MONROE STREET, CHICAGO, IL, 60606-5096, US

(21) Appl. No.: 11/542,067

(22) Filed: Oct. 2, 2006

Related U.S. Application Data
(60) Provisional application No. 60/722,896, filed on Sep. 30, 2005.

(51) Int. Cl. G06F 7/00

(52) U.S. Cl. 707/100

(57) ABSTRACT

A data storage system or structure is provided representing a number of sets of data storage locations. Each set has a parent set identifier and contains a linked list of child storage locations. When used as a memory storage with a computationally complete environment in the invention provides protection against attacks from unauthorized users.

The present invention claims priority to U.S. Provisional Patent Application No. 60/722,896, filed Sep. 30, 2005.

### TECHNICAL FIELD

This invention relates to Computer Science and has applications in Information and Communication Technology (ICT). The invention is particularly suited for systems that require storage and retrieval of set structures founded on Set Theory. Sets can be applied in diverse applications such as XML, filing systems, databases and mathematical constructs evaluated with computational systems.

### BACKGROUND

Set Theory was developed by Gregory Cantor almost 300 years ago. It forms a foundation of mathematics and is a useful mechanism for modelling information systems. There are many versions of Set Theory, each with varying axioms that create subtly different universes with different properties. The present invention uses a unique set of axioms that are optimized for the manipulation of sets from a computational perspective. The invention allows for the storage of sets as well as managing instructions to manipulate their contents.

### OBJECT OF THE INVENTION

It is an object of the invention to provide a computational device or data structure or method of manipulating data that provides advantages over known apparatus or techniques. Alternatively it is an object of the invention to provide a useful alternative to known apparatus or techniques.

### SUMMARY

In one aspect the invention provides a computational device including a data manipulation and/or storage structure representing a plurality of sets of data storage locations, each set having a parent set identifier and containing a linked list of one or more child storage locations wherein each parent set identifier references a child storage locations in the set, and wherein each child storage location can reference its parent storage location.

Preferably, each parent set identifier references a plurality of markers that each reference a single child storage location.

In a preferred embodiment an interface is provided that can manipulate data storage locations by means of a marker.

Each parent set identifier may be capable of attaching primitive data structures or files.

The data manipulation may trigger events.

In another aspect the invention provides a data structure representing a plurality of sets of data storage locations, each set having a parent set identifier and containing a linked list of one or more child storage locations wherein each parent set identifier references a child storage locations in the set, and wherein each child storage location can reference its parent storage location.

Preferably, each parent set identifier references a plurality of markers that each reference a single child storage location.

The invention can be used in conjunction with other circuits to produce useful computational processes for the manipulation of sets. The invention can be used for constructing compilers for an Interoperable Information Infrastructure model (III-model), storage mechanisms, educational and experimental mathematical systems. These systems can be used to deliver products and generate revenue.

### INTROSPECTIVE SCOPE OF EXECUTION

The unique mathematics of the invention is derived from Set Theory to provide total protection against attack when used with a computationally complete environment that utilizes the invention as its memory store. If the software is required to communicate with other software, it can perform this communication across a single set. The software is then required to take additional steps to prevent this communication from posing any risk. This mechanism is known as a Reference Membrane. Introspective scope of execution prevents software from accessing other software for which it does not contain a reference—a property exhibited from the hardware itself.

The invention has only one instruction to obtain a new reference (known as Get-Child and is described further below), which retrieves a specified Child set from within a Parent set. There is absolutely no instruction to retrieve the reference to a Parent set even though these sets may exist privately and in plurality in the invention.

The set structure according to a preferred embodiment of the invention is referred to herein as the Manabars-Set. It provides a foundation mathematical structure that can be used as a generic container to hold any kind of information. Furthermore, the Manabars-Set is super-symmetric, meaning that there is no logical limit to the amount of data that it can hold, or the number of relationships that may exist between any sets. The mechanics of the Manabars-Set provides an efficient way of structuring information to help reduce complexity and increase productivity for developers and users of software.

The invention is an abstract design of a circuit that can be implemented in a number of ways in software, CMOS, FPGA or other exotic computational environments such as Spintronics™, Quantum Computing or biological computers.

The invention communicates with other external components via a series of buses known as the KI-Interface. Each KI-Interface bus allows the sets contained within the invention to be manipulated by an external circuit utilizing the bus.

The bus operates by sending a continuous stream of instructions to the invention. Each instruction on the bus may have numerous parameters and returns.

The invention starts up with a single set known as the Powerset. By using the KI-Interface repeatedly, an image can be pre-installed. During implementation, the invention can be modified at several points to allow for the fast loading of pre-existing images instead of using the KI-Interface.

### BRIEF DESCRIPTION OF THE DRAWINGS

An embodiment of the invention will be described by way of example further below with reference to the accompanying drawings. Attached hereto as Appendix D is a description of the conventions used in the Figures.

FIG. 1 shows the preferred embodiment of the invention also known as the Kernel-Image. The Kernel-Image (2800) is accessed by the KI-Interface (2810). In this embodiment, the KI-Interface has 6 high priority channels (2870a-f) and 6 low priority channels (2875a-f). It also has a Backplane-Bus (2900) to allow instructions to flow between Isolated-Memory-Segments (2910a-c).

FIG. 2 shows the Manabars-Set is composed of four basic structures. The Parent-Identification holds the set data, the Cursor-Identification marks the Cursor position, the Child-Identification locates the associated Parent for that Child and the Proxy-Identification is a structure to manage dynamic manipulation of the link lists.

FIG. 3 shows the Parent-Identification links to the Cursor-Identification and the Child-Identification only. It contains four fields being the Leftmost-Cursor-Handle, the Rightmost-Cursor-Handle, the Leftmost-Child-Handle and the Rightmost-Child-Handle. It also contains the content associated with this Parent. In the preferred embodiment, this content contains primitives such as a 64-bit integer or a 64-bit floating-point number.

FIG. 4 shows the Child-Identification is a linked list structure of Children sets that maintains ordering.

FIG. 5 shows the Proxy-Identification links to the Cursor-Identification and the Child-Identification. It is useful for tracking connectivity through such instructions as the deletion of a Child from a Parent that could lead to Cursor-Identifications sharing a single. Child.

FIG. 6 shows the Cursor-Identification that contains the Left-Cursor-Handle and the Right-Cursor Handle that make it form part of a linked list of Cursor-Identifications inside a single Parent. The Parent-Handle-Port is able to locate the Parent-Identification of the Child to which it points. It is also able to locate the appropriate Proxy-Identification so that it can locate other Cursor-Identifications or Child-Identifications.

FIG. 7 shows the Cursor-Identification-Content (4000) that is used to manage the CUI-Monitor-Event (4010). It also shows the Proxy-Identification-Content (4020) that holds the Proxy-Size (4030).

FIG. 8 shows the Child-Identification-Content (4200) that holds the CHI-Monitor-Event (4210) and the Left-Index (4220).

FIG. 9 shows the Parent-Identification-Content (4400) that holds the primitives that are attached to the set as well as additional indexing information.

FIG. 10 shows an arbitrary Manabars-Set (4800) in a manner that highlights how the handles reference elements of the set.

FIG. 11 shows a single Manabars-Set (5000) that can have 3 Monitor-Events (5100) attached at the PI-Monitor-Event (5015), CHI-Monitor-Event (5025) and CUI-Monitor-Event (5035).

FIG. 13 shows a UPT-Monitor-Generator (5400) that is used to capture the state of a single KI-Interface method call.

FIG. 14 shows the MG-Capture-Instance (5600) that is used to assist the UPT-Monitor-Generator.

FIG. 16 shows a physical deployment of the Kernel-Image that includes the KI-Interface to enable access to the KI-Memory via Cursor-Identifications.

FIG. 17 shows the structure of a Monitor, used to trigger events.

### DETAILED DESCRIPTION

Although this invention is described by way of example and with reference to possible embodiments thereof, it is to be understood that modifications or improvements may be made thereto without departing from the scope of the invention.

An exemplary embodiment of the invention is when it operates as a memory store of sets founded on Set Theory and is likely to be housed within a more complex machine.

The invention provides a dynamic container for a special variety of sets which are referred to herein as Manabars-Sets. The Manabars-Set is a mechanical structure to represent a variant of Set Theory in a computational form that is flexible enough to achieve computational completeness but yet preserve scope as inherited from Set Theory.

The Manabars-Set structure is optimized for implementation through the use of array structures, which are readily available on computing platforms with sequential addressable memory. The Manabars-Set is representative only of the idealistic set structure alone and does not include the mathematical operators such as Union and Intersection. These operators are required to be derived at another level through the use of a program and are outside the scope of the Manabars-Set.

The Manabars-Set deviates from traditional Set Theory as originally outlined by Gregory Cantor. The Manabars-Set can contain any number of Children sets and any Child can be repeated any number of times. Furthermore, Children are arranged sequentially from one pole to the other and are referred from Left to Right.

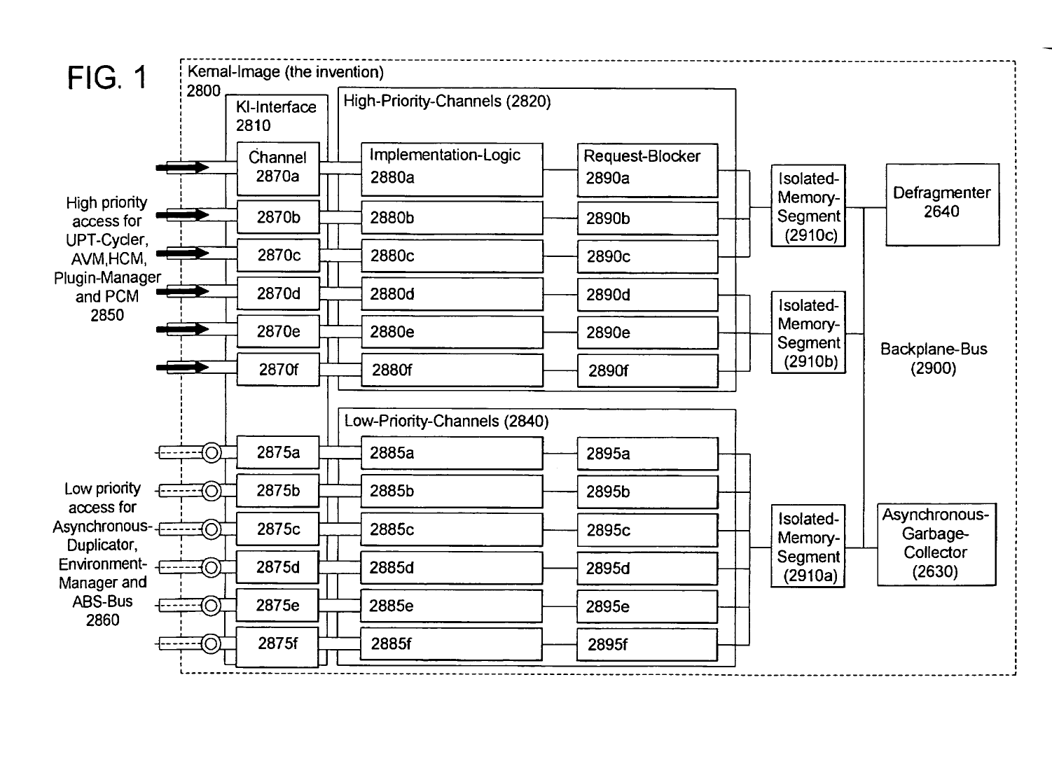

In order to enable efficient computability of the Manabars-Set, individual Children are identified through the use of an element having the ability to act as a marker or pointer, which we refer to in this document as a Cursor. A single Cursor will point to a single Child that belongs to a single Parent. A preferred embodiment of the Manabars-Set enables a system that has access to Cursor references and is not able to alter the Parents or Children directly. However, a single Parent may have any number of Cursors. The invention utilizes the KI-Interface (2810 of FIG. 1) to allow alteration to the structure using the Cursor references alone. This interface will allow for the manipulation of the Manabars-Set through method calls such as shifting a Cursor to the Leftmost position (see Appendix A). A preferred embodiment of the invention would implement these method calls and alter the array structures that represent the Manabars-Set directly.

The Manabars-Set

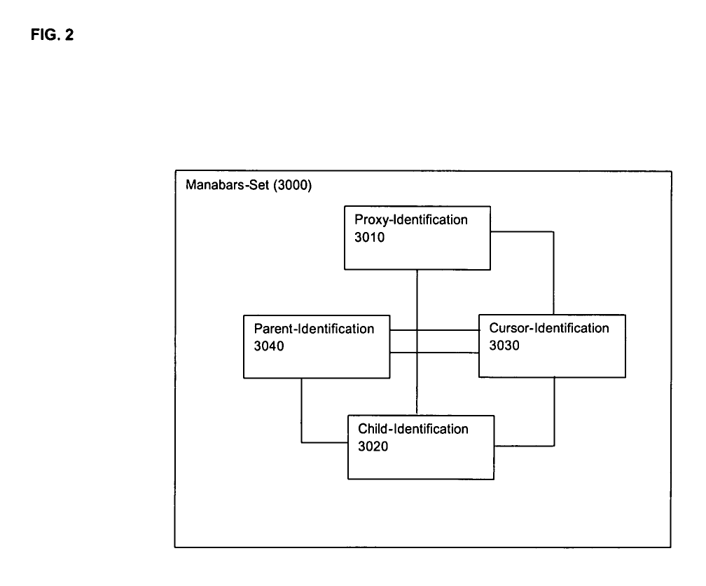

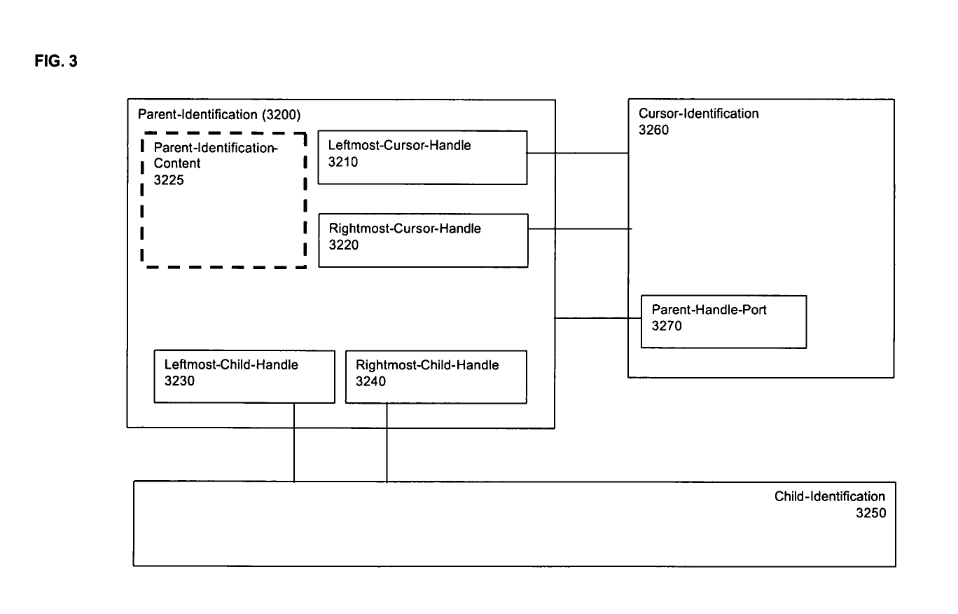

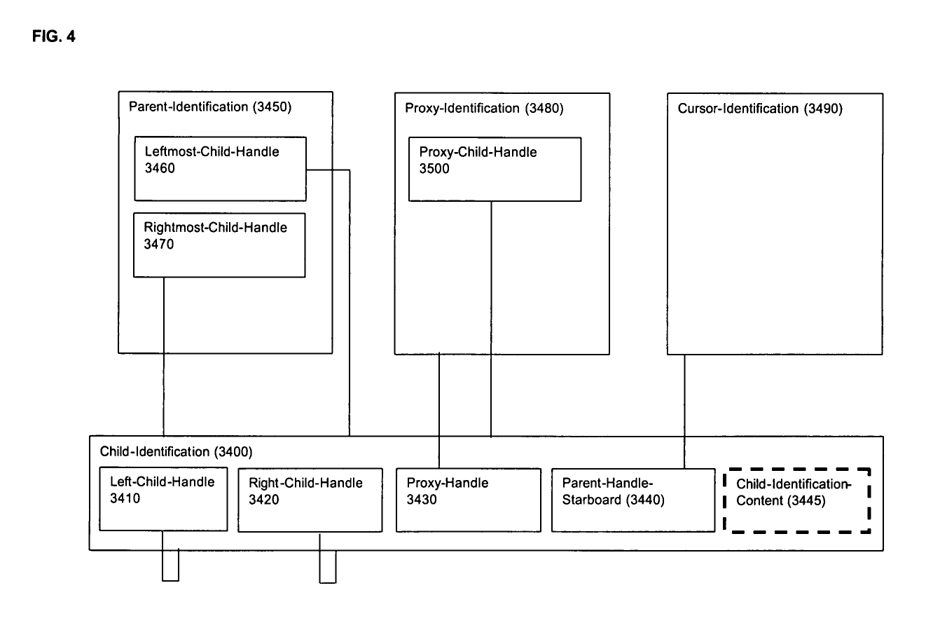

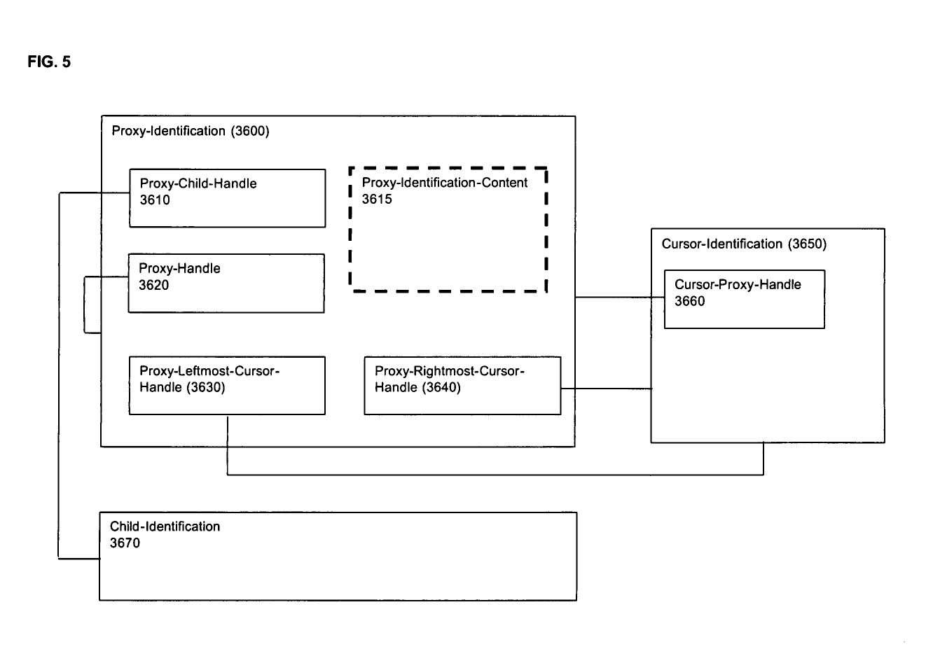

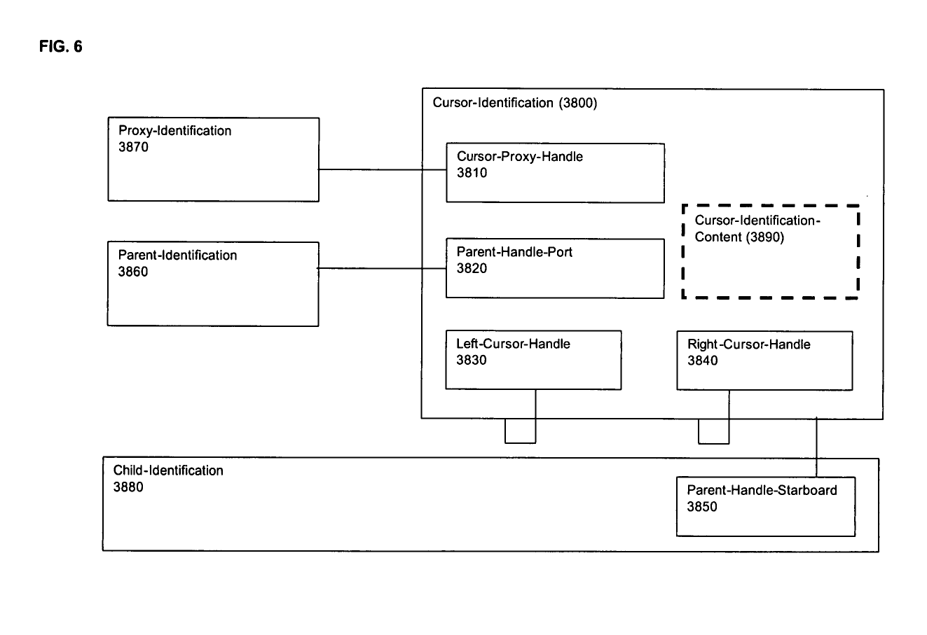

The Manabars-Set (3000 of FIG. 2) is the fundamental and only data type used by the invention (2800 of FIG. 1) to store and represent all information. A unique handle identifies each Manabars-Set. Although a Manabars-Set can be thought of abstractly as a unique entity, it is actually related to other Manabars-Sets in the invention in complex ways. The structure of the Manabars-Set is made up of 4 individual structures which each have their own values and links. These structures are the Cursor-Identification (3030 of FIG. 2 and 3800 of FIG. 6), the Parent-Identification (3040 of FIG. 2 and 3200 of FIG. 3), the Child-Identification (3020 Of FIG. 2 and 3400 of FIG. 4) and the Proxy-Identification (3010 of FIG. 2 and 3600 of FIG. 5). In calling methods in the KI-Interface (2810 of FIG. 1), all references to data must be via a unique handle (identification number) that points to a single Cursor-Identification (3030 of FIG. 2), which in turn translates to a single Manabars-Set (3000 of FIG. 2). There can be one or more Cursor-Identifications for each Manabars-Set. The references for these Cursor-Identifications are kept up to date with the use of the Proxy-Identification (3010 of FIG. 2) structure. The Manabars-Set is able to retain information for any Child-Identifications (3020 of FIG. 2) that are held inside it. There may be 0, 1 or more Children inside each Manabars-Set. Information about the overall Manabars-Set is held and referenced utilizing the Parent-Identification (3040 of FIG. 2). The arrows in FIG. 2 represent what each structure is able to hold information about and how the structures link with each other.

Cursor-Identification

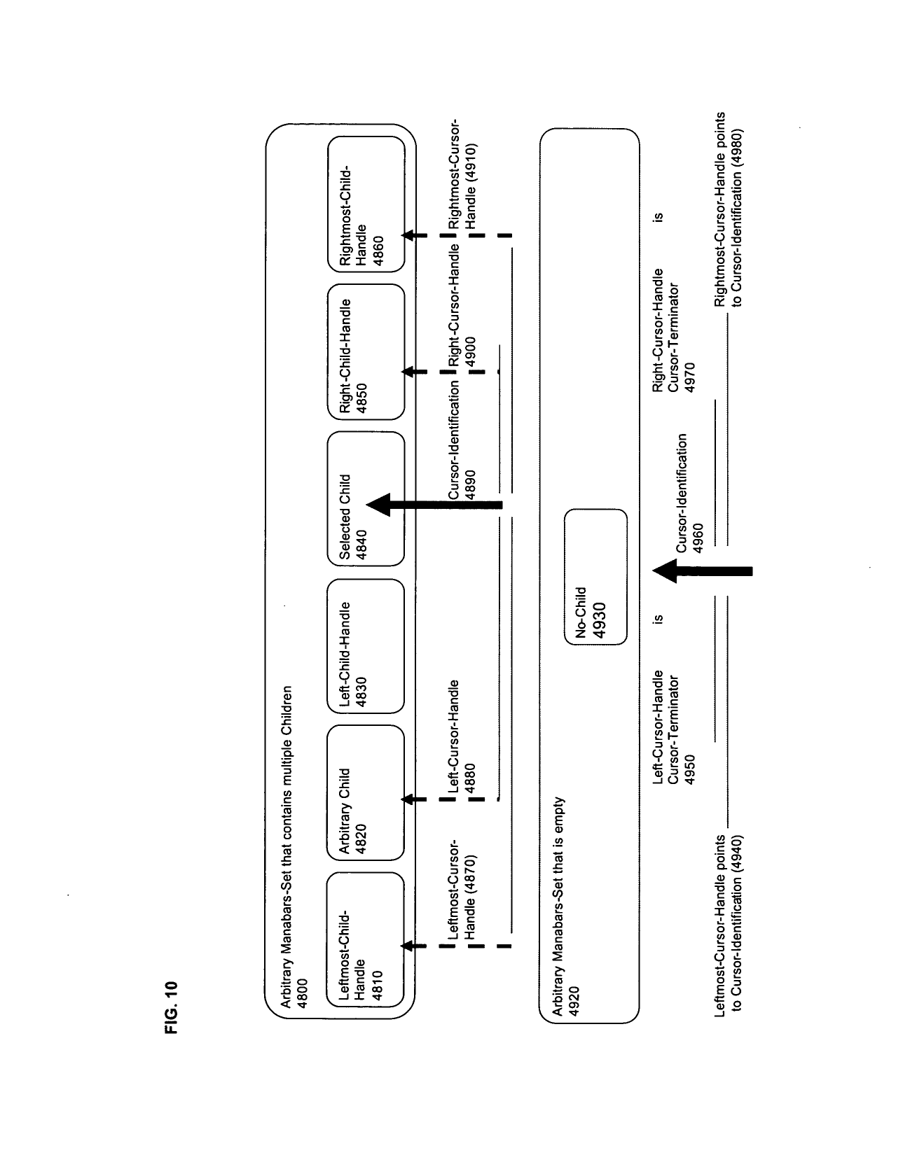

The Cursor-Identification (3030 of FIG. 2 and 3800 of FIG. 6) structure is the only frame of reference that Emulator-Components can use to modify the invention (2800 of FIG. 1) through the KI-Interface (2810 of FIG. 1). The remaining structures of the Parent-Identification (3040 of FIG. 2 and 3200 of FIG. 3), the Proxy-Identification (3010 of FIG. 2 and 3600 of FIG. 5) and the Child-Identification (3020 of FIG. 2 and 3400 of FIG. 4) are hidden from direct access and so are perceived as a simpler entity. FIG. 10 shows 2 exemplary Manabars-Sets (4800 & 4920) that have been referenced with a Cursor-Identification (3030 of FIG. 2 and 3800 of FIG. 6) handle. The Cursor-Identification handle renders a simplistic view of a Manabars-Set Parent (4800 of FIG. 10) that contains any number of other Manabars-Sets that form its Children (4810-4860 of FIG. 10) in a chain. Only one of these Children, the Selected-Child (4840 of FIG. 10) must hold the unique position in the Manabars-Set that is pointed to by the Cursor (4890 of FIG. 10). If there are no Children, then the Cursor (4860 of FIG. 10) points to an identifier called No-Child (4930 of FIG. 10) that represents an empty set. FIG. 6 shows all the fields that make up the structure of the Cursor-Identification and how they link to the other structures. These include the following:

Cursor-Proxy-Handle

The Cursor-Proxy-Handle (3810 of FIG. 6 field references the Proxy-Identification (3870 of FIG. 6 and 3010 of FIG. 2) to which this Cursor-Identification belongs.

Parent-Handle-Port

The Parent-Handle-Port (3820 of FIG. 6) field points to the Parent-Identification (3860 of FIG. 6 and 3040 of FIG. 2) to which this Cursor-Identification belongs. This is a mechanism for any Cursor-Identification to find the Parent-Identification that it may share with many other Cursor-Identifications. In the example in FIG. 10, it points to the Parent (4800 of FIG. 10).

Left-Cursor-Handle and Right-Cursor-Handle

The Left-Cursor-Handle (3830 of FIG. 6) and Right-Cursor-Handle (3840 of FIG. 6) fields point to adjacent Cursor-Identifications (3800 of FIG. 6 and 3030 of FIG. 2) within the shared Parent-Identification (3860 of FIG. 6 and 3040 of FIG. 2). The actual Cursor-Identification is determined by a linked list of Cursor-Identifications built by chaining from the Left-Cursor-Handle (3830 of FIG. 6) to the Right-Cursor-Handle (3840 of FIG. 6). This is used to locate the Left-Cursor (4840 of FIG. 10) and Right-Cursor (4900 FIG. 10). The chains are terminated at either end of the chain with a unique identifier called Cursor-Terminator (4950 and 4970 of FIG. 10), which differentiates it from a genuine reference to another Cursor-Identification.

Cursor-Identification-Content

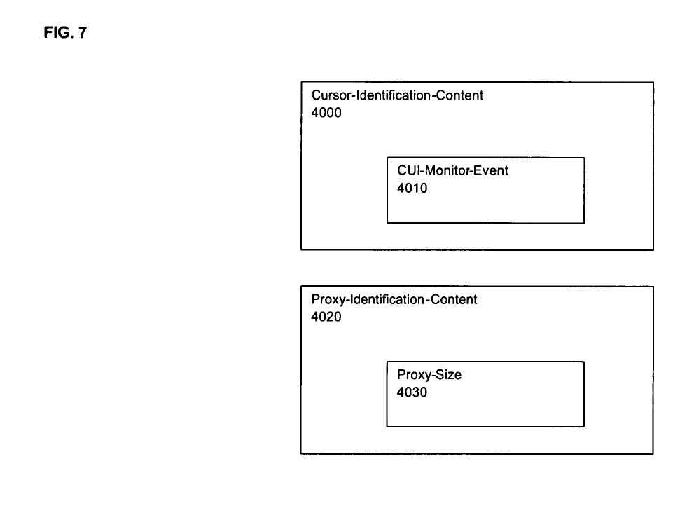

The Cursor-Identification-Content (3890 of FIG. 6 and 4000 of FIG. 7) contains a single field—the CUI-Monitor-Event (4010 of FIG. 7).

CUI-Monitor-Event

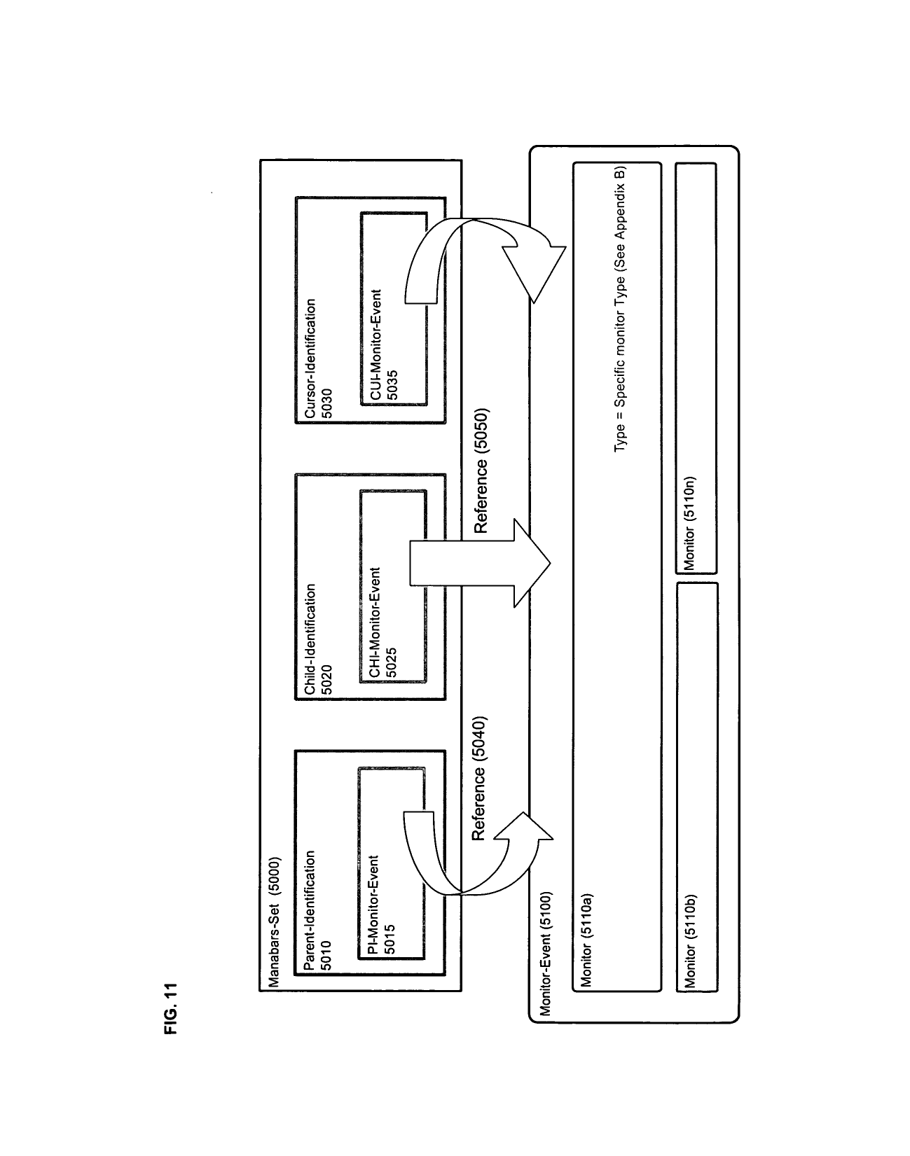

The CUI-Monitor-Event (4010 of FIG. 7 and 5035 of FIG. 11) field provides a handle to a Monitor-Event (5100 of FIG. 11) that contains Monitors (5110a-5110n of FIG. 11). These Monitors are required to be triggered with activity relating to the Cursor-Identification (3030 of FIG. 2) during the implementation of KI-Interface instructions.

Parent-Identification

The Parent-Identification (3040 of FIG. 2 and 3200 of FIG. 3) structure is a hidden frame of reference and is used internally by the Kernel-Image (2800 of FIG. 1) as a superstructure to hold references to Cursor-Identification (3030 of FIG. 2 and 3260 of FIG. 3) and Child-Identification (3020 of FIG. 2 and 3250 of FIG. 3) structures. The Parent-Identification acts as a common Parent for all Cursor-Identifications (3260 of FIG. 3 and 3030 of FIG. 2) that it holds, so it contains the shared information that represents a single Manabars-Set. The Cursor-Identification has a reference to the Parent-Identification called the Parent-Handle-Port (3270 of FIG. 3 and 3820 of FIG. 6). FIG. 3 shows all the fields that make up the structure of the Parent-Identification and how they link to the other structures. These include the following:

Leftmost-Cursor-Handle and Rightmost-Cursor-Handle

The Leftmost-Cursor-Handle (3210 of FIG. 3) and Rightmost-Cursor-Handle (3220 of FIG. 3) locates the Leftmost-Cursor-Identification (4870 of FIG. 10) and Rightmost-Cursor-Identification (4910 of FIG. 10) for this Parent-Identification (3200 of FIG. 3 and 3040 of FIG. 2). In the boundary case, where a Manabars-Set (3000 of FIG. 2) contains no Children, there is only 1 Cursor for the Parent-Identification, so the Leftmost-Cursor-Handle and the Rightmost-Cursor-Handle both use the same Cursor-Identification (4890 of FIG. 10)—even though this Cursor-Identification itself has a Child-Handle that points to No-Child instead of a genuine Child-Identification (3020 of FIG. 2).

Leftmost-Child-Handle and Rightmost-Child-Handle

The Leftmost-Child-Handle (3230 of FIG. 3) and Rightmost-Child-Handle (3240 of FIG. 3) contains the Leftmost-Child-Identification (4810 of FIG. 10) and Rightmost-Child-Identification (4860 of FIG. 10) of a Manabars-Set (3000 of FIG. 2). In the boundary case where there are no Children in the Manabars-Set (4920 of FIG. 10), then both the Leftmost-Child-Handle and Rightmost-Child-Handle fields point to the No-Child identifier (4930 of FIG. 10) that differentiates them from their normal context where the handle would otherwise point to a genuine Child-Identification (3250 of FIG. 3 and 3020 of FIG. 2).

Parent-Identification-Content

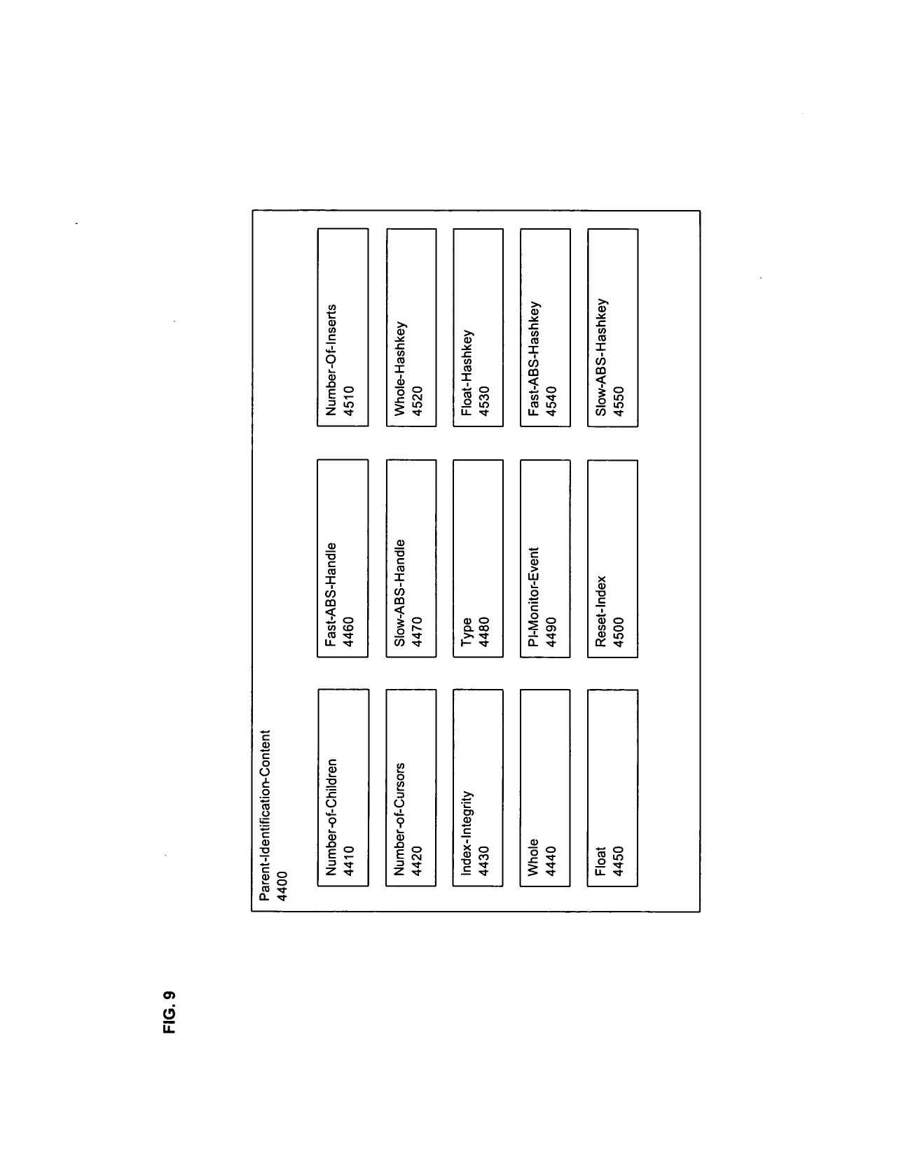

The Parent-Identification-Content (3225 of FIG. 3 and 4400 of FIG. 9) contains 15 fields listed below:

Number-of-Children

The Number-Of-Children (4410 of FIG. 9) contains the number of unique Child-Identifications (3020 in FIG. 2) for this Parent-Identification (3040 of FIG. 2). The Child-Identifications are chained together as other Manabars-Sets in a linked list. In the example in FIG. 10, the Number-Of-Children is the total number of Children (4810-4860 of FIG. 10) in the arbitrary Manabars-Set (4800 of FIG. 10).

Index-Integrity

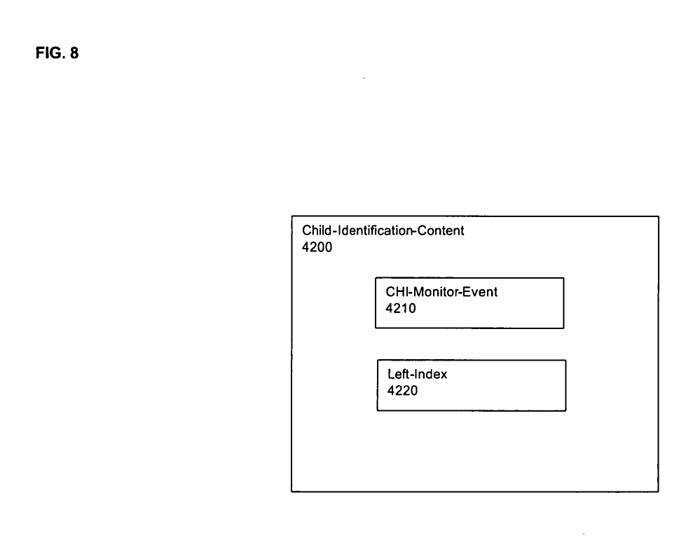

The Index-Integrity (4430 of FIG. 9) is a boolean field holding True or False. A value of True indicates the Left-Index (4220 of FIG. 8) is correct. If the value is False, then the index should be recalculated before the result for the Get-Index is called.

Reset-Index

Reset-Index (4500 of FIG. 9) is a boolean field holding True or False. A value of False indicates that no change has occurred in the Parent-Identification (3040 of FIG. 2) since the last KI-Get-Index method call. The Kernel-Image (2800 of FIG. 1) holds a reference to the. last Child-Identification (3020 in FIG. 2) that had its Left-Index (4220 of FIG. 8) updated. A value of True indicates that the KI-Get-Index call has to start again from the Leftmost-Child-Identification held in the Leftmost-Child-Handle (3230 of FIG. 3).

Number-of-Cursors

Number-Of-Cursors (4420 of FIG. 9) contains the number of unique Cursor-Identifications (3030 of FIG. 2) for the shared Parent-Identification (3040 of FIG. 2). Each Child may have any number of Cursors, each represented by a unique Cursor-Identification. Each Cursor-Identification may be separated by any number of Children.

PI-Monitor-Event

PI-Monitor-Event (4490 of FIG. 9 and 5015 of FIG. 11) provides a handle to a Monitor-Event (5100 of FIG. 11) that contains Monitors (5110a-5110n of FIG. 11). These Monitors are required to be triggered with activity relating to the Parent-Identification (3040 of FIG. 2) during the implementation of KI-Interface instructions.

Whole

The Whole (4440 of FIG. 9) contains a 64 Bit numerical value that does not have a decimal point.

Float

The Float (4450 of FIG. 9) contains a 64 Bit numerical value that includes a floating decimal point.

Fast-ABS-Handle

The Fast-ABS-Handle (4460 of FIG. 9) contains a unique key that is used to locate a Bit-Sequence in the Fast-ABS.

Slow-ABS-Handle

The Slow-ABS-Handle (4470 of FIG. 9) contains a unique key that is used to locate a Bit-Sequence in the Slow-ABS.

Type

The Type (4480 of FIG. 9) contains a Whole number that identifies the Type of the Manabars-Set.

Number-of-Inserts

The Number-Of-Inserts (4510 of FIG. 9) contains a Whole number that identifies how many times this Parent-Identification is inserted as a Child inside another Manabars-Set (3000 of FIG. 2).

Whole-Hashkey

The Whole-Hashkey (4520 of FIG. 9) contains a Whole number that is used as a unique identifier based on the Whole values of all the Children of the Manabars-Set (3000 of FIG. 2). Any one of many algorithms may be used for determining the Whole-Hashkey.

Float-Hashkey

The Float-Hashkey (4520 of FIG. 9) contains a Whole number that is used as a unique identifier based on the Float values of all the Children of the Manabars-Set (3000 of FIG. 2). Any one of many algorithms may be used for determining the Float-Hashkey.

Fast-ABS-Hashkey

The Fast-ABS-Hashkey (4520 of FIG. 9) contains a Whole number that is used as a unique identifier based on the Fast-ABS-Handles of all the Children of the Manabars-Set (3000 of FIG. 2). Any one of many algorithms may be used for determining the Fast-ABS-Hashkey.

Slow-ABS-Hashkey

The Slow-ABS-Hashkey (4520 of FIG. 9) contains a Whole number that is used as a unique identifier based on the Slow-ABS-Handles of all the Children of the Manabars-Set (3000 of FIG. 2). Any one of many algorithms may be used for determining the Slow-ABS-Hashkey.

Child-Identification

The Child-Identification (3020 Of FIG. 2 and 3400 of FIG. 4) structure forms a linked list of Manabars-Sets (3000 of FIG. 2) that are all Children of a common Parent-Identification (3450 of FIG. 4 and 3040 of FIG. 2). The linked list is terminated on either end when the Left-Child-Handle (3410 of FIG. 4) and the Right-Child-Handle (3420 of FIG. 4) equals the No-Child identifier.

Left-Child-Handle and Right-Child-Handle

The Left-Child-Handle (3410 of FIG. 4) and Right-Child-Handle (3420 of FIG. 4) provides references to the adjacent Child-Identifications (3400 of FIG. 4 and 3020 of FIG. 2) that are the Left-Child-Identification (4830 of FIG. 10) and Right-Child-Identification (4850 of FIG. 10) that create a linked list of Children Manabars-Sets (3000 of FIG. 2) for this Parent-Identification (3450 of FIG. 4 and 3040 of FIG. 2).

Child-Proxy-Handle

The Child-Proxy-Handle (3430 of FIG. 4) provides a handle to a Proxy-Identification (3480 of FIG. 4 and 3010 of FIG. 2) that contains all the Cursor-Identifications (3490 of FIG. 4 and 3030 of FIG. 2) that are currently pointing to the Child-Identification (3400 of FIG. 4). If there are no Cursor-Identifications currently pointing to the Child-Identification then the Child-Proxy-Handle will point to a No-Proxy identifier that differentiates it from a genuine reference to another Proxy-Identification.

Parent-Handle-Starboard

The Parent-Handle-Starboard (3440 of FIG. 4) provides a handle to the Cursor-Identification (3490 of FIG. 4 and 3030 of FIG. 2) to which this Child-Identification (3400 of FIG. 4) refers.

Child-Identification-Content

The Child-Identification-Content (3445 of FIG. 4 and 4200 of FIG. 8) contains 2 fields listed below:

CHI-Monitor-Event

The CHI-Monitor-Event (4210 of FIG. 8 and 5025 of FIG. 11) provides a handle to a Monitor-Event (5100 of FIG. 11) that contains Monitors (5110a-5110n of FIG. 11). These Monitors are required to be triggered with activity relating to the Child-Identification (3020 of FIG. 2) during the implementation of KI-Interface instructions.

Left-Index

The Left-Index (4220 of FIG. 8) field holds the last known index that the Cursor occupies from the Leftmost Manabars-Set (3000 of FIG. 2). The Right-Index is the last known index that the Cursor occupies from the Rightmost Manabars-Set and is calculated through subtracting the Left-Index from the Number-of-Children (4410 of FIG. 9). The integrity of these indexes should be checked with the Index-Integrity field (4430 of FIG. 9). If False, the indexes should be recalculated before use with the Get-Index method.

Proxy-Identification

The Proxy-Identification (3010 of FIG. 2 and 3600 of FIG. 5) structure forms a linked list of Cursor-Identifications (3650 of FIG. 5 and 3030 of FIG. 2) that are currently pointing to a Child-Identification (3670 of FIG. 5 and 3020 of FIG. 2). There are 2 types of Proxy-Identification—a Main and a Sublevel Proxy-Identification. This is because there may be more than one Proxy-Identification referencing a Child-Identification but the Child-Identification can only reference one Proxy-Identification. The Main and the Sublevel Proxy-Identifications (3600 of FIG. 5) are distinguished through the Proxy-Handle (3620 of FIG. 5). A Main Proxy-Identification holds an identifier of No-Proxy in the Proxy-Handle. If the Proxy-Handle holds a reference to another Proxy-Identification then it is considered to be a Sublevel Proxy-Identification. The Main Proxy-Identification fields are kept up to date after each KI-Interface method call, while the Sublevel Proxy-Identification fields are not always reliable with the exception of the Proxy-Handle (3620 of FIG. 5). In an optimized configuration a background process may synchronize the Main and Sublevel-Proxy-Identifications on a regular basis.

Proxy-Child-Handle

The Proxy-Child-Handle (3610 of FIG. 5) field holds the handle to the Child-Identification (3670 of FIG. 5 and 3020 of FIG. 2) that is pointed to by all of the Cursor-Identifications (3650 of FIG. 5) inside the Proxy and represents the Selected-Child (4840 of FIG. 10). If the Manabars-Set is empty, the Proxy-Child-Handle should hold the state of No-Child, differentiating it from an actual handle to a genuine Child-Identification.

Proxy-Handle

The Proxy-Handle (3620 of FIG. 5) field is utilized when there is more than one Proxy currently referencing the same Child-Identification (3670 of FIG. 5 and 3020 of FIG. 2). This would happen in the event of Delete-Child KI-Interface method call, or an Insert-Child KI-Interface method call in the situation of a number of Cursor-Identifications (3650 of FIG. 5 and 3030 of FIG. 2) shifting over to reference another Child-Identification (3670 of FIG. 5) at the same time. In this situation the Main Proxy-Identification (3600 of FIG. 5) currently pointing to the new Child-Identification has its Proxy-Handle (3620 of FIG. 5) updated to reference the Proxy-Identification that is being moved, thereby becoming a Sublevel Proxy-Identification, and the Proxy-Identification that is being moved will become the Main Proxy-Identification referenced by the new Child-Identification.

Proxy-Leftmost-Cursor-Handle and Proxy-Rightmost-Cursor-Handle

The Proxy-Leftmost-Cursor-Handle (3630 of FIG. 5) and Proxy-Rightmost-Cursor-Handle (3640 of FIG. 5) locates the first and last Cursor-Identifications (3660 of FIG. 5 and 3030 of FIG. 2) that are inside the Proxy. All Cursors in between the first and last Cursors can be found using the Left-Cursor-Handle (3830 of FIG. 6) and Right-Cursor-Handle (3840 of FIG. 6) of the Cursor-Identification. Any Sublevel Proxy-Identifications (3600 of FIG. 5) are considered to be part of the Main Proxy-Identification, in which case the Proxy-Leftmost-Cursor-Handle or the Proxy-Rightmost-Cursor-Handle of the Main Proxy-Identification may be referencing a Cursor-Identification that is residing in a Sublevel Proxy-Identification.

Proxy-Identification-Content

The Proxy-Identification-Content (3615 of FIG. 5) contains a single field—the Proxy-Size.

Proxy-Size

The Proxy-Size (4030 of FIG. 7) holds the amount of Cursor-Identifications (3660 of FIG. 5 and 3030 of FIG. 2) currently referencing the same Proxy-Identification (3600 of FIG. 5). Any Sublevel Proxy-Identifications are considered to be part of the Main Proxy-Identification, which means that the Proxy-Size of the Main Proxy-Identification includes all the sizes of any Sublevel Proxy-Identifications. If a Cursor-Identification (3660 of FIG. 5) is shifted into, or out of the Main Proxy-Identification or any of its Sublevel Proxy-Identifications then only the size of the Main Proxy-Identification is updated.

Kernel-Image

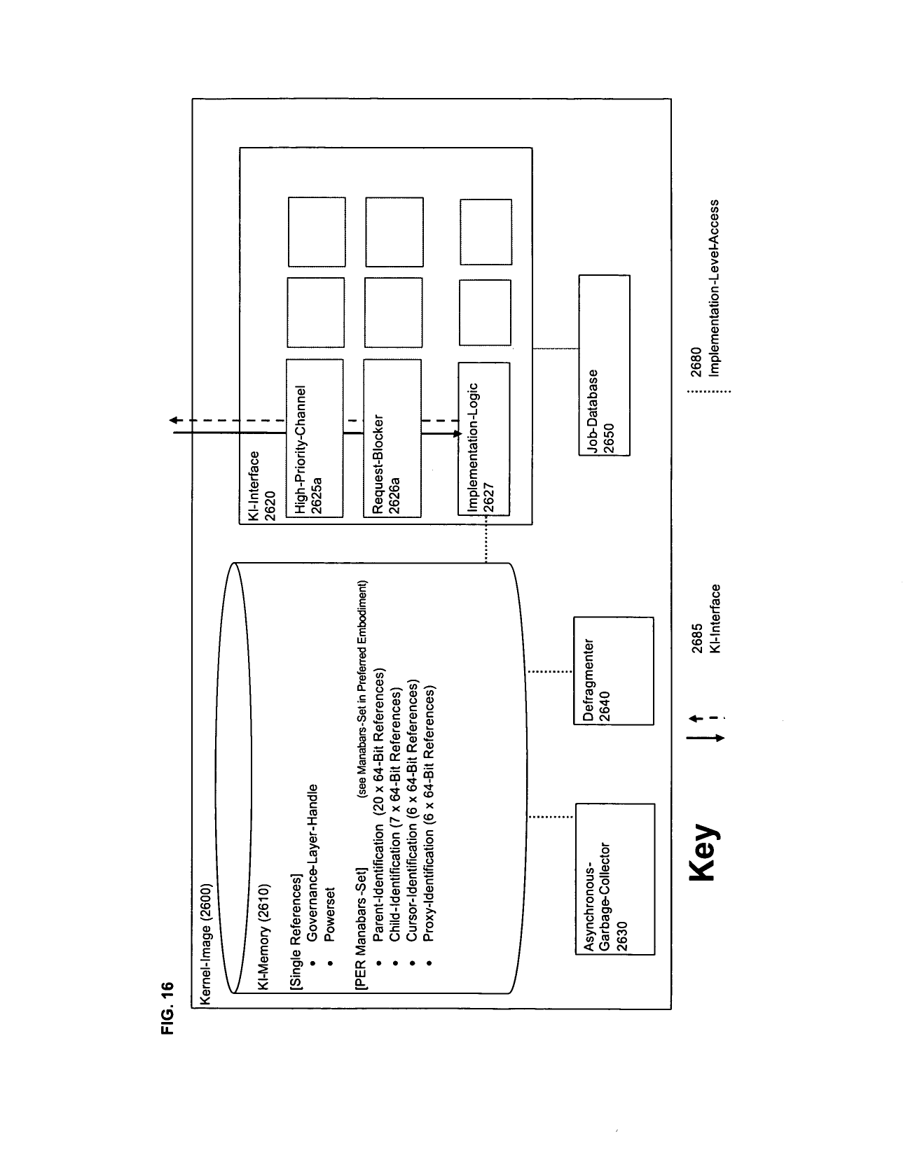

The invention in the embodiment described is implemented in a module known as the Kernel-Image(2800 of FIG. 1), hence the term “Kernel-Image” is also used in this document to refer generally to the invention. The invention may act as a central repository for information by other devices. Every Manabars-Set (3000 of FIG. 2) is stored within the invention. The outermost Manabars-Set is known as the Powerset. Manabars-Sets can only be accessed through the KI-Interface (2810 of FIG. 1), so other Emulator-Components can't access the KI-Memory (2610 of FIG. 16) directly. All handles to manipulate Manabars-Sets are of the type Cursor-Identification (3030 of FIG. 2 and 3800 of FIG. 6), whilst handles to the Parent-Identification (3040 of FIG. 2 and 3200 of FIG. 3), Proxy-Identification (3010 Of FIG. 2 and 3600 of FIG. 5) and Child-Identification (3020 Of FIG. 2 and 3400 of FIG. 4) are protected behind the KI-Interface.

KI-Memory

The KI-Memory (2610 of FIG. 16) is used to store every Manabars-Set (3000 of FIG. 2) within the Kernel-Image (2800 of FIG. 1). It is likely that the implementers of the invention may use arrays to represent every field in the Parent-Identification (3040 of FIG. 2), the Cursor-Identification (3030 of FIG. 2), the Child-Identification (3020 of FIG. 2) and the Proxy-Identification (3010 of FIG. 2). The KI-Memory is the primary memory system in the Emulator.

KI-Interface

The KI-Interface (2810 of FIG. 1) is the only conduit through which Emulator-Components can access the KI-Memory (2610 of FIG. 16). The KI-Interface should allow any number of methods to be called in parallel, provided that they do not utilize any identical Cursor-Identification (3030 of FIG. 2 and 3800 of FIG. 6) handles and they don't share a common Parent. For each parallel access that may be required for a specific implementation of the Emulator, a separate Channel (2870a-2870f and 2875a-2875f of FIG. 1) is required. There are two types of Channels (1) High-Priority-Channels (2870a-2870f of FIG. 1) and (2) Low-Priority-Channels (2875a-2875f of FIG. 1). Requests entering a Low-Priority-Channel must wait until there are no more requests entering any High-Priority-Channel. It is beyond the scope of this patent to define the configuration of Channels during the implementation, as there are many valid configurations that are likely to be determined by the relative power rating of the other Emulator-Components. FIG. 16 shows a minimal implementation where a single High-Priority-Channel (2625a of FIG. 16) is used to service all the requests. FIG. 1 shows the KI-Interface configuration that is optimized for silicon, having 6 High-Priority-Channels and 6 Low-Priority-Channels. Each Channel acts as a parallel interface to the KI-Memory (2610 of FIG. 16) that conforms to the KI-Interface and each will be blocked by the Request-Blocker (2890a-2890f & 2895a-2895f of FIG. 1) if it is already busy with a request. If multiple requests are made, the Request-Blocker should queue these. Each Channel may have its own Implementation-Logic (2880a-2880f and 2885a-2885f of FIG. 1), so that requests may be processed in parallel. The minimal implementation is a single Implementation-Logic unit (2627 of FIG. 16) that services High-Priority-Channel requests before Low-Priority-Channel requests.

In some implementations, the KI-Memory (2610 of FIG. 16) may not allow absolute parallel access for all the Implementation-Logic (2627 of FIG. 16) components. In this case, these Request-Blockers (2626a of FIG. 16) for the High-Priority-Channels (2625a of FIG. 16) should each rotate in their own round robins. Since a Channel may constantly be utilized, failure to service all Channels in a statistically equivalent manner could lead to the disruption of the devices the invention supports. Specifically, in the optimized configuration of FIG. 1 this could be avoided through the following rotation sequence: 2890a-2890b-2890c-2890d-2890e-2890f-2890a. However, any statistically equivalent distribution is acceptable.

The Implementation-Logic translates methods directly into implementation specific low-level memory requests by using Implementation-Level-Access (2680 of FIG. 16). The Implementation-Logic therefore has direct access to arrays to build the set structures, which are efficient and readily available on the von Neumann architecture. The Arrays and Counters are beyond the scope of the patent because the behavioural specification of the Manabars-Set (3000 of FIG. 2) is already defined and the implementation may vary.

Implementation-Logic

FIG. 16 shows the invention (2600 of FIG. 16) acting as a centralized memory model. Emulator-Components do not have direct access to the KI-Memory (2610 of FIG. 16), but manipulate data with handles and methods via the KI-Interface (2685 of FIG. 16 and 2810 of FIG. 1).

The KI-Interface seamlessly passes method calls to the Implementation-Logic (2880a-2880f & 2885a-2885f of FIG. 1). In a typical Object Orientated deployment, the Implementation-Logic is likely to be a series of methods calls within a single KI-Interface object. In a software implementation, there is little need to repeat the Implementation-Logic as memory is shared between processes and repeating code does not speed up execution because more threads have to compete for a fixed computational resource in a conventional von Neumann hardware deployment.

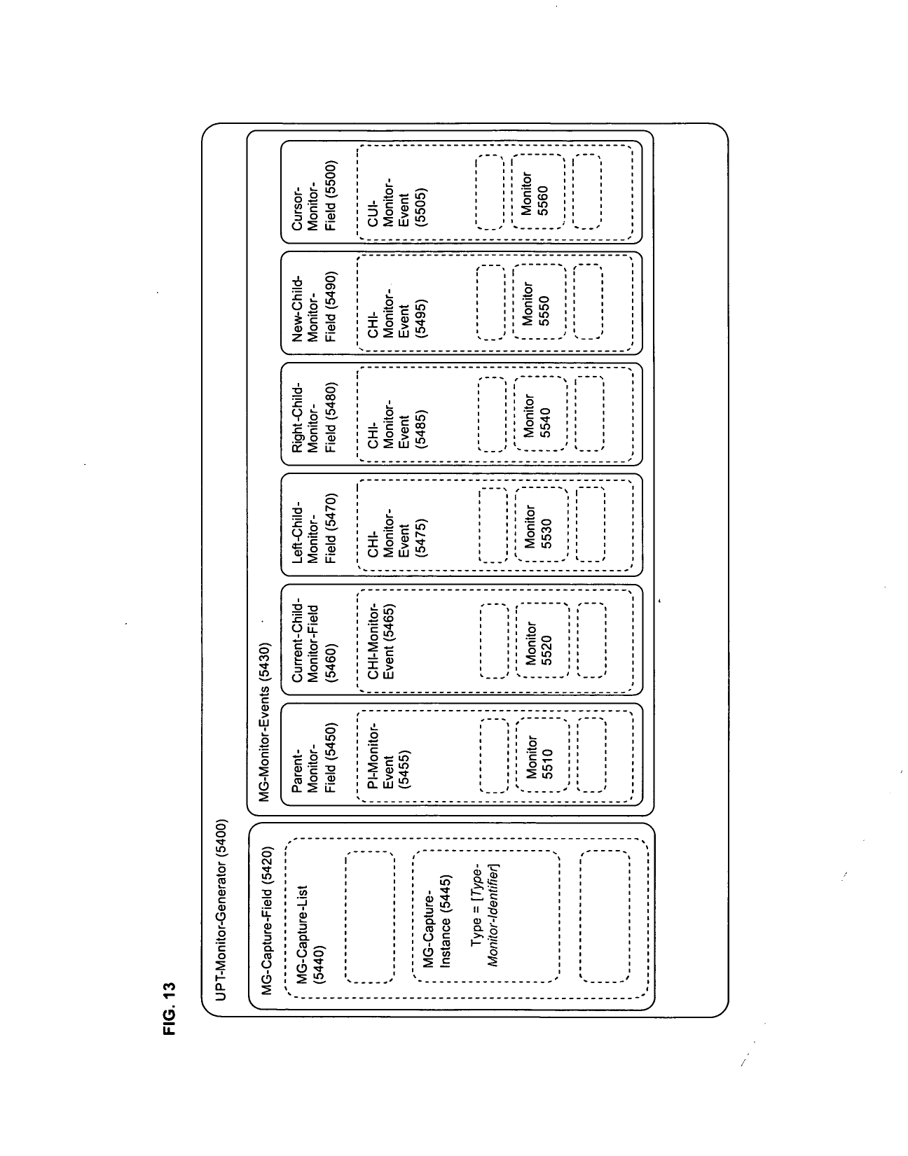

The Implementation-Logic is required to check for any attached to Manabars-Sets (3000 of FIG. 2) that are affected directly and indirectly by any KI-Interface (2620 of FIG. 16) method calls. A compulsory parameter for each method call identifies the stack that will contain the UPT-Monitor-Generator (5400 of FIG. 13). This stack is to contain instructions that provide a computationally complete platform and is provided by devices that utilize this invention. If this parameter is set to the value No-Stack then all Monitors attached to the Manabars-Set are ignored. See the Monitors section for a complete explanation of how Monitors are triggered. Also refer to Appendix A for a full list of KI-Interface methods and the Monitors that may be triggered through each KI-Interface method call.

Defragmenter

The Defragmenter (2640 of FIG. 16) is an implementation specific component and so is beyond the scope of this patent. For example, the implementers may choose to maintain a list of every available Cursor-Identification (3030 of FIG. 2), Child-Identification (3020 of FIG. 2) and Parent-Identification (3040 of FIG. 2) so that the entire defragmentation process is irrelevant. Alternatively, the implementers may choose to confine all the utilized memory structures within tracked zones of indexes. Defragmentation would then be used to shrink these zones when elements inside them were deleted. The Defragmenter may receive events from the KI-Memory (2610 of FIG. 16) that may assist in the defragmentation process.

The Defragmenter has Implementation-Level-Access (2680 of FIG. 16), so it modifies the KI-Memory structures directly.

Asynchronous-Garbage-Collector

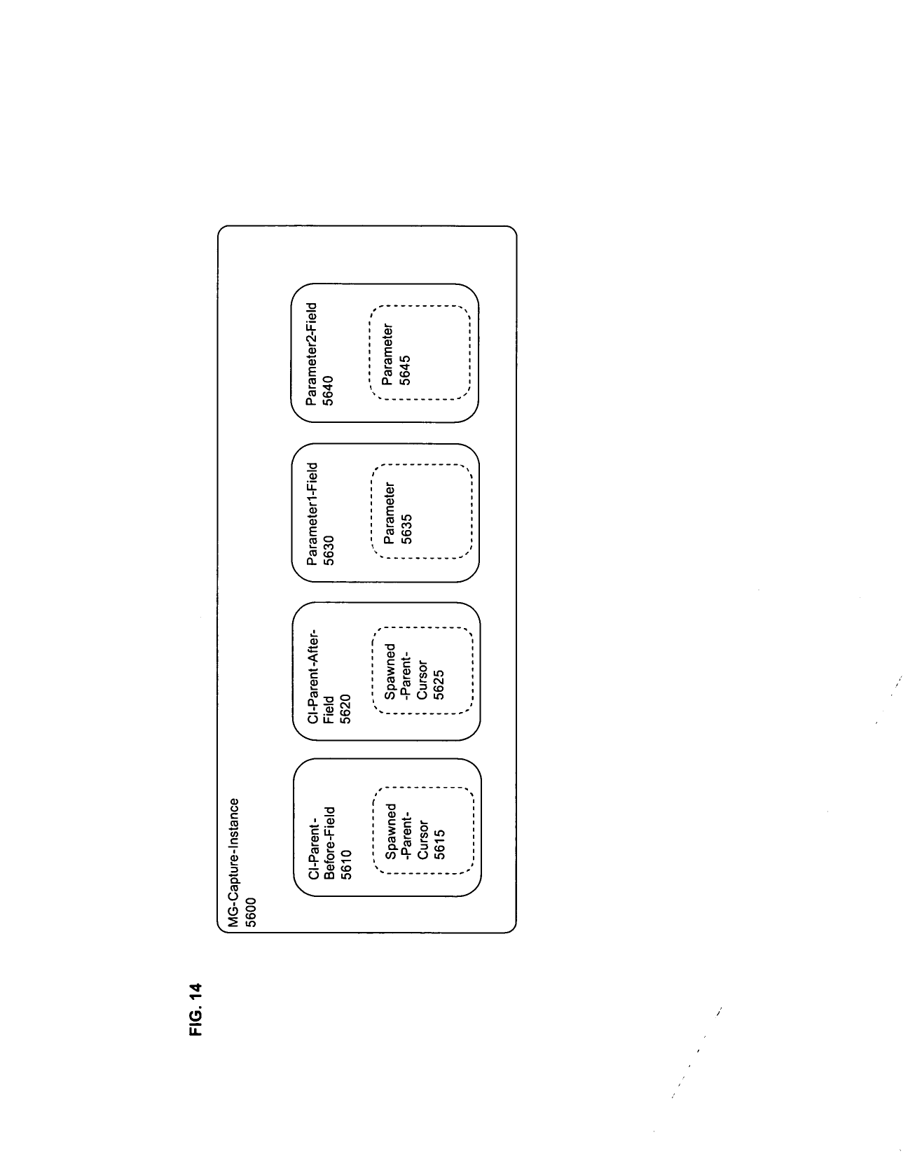

The Asynchronous-Garbage-Collector (2630 of FIG. 16) is an implementation specific component. It is responsible for freeing up unused memory that occurs during a Delete-Child KI-Interface method call or Insert-Child KI-Interface method call with an Action-Polarity set to Type-Neutral. These KI-Interface calls are guaranteed to free up memory associated with Child-Identifications, however, the memory associated with the Cursor-Identification and its shared Parent-Identification can only be deleted if there are exactly zero references utilizing it. This Emulator-Component is tightly related to the Defragmenter and it is expected that they may work together to manage the KI-Memory (2610 of FIG. 14).

Monitors

Monitors (Refer Appendices B and C) provide a mechanism whereby software executing in the Kernel-Image (2800 of FIG. 1) can be made aware of changes to other Children. There are three different main Types of Monitor:
(1) CUI-Monitors: These Monitors are concerned with any changes to the Cursor-Identification (3030 of FIG. 2 and 3800 of FIG. 6) such as the Cursor shifting to a different Child. These Monitors are stored in the CUI-Monitor-Event (4010 of FIG. 7 and 5035 of FIG. 11) of the Cursor-Identification-Content (3890 of FIG. 6 and 4000 of FIG. 7).
(2) PI-Monitors: These Monitors are concerned with any changes to the Parent-Identification (3040 of FIG. 2 and 3600 of FIG. 5) such as a Child being inserted or deleted, or the Whole (4440 of FIG. 9) or Float (4450 of FIG. 9) being altered. These Monitors are stored in the PI-Monitor-Event (4490 of FIG. 9 and 5015 of FIG. 11) of the Parent-Identification-Content (3225 of FIG. 3 and 4400 of FIG. 9).
(3) CHI-Monitors: These Monitors are concerned with any changes to the Child-Identification (3020 of FIG. 2 and 3400 of FIG. 4) such as a Child being inserted to the Left or Right of the Child being monitored. These Monitors are stored in the CHI-Monitor-Event (4210 of FIG. 8 and 5025 of FIG. 11) of the Child-Identification-Content (3445 of FIG. 4 and 4200 of FIG. 8).

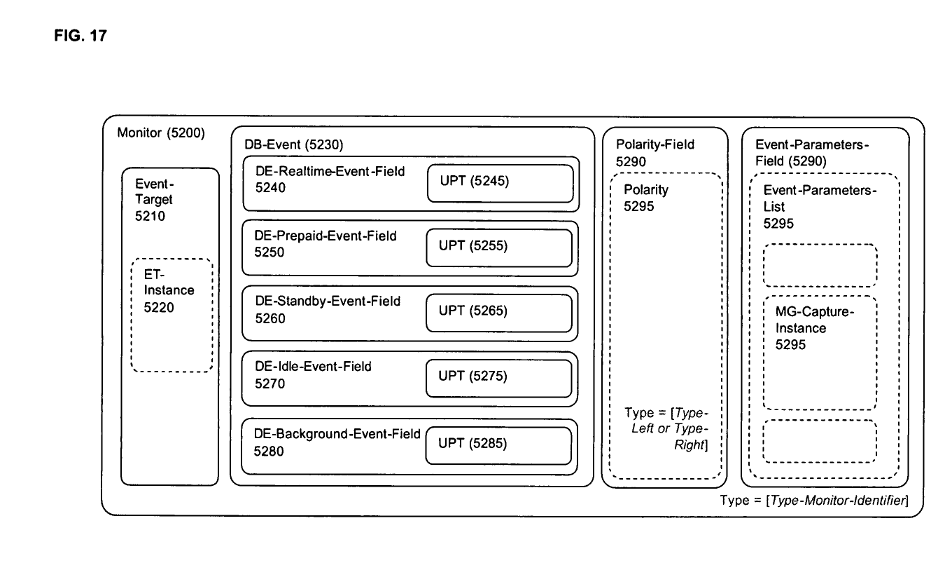

For a full list of Monitors, their Types and their Parameters see Appendix B. Monitors (5110a-5110n of FIG. 11 and FIG. 17) are added to a Monitor-Event (5100 of FIG. 11) through the KI-Add-Monitor method (refer Appendix A). The parameters for this method call are the Monitor that is to be added and the Cursor-Identification (3030 of FIG. 2 and 3800 of FIG. 6) used to locate the Monitor-Event. Each Monitor has a unique Type (4480 of FIG. 9) that is used to identify whether the Monitor belongs in a PI-Monitor-Event (4490 of FIG. 9 and 5015 of FIG. 11), CUI-Monitor-Event (4010 of FIG. 7 and 5035 of FIG. 11) or a CHI-Monitor-Event (4210 of FIG. 8 and 5025 of FIG. 11). A Monitor-Event (5100 of FIG. 11) is a Child with no specific Type, which is essentially a list of Monitors (5110a-5110n of FIG. 11 and FIG. 17) that identify specific events that require triggering. Events are triggered from within the Implementation-Logic (2880a-2880f and 2885a-2885f of FIG. 1) that processes instructions for the KI-Interface (2810 of FIG. 1). A single instruction processed by the Implementation-Logic may trigger a number of Monitors. See appendix A for all Monitors triggered through each KI-Interface method call. The CUI-Monitor-Event (4010 of FIG. 7 and 5035 of FIG. 11), PI-Monitor-Event (4490 of FIG. 9 and 5015 of FIG. 11) and CHI-Monitor-Event (4210 of FIG. 8 and 5025 of FIG. 11) must be searched to locate the Monitors (5110a-5110n of FIG. 11 and FIG. 17) that are to be triggered. This may take an unknown amount of time and therefore cannot be processed through the Implementation-Logic. Therefore during the processing of each instruction, the Implementation-Logic creates (see below for further explanation) an UPT-Monitor-Generator (5400 of FIG. 13), which holds all the relevant parameters for each event that has occurred that may trigger a Monitor. These parameters are known as MG-Capture-Instances (5445 of FIG. 13 and 5600 of FIG. 14). All Monitor-Events that may hold Monitors that require triggering are also included in the UPT-Monitor-Generator. These Monitor-Events are:
(1) The CUI-Monitor-Event (4010 of FIG. 7 and 5505 of FIG. 13) of the Cursor-Identification (3030 of FIG. 2 and 3800 of FIG. 6) used in the KI-Interface call. This Monitor-Event is inserted into the Cursor-Monitor-Field (5500 of FIG. 13).
(2) The PI-Monitor-Event (4490 of FIG. 9 and 5455 of FIG. 13) of the Parent-Identification (3040 of FIG. 2 and 3600 of FIG. 5) connected to the Cursor-Identification (3030 of FIG. 2 and 3800 of FIG. 6). This Monitor-Event is inserted into the Parent-Monitor-Field (5450 of FIG. 13).
(3) The CHI-Monitor-Event (4210 of FIG. 8 and 5465 of FIG. 13) of the Child that the Cursor-Identification (3030 of FIG. 2 and 3800 of FIG. 6) is currently pointing to. This Monitor-Event is inserted into the Current-Child-Monitor-Field (5460 of FIG. 13).
(4) The CHI-Monitor-Event (4210 of FIG. 8 and 5475 of FIG. 13) of the Child to the Left of the Child that the Cursor-Identification (3030 of FIG. 2 and 3800 of FIG. 6) is currently pointing to. This Monitor-Event is inserted into the Left-Child-Monitor-Field (5470 of FIG. 13).
(5) The CHI-Monitor-Event (4210 of FIG. 8 and 5485 of FIG. 13) of the Child to the Right of the Child that the Cursor-Identification (3030 of FIG. 2 and 3800 of FIG. 6) is currently pointing to. This Monitor-Event is inserted into the Right-Child-Monitor-Field (5480 of FIG. 13).
(6) The CHI-Monitor-Event (4210 of FIG. 8 and 5495 of FIG. 13) of the new Child that the Cursor-Identification (3030 of FIG. 2 and 3800 of FIG. 6) is pointing to. This Monitor-Event is inserted into the New-Child-Monitor-Field (5490 of FIG. 13).

In deploying the invention, a computationally complete environment is required to process instructions from a stack, all comprised of Manabars-Sets. The UPT-Monitor-Generator (5400 of FIG. 13) is then inserted into the Leftmost position of the Stack provided as a compulsory call parameter for every KI-Interface method—providing that the Stack itself is non-null. Monitor behaviour should be ignored for the KI-Interface call, if the Stack is null. The UPT-Monitor-Generator is subsequently executed repeatedly inside the appropriate Stack until all the relevant Monitors have been processed. However the full details of how the UPT-Monitor-Generator is executed and how the Monitor is subsequently processed is beyond the scope of this document.

The KI-Add-Monitor method call returns a key that is used to locate the specific Monitor (5110a-5110n of FIG. 11) within the Monitor-Event (5100 of FIG. 11). This key is subsequently used to remove the Monitor from the Monitor-Event through the KI-Remove-Monitor method call. All Monitors are transient and therefore all Monitor-Events are removed from the Manabars-Set on Shutdown of the invention.

Wherein the foregoing description reference has been made to specific components or integers of the invention having known equivalents then such equivalents are herein incorporated as if individually set forth.

### APPENDIX A

KI-Interface Methods

Each KI-Interface methods is defined in a single table with the following fields.

| | |
|---|---|
| Generic | The behaviour that the KI-Interface method will assume |
| Behaviour | for the majority of all execution. All the individual |
| | cases will deviate from this. Unless otherwise stated, each |
| | case can assume to inherit all the behaviour |
| | from “Generic Behaviour”. |
| Inputs | Parameters that are passed with the KI-Interface method. |
| Outputs | Data that is returned as a result of the |
| | KI-Interface method call. |
| References | Lists all fields that are accessed multiple |
| set up at | times throughout the method. |
| | the start |
| Fields | Lists all the fields within the Manabars-Set structure |
| Altered | (3000 of FIG. 2) that may be affected by the method |
| | call. |
| Monitors | Lists the Monitors that may be triggered during this “Case” |
| | where the behaviour of the method deviates from |
| | the “Generic Behaviour”. |
| Occurrence | The situation when the case is applicable. |
| Deviated | The altered behaviour from the “Generic Behaviour” |
| Behaviour | that the case assumes. |
| Monitors | The monitors that may be triggered during this case. |

KI-Add-Monitor

| | |
|---|---|
| Inputs | (1) The Cursor-Identification (3030 of FIG. 2 and 3800 of FIG. 6) that is to have the Monitor attached |
| | or will be used to locate either the Parent-Identification (3040 of FIG. 2 and 3200 of FIG. 3) or the |
| | Child-Identification (3020 of FIG. 2 and 3400 of FIG. 4) that will have the Monitor (5110a-5110n of |
| | FIG. 11) attached. (2) The Cursor-Identification of the Monitor that has previously been constructed. |
| Outputs | (1) The Key that is used at a later time to remove the particular Monitor, attached through this KI- |
| | Add-Monitor method call, from the Monitor-Event (5100 of FIG. 11). |
| References set up | Parent-Identification: Found through the Parent-Handle-Port (3820 of FIG. 6) of the Cursor- |
| at the start | Identification (input (1)). |
| | Current-Child-Identification: Found through the Proxy-Child-Handle (3610 of FIG. 5 and 3400 of |
| | FIG. 4) of the Cursor-Proxy-Handle (3660 of FIG. 5 and 3810 of FIG. 6) of the Cursor-Identification |
| | (input (1)). |
| Generic Behaviour | This Method adds a Monitor to a Monitor-Event of the Cursor-Identification (input (1)), the Parent- |
| | Identification or the Current-Child-Identification depending on the Type of the Monitor (input (2)). |
| | Step 1: Identify the Type of the Monitor. If the Type is less than 130 (see Appendix C) then locate |
| | the Monitor-Event found through the CHI-Monitor-Event of the Current-Child-Identification. If the |
| | Type is between 130 and 160 then locate the Monitor-Event found through the PI-Monitor-Event of |
| | the Parent-Identification. If the Type is between 160 and 180 then locate the Monitor-Event found |
| | through the CUI-Monitor-Event of the Cursor-Identification (input (1)). |
| | Step 2: Spawn the Cursor-Identification of the located Monitor-Event and insert the Monitor into the |
| | Monitor-Event using the spawned Monitor-Event. |
| | Step 3: Create a new Manabars-Set as a key to an indexing mechanism. Insert the spawned |
| | Monitor-Event into the indexing mechanism utilising the key and return the key. |
| Fields Altered | None |
| Monitors | None |
| | Case 1 |
| Occurrence | There is no Monitor-Event attached to the CHI-Monitor-Event, PI-Monitor-Event or CUI-Monitor- |
| | Event. |
| Deviated | Create new Monitor-Event and update the CHI-Monitor-Event, PI-Monitor-Event or CUI-Monitor- |
| Behaviour | Event (depending on the Type of the Monitor) to reference the newly created Monitor-Event. |
| Fields Altered | CHI-Monitor-Event of the Current-Child-Identification, PI-Monitor-Event of the Parent-Identification or |
| | CUI-Monitor-Event of the Cursor-Identification (input (1)) - depending on the Type of the Monitor. |
| Monitors | None |

KI-Broadcast

| | |
|---|---|
| Inputs | 64-Bit parameter |
| Outputs | None |
| References set up | None |
| at the start | |
| Generic Behaviour | Broadcasts the 64-Bit parameter |
| | to all Emulator components. |
| Fields Altered | None |
| Monitors | None |

KI-Create-Manabars-Set

| | |
|---|---|
| Inputs | (1) The Type (4480 of FIG. 9) for the newly created Manabars-Set (3000 of FIG. 2). |
| Outputs | The newly created Cursor-Identification. |
| References set up | None |
| at the start | |
| Generic Behaviour | This method creates a new Manabars-Set (3000 of FIG. 2) without inserting it into another |
| | Manabars-Set. The newly created Manabars-Set is unable to be saved until it is inserted into |
| | another Manabars-Set. |
| | Step 1: Create a new Parent-Identification (3040 of FIG. 2 and 3200 of FIG. 3), a new Cursor- |
| | Identification (3030 of FIG. 2 and 3800 of FIG. 6), and a new Proxy-Identification (3010 of FIG. 2 |
| | and 3600 of FIG. 5). |
| | Step 2: Update the following fields for the new Parent-Identification (3200 of FIG. 3): Leftmost- |
| | Cursor-Handle (3210 of FIG. 3) and Rightmost-Cursor-Handle (3220 of FIG. 3) to reference new |
| | Cursor-Identification, Leftmost-Child-Handle (3230 of FIG. 3) and Rightmost-Child-Handle (3240 of |
| | FIG. 3) to reference No-Child. Update the following fields for the Parent-Identification-Content (3225 |
| | of FIG. 3 and 4400 of FIG. 9): Number-Of-Children (4410 of FIG. 9) to equal 0, Number-Of-Cursors |
| | (4420 of FIG. 9) to equal 1, Index-Integrity (4430 of FIG. 9) to equal true, PI-Monitor-Event (4490 of |
| | FIG. 9) to reference No-Monitor-Event, Whole (4440 of FIG. 9), Float (4450 of FIG. 9), Fast-ABS- |
| | Handle (4460 of FIG. 9), Slow-ABS-Handle (4470 of FIG. 9), Whole-Hashkey (4520 of FIG. 9), |
| | Float-Hashkey (4530 of FIG. 9), Fast-ABS-Hashkey (4540 of FIG. 9) and Slow-ABS-Hashkey (4550 |
| | of FIG. 9) to equal 0, Type (4480 of FIG. 9) to equal input (1), Reset-Index to equal true. |
| | Step 3: Update the following fields for the new Cursor-Identification (3800 of FIG. 6): Cursor-Proxy- |
| | Handle (3810 of FIG. 6) to reference new Proxy-Identification, Parent-Handle-Port (3820 of FIG. 6) |
| | to reference new Parent-Identification (3200 of FIG. 3), Left-Cursor-Handle (3830 of FIG. 6) and |
| | Right-Cursor-Handle (3840 of FIG. 6) to reference Cursor-Terminator. Update the CUI-Monitor- |
| | Event (4010 of FIG. 7) found in the Cursor-Identification-Content (3890 of FIG. 6 and 4000 of FIG. 7) |
| | to reference No-Monitor-Event. |
| | Step 4: Update the following fields for the new Proxy-Identification (3600 of FIG. 5): Proxy-Child- |
| | Handle (3610 of FIG. 5) to reference No-Child, Proxy-Handle (3620 of FIG. 5) to reference No- |
| | Proxy, Proxy-Leftmost-Cursor-Handle (3630 of FIG. 5) and Proxy-Rightmost-Cursor-Handle (3640 of |
| | FIG. 5) to reference new Cursor-Identification (3800 of FIG. 6), Proxy-Size (4030 of FIG. 7) found in |
| | the Proxy-Identification-Content (3615 of FIG. 5 and 4020 of FIG. 7) to equal 1. |
| | Step 5: Return the newly created Cursor-Identification (3030 of FIG. 2 and 3800 of FIG. 6). |
| Fields Altered | Parent-Identification(of the new Manabars-Set): Number-Of-Children, Number-Of-Cursors, Index- |
| | Integrity, PI-Monitor-Event, Leftmost-Cursor-Handle, Rightmost-Cursor-Handle, Leftmost-Child- |
| | Handle, Rightmost-Child-Handle, Whole, Float, Fast-ABS-Handle, Slow-ABS-Handle, and Type. |
| | Cursor-Identification (of the new Manabars-Set): Cursor-Proxy-Handle, Parent-Handle-Port, Left- |
| | Cursor-Handle, Right-Cursor-Handle, CUI-Monitor-Event, and Child-Handle. |
| | Proxy-Identification (of the new Manabars-Set): Proxy-Child-Handle, Proxy-Handle, Proxy-Leftmost- |
| | Cursor-Handle, Proxy-Rightmost-Cursor-Handle, and Proxy-Size. |
| Monitors | None |

KI-Delete-Child

| | |
|---|---|
| Inputs | (1) The Cursor-Identification (3030 of FIG. 2 and 3800 of FIG. 6) for this deletion |
| | (2) Action-Polarity. |
| Outputs | None |
| References set up | Current-Child: The Child that the Cursor-Identification (input (1)) is currently pointing to and is to be |
| at the start | deleted - found through the Proxy-Child-Handle (3610 of FIG. 5) of the Current-Proxy. |
| | Current-Proxy: The main Proxy-Identification (3010 of FIG. 2 and 3870 of FIG. 6) of the current |
| | Child found through the Cursor-Proxy-Handle (3810 of FIG. 6) of input (1). |
| | Next-Child: (Able to be No-Child) The Child to which all Cursors currently referencing the Child to |
| | be deleted will now be referencing. Found through the Left-Child-Handle (3410 of FIG. 4) or the |
| | Right-Child-Handle (3420 of FIG. 4) of the Current-Child based on the Action-Polarity (input 2). |
| | Next-Proxy: (Able to be No-Proxy) The main Proxy-Identification (3010 of FIG. 2 and 3870 of FIG. |
| | 6) found through the Child-Proxy-Handle (3430 of FIG. 4) of the Next-Child. |
| | Left-Child: (Able to be No-Child) The Child to the Left of the Child to be deleted (Current-Child) |
| | found through the Left-Child-Handle (3410 of FIG. 4) of the Current-Child. |
| | Right-Child: (Able to be No-Child) The Child to the Right of the Child to be deleted (Current-Child) |
| | found through the Right-Child-Handle (3420 of FIG. 4) of the Current-Child. |
| | Parent-Identification: Found through the Parent-Handle-Port (3820 of FIG. 6) of the Cursor- |
| | Identification (input 1). |
| Generic Behaviour | This method functionally deletes the Child currently pointed to by the Cursor in input (1). |
| | Step 1: The Left-Child-Handle (3410 of FIG. 4) of the Right-Child and the Right-Child-Handle (3420 |
| | of FIG. 4) of Left-Child are updated to reference each other. Check for the following monitors: CHI- |
| | Monitor-Child-Deletes-Left for the Right-Child, CHI-Monitor-Child-Deletes-Right for the Left-Child. |
| | Step 2: Update the Proxy-Handle (3620 of FIG. 5) of the Next-Proxy to reference the Current-Proxy. |
| | Depending on the Action-Polarity (input (2)) update the Proxy-Leftmost-Cursor-Handle (3630 of FIG. |
| | 5) or the Proxy-Rightmost-Cursor-Handle (3640 of FIG. 5) of the Current Proxy to equal the Proxy- |
| | Leftmost-Cursor-Handle or the Proxy-Rightmost-Cursor-Handle of the Next-Proxy. Add the Proxy- |
| | Size (4030 of FIG. 7) found in the Proxy-Identification-Content (3615 of FIG. 5 and 4020 of FIG. 7) of |
| | the Next-Proxy to the Proxy-Size of the Current-Proxy. Update the Proxy-Child-Handle (3610 of |
| | FIG. 5) of the Next-Proxy to reference No-Child. |
| | Step 3: Update the Proxy-Child-Handle (3610 of FIG. 5) of the Current-Proxy to reference the Next- |
| | Child. Update the Child-Proxy-Handle (3430 of FIG. 4) of the Next-Child to reference the Current- |
| | Proxy. Update the Child-Proxy-Handle of the Current-Child to reference No-Proxy. |
| | Step 4: If the Index-Integrity (4430 of FIG. 9) found in the Parent-Identification-Content (3225 of FIG. |
| | 3 and 4400 of FIG. 9) of the Parent-Identification is currently set to True then set it to False, and |
| | check for the PI-Monitor-Bad-Index for the Parent-Identification. Calculate and update the new |
| | values for the Whole-Hashkey (4520 of FIG. 9), Float-Hashkey (4530 of FIG. 9), Fast-ABS-Hashkey |
| | (4540 of FIG. 9) and Slow-ABS-Hashkey (4550 of FIG. 9) of the Parent-Identification-Content. |
| | Step 5: The Asynchronous-Garbage-Collector (2630 of FIG. 14) is informed of the released Child- |
| | Identification (3020 of FIG. 2 and 3400 of FIG. 4) and the Number-Of-Children (4410 of FIG. 9) |
| | found in the Parent-Identification-Content (3225 of FIG. 3 and 4400 of FIG. 9) of the Parent- |
| | Identification is decreased. Check for PI-Monitor-Deletes-Child for the Parent-Identification and CHI- |
| | Monitor-No-Cursor-Identification and CHI-Monitor Child Delete for the Child to be deleted. |
| Fields Altered | Left-Child-Handle (of the Right-Child), Right-Child-Handle (of the Left-Child), Proxy-Handle (of the |
| | Next-Proxy), Proxy-Leftmost-Cursor-Handle or the Proxy-Rightmost-Cursor-Handle (of the Current |
| | Proxy depending on Action-Polarity (input (2)), Proxy-Size (of the Next-Proxy), Proxy-Child-Handle |
| | (of the Next-Proxy), Proxy-Child-Handle (of the Current-Proxy), Child-Proxy-Handle (of the Next- |
| | Child), Child-Proxy-Handle (of the Current-Child), Number-Of-Children (of the Parent-Identification), |
| | Index-Integrity (of the Parent-Identification) |
| Monitors | CHI-Monitor-Child-Deletes-Left (for the Right-Child), CHI-Monitor-Child-Deletes-Right (for the Left- |
| | Child), PI-Monitor-Bad-Index (for the Parent-Identification), PI-Monitor-Deletes-Child (for the Parent- |
| | Identification), CHI-Monitor-Child-Delete (for the Current-Child), CHI-Monitor-No-Cursor- |
| | Identification (for the Current-Child) |
| | Case 1 |
| Occurrence | The Child-Proxy-Handle of the Next-Child is pointing to No-Proxy |
| Deviated | Step 1: Is the same as in the generic behaviour. |
| Behaviour | Step 2: Does not occur. |
| | Steps 2 to 5: Are the same as in the generic behaviour. |
| Fields Altered | Left-Child-Handle (of the Right-Child), Right-Child-Handle (of the Left-Child), Proxy-Child-Handle (of |
| | the Current-Proxy), Child-Proxy-Handle (of the Next-Child), Child-Proxy-Handle (of the Current- |
| | Child), Number-Of-Children (of the Parent-Identification), Index-Integrity (of the Parent-Identification) |
| Monitors | CHI-Monitor-Child-Deletes-Left (for the Right-Child), CHI-Monitor-Child-Deletes-Right (for the Left- |
| | Child), PI-Monitor-Bad-Index (for the Parent-Identification), PI-Monitor-Deletes-Child (for the Parent- |
| | Identification), CHI-Monitor-Child-Delete (for the Current-Child), CHI-Monitor-No-Cursor- |
| | Identification (for the Current-Child) |
| | Case 2 |
| Occurrence | In the boundary case where the Child being deleted is on the Left or Right boundary |
| Deviated | Step 1 - Child on Left Boundary: The Left-Child-Handle (3410 of FIG. 4) of the Right-Child is |
| Behaviour | updated to reference No-Child. The Leftmost-Child-Handle (3460 of FIG. 4 and 3230 of FIG. 3) of |
| | the Parent-Identification is updated to reference the Right-Child. Check for the following monitors: |
| | CHI-Monitor-Child-Deletes-Left and CHI-Monitor-Child-Terminate-Left for the Right-Child and PI- |
| | Monitor-Leftmost for the Parent-Identification. |
| | Step 1: - Child on Right Boundary: The Right-Child-Handle (3420 of FIG. 4) of the Left-Child is |
| | updated to reference No-Child. The Rightmost-Child-Handle (3470 of FIG. 4 and 3240 of FIG. 3) of |
| | the Parent-Identification is updated to reference the Left-Child. Check for the following monitors: |
| | CHI-Monitor-Child-Deletes-Right and CHI-Monitor-Child-Terminate-Right for the Left-Child and PI- |
| | Monitor-Rightmost for the Parent-Identification. |
| | Steps 2 to 5: Are the same as in the generic behaviour. |
| Fields Altered | Left-Child-Handle (of the Right-Child) or Right-Child-Handle (of the Left-Child), Proxy-Handle (of the |
| | Next-Proxy), Proxy-Leftmost-Cursor-Handle or the Proxy-Rightmost-Cursor-Handle (of the Current |
| | Proxy depending on Action-Polarity (input (2)), Proxy-Size (of the Next-Proxy), Proxy-Child-Handle |
| | (of the Next-Proxy), Proxy-Child-Handle (of the Current-Proxy), Child-Proxy-Handle (of the Next- |
| | Child), Child-Proxy-Handle (of the Current-Child), Number-Of-Children (of the Parent-Identification), |
| | Index-Integrity (of the Parent-Identification), Leftmost-Child-Handle or Rightmost-Child-Handle (of |
| | the Parent-Identification). |
| Monitors | CHI-Monitor-Child-Deletes-Left (for the Right-Child) or Right-Child-Handle (of the Left-Child), PI- |
| | Monitor-Bad-Index (for the Parent-Identification), PI-Monitor-Deletes-Child (for the Parent- |
| | Identification), CHI-Monitor-Child-Delete (for the Current-Child), CHI-Monitor-No-Cursor- |
| | Identification (for the Current-Child), CHI-Monitor-Child-Terminate-Left (for the Right-Child) or CHI- |
| | Monitor-Child-Terminate-Right (for the Right-Child), PI-Monitor-Child-Leftmost (for the Parent- |
| | Identification) or PI-Monitor-Child-Rightmost (for the Parent-Identification). |
| | Case 3 |
| Occurrence | There is only one Child in the Parent Set before the deletion |
| Deviated | Step 1: Update the Leftmost-Child-Handle (3230 of FIG. 3) and Rightmost-Child-Handle (3240 of |
| Behaviour | FIG. 3) of the Parent-Identification to reference No-Child. |
| | Step 2: Does not happen. |
| | Step 3: Update the Proxy-Child-Handle (3610 of FIG. 5) of the Current-Proxy to reference the No- |
| | Child. |
| | Step 4: If the Index-Integrity (4430 of FIG. 9) found in the Parent-Identification-Content (3225 of |
| | FIG. 3 and 4400 of FIG. 9) of the Parent-Identification is currently set to False then set it to True and |
| | check for the PI-Monitor-Good-Index for the Parent-Identification. Update the new values for the |
| | Whole-Hashkey (4520 of FIG. 9), Float-Hashkey (4530 of FIG. 9), Fast-ABS-Hashkey (4540 of FIG. |
| | 9) and Slow-ABS-Hashkey (4550 of FIG. 9) of the Parent-Identification-Content. |
| | Step 5: The Asynchronous-Garbage-Collector (2630 of FIG. 14) is informed of the released Child- |
| | Identification (3020 of FIG. 2 and 3400 of FIG. 4), and the Number-Of-Children (4410 of FIG. 9) |
| | found in the Parent-Identification-Content (3225 of FIG. 3 and 4400 of FIG. 9) of the Parent- |
| | Identification is decreased. |
| | Check for PI-Monitor-Deletes-Child, PI-Monitor-Child-Leftmost, PI-Monitor-Child-Rightmost and PI- |
| | Monitor-No-Child for the Parent-Identification and CHI-Monitor-No-Cursor-Identification and CHI- |
| | Monitor Child Delete for the Child to be deleted. |
| Fields Altered | Proxy-Child-Handle (of the Current-Proxy), Number-Of-Children (of the Parent-Identification), Index- |
| | Integrity (of the Parent-Identification), Leftmost-Child-Handle (of the Parent-Identification), |
| | Rightmost-Child-Handle (of the Parent-Identification). |
| Monitors | CHI-Monitor-Child-Delete (for the Current-Child), CHI-Monitor-No-Cursor-Identification (for the |
| | Current-Child), PI-Monitor-Child-Leftmost (for the Parent-Identification), PI-Monitor-Child-Rightmost |
| | (for the Parent-Identification), PI-Monitor-Good-Index (for the Parent-Identification), PI-Monitor- |
| | Deletes-Child (for the Parent-Identification), PI-Monitor-No-Child (for the Parent-Identification). |
| | Case 4 |
| Occurrence | There are no Children |
| Deviated | Do nothing |
| Behaviour | |
| Fields Altered | None |
| Monitors | None |

KI-Get-Adjacent-Cursor-Identification

| | |
|---|---|
| Inputs | (1) Cursor-Identification (3030 of FIG. 2 and 3800 of FIG. 6) for which the adjacent Cursor- |
| | Identification is required, (2) the Action-Polarity that indicates if it is the Left or Right Cursor- |
| | Identification that is sought. |
| Outputs | (1) The Cursor-Identification of the adjacent Cursor |
| References set up | Left-Cursor: (Able to be Cursor-Terminator) The Cursor to the Left of the Cursor-Identification |
| at the start | (input (1)) found through the Left-Cursor-Handle (3830 of FIG. 6) of the Cursor-Identification (input |
| | (1)). |
| | Right-Cursor: (Able to be Cursor-Terminator) The Cursor to the Right of the Cursor-Identification |
| | (input (1)) found through the Right-Cursor-Handle (3840 of FIG. 6) of the Cursor-Identification (input |
| | (1)). |
| Generic Behaviour | This method returns the Cursor-Identification (3030 of FIG. 2 and 3800 of FIG. 6) to the Left or |
| | Right of input (1) that forms part of the chain of Cursor-Identifications. |
| | Step 1: Return the Left-Cursor or Right-Cursor depending on the Action-Polarity (input (2)). Check |
| | for the CUI-Monitor-Cursor-Retrieved. |
| Fields Altered | None |
| Monitors | CUI-Monitor-Cursor-Retrieved (for the Left-Cursor or Right-Cursor (dependent on Action-Polarity |
| | (input (2))) |
| | Case 1 |
| Occurrence | If the Left-Cursor when input (2) is Left or the Right-Cursor when input (2) is Right is set to Cursor- |
| | Terminator |
| Deviated | Step 1: The method returns the Cursor-Identification (3030 of FIG. 2 and 3800 of FIG. 6) equal to |
| Behaviour | input (1) because there are no more Cursor-Identifications in the direction specified. Check for the |
| | CUI-Monitor-Cursor-Retrieved. |
| Fields Altered | None |
| Monitors | CUI-Monitor-Cursor-Retrieved (for the Left-Cursor or Right-Cursor (dependent on Polarity (input (2)) |
| | of input (1)) |

KI-Get-Boundary-Cursor-Identification

| | |
|---|---|
| Inputs | (1) Any Cursor-Identification (3030 of FIG. 2 and 3800 of FIG. 6) of the shared Parent-Identification |
| | (3040 of FIG. 2 and 3200 of FIG. 3) for which the boundary Cursor-Identification is required, (2) the |
| | Action-Polarity that indicates if it is the Leftmost or Rightmost Cursor-Identification that is sought. |
| Outputs | (1) The Cursor-Identification of the boundary Cursor |
| References set up | Parent-Identification: Found through the Parent-Handle-Port (3820 of FIG. 6) of the Cursor- |
| at the start | Identification of input (1). |
| | Leftmost-Cursor: (Able to be Cursor-Terminator) Found through the Leftmost-Cursor-Handle (3210 |
| | of FIG. 3) of the Parent-Identification. |
| | Rightmost-Cursor: (Able to be Cursor-Terminator) Found through the Rightmost-Cursor-Handle |
| | (3220 of FIG. 3) of the Parent-Identification. |
| Generic Behaviour | This method returns the Rightmost-Cursor or Leftmost-Cursor that shares the same Parent- |
| | Identification as input (1) and which forms part of the chain of Cursor-Identifications. |
| | Step 1: Check for and trigger the CUI-Monitor-Cursor-Retrieved and return the Rightmost-Cursor or |
| | Leftmost Cursor dependent on the Action-Polarity (input (2)). |
| Fields Altered | None |
| Monitors | CUI-Monitor-Cursor-Retrieved (for the Leftmost-Cursor or Rightmost-Cursor (dependent on Polarity |
| | (input (2)) |

KI-Get-Child

| | |
|---|---|
| Inputs | (1) Cursor-Identification (3030 of FIG. 2 and 3800 of FIG. 6) which is pointing to the Child to be |
| | retrieved |
| Outputs | The newly found Child Cursor-Identification. |
| References set up | Current-Proxy: The main Proxy-Identification (3010 of FIG. 2 and 3870 of FIG. 6) found through the |
| at the start | Cursor-Proxy-Handle (3810 of FIG. 6) of input (1). |
| | Current-Child: The Child that the Cursor-Identification (input (1)) is currently pointing to - found |
| | through the Proxy-Child-Handle (3610 of FIG. 5) of the Current-Proxy. |
| Generic Behaviour | This method retrieves the Cursor-Identification found within the Child of input (1). |
| | Step 1: Find the Cursor-Identification (3030 of FIG. 2 and 3800 of FIG. 6) of the Child through the |
| | Parent-Handle-Starboard (3440 of FIG. 4) of the Current-Child. Check for and trigger the CUI- |
| | Monitor-Cursor-Retrieved. |
| Fields Altered | None |
| Monitors | CUI-Monitor-Cursor-Retrieved (for the retrieved Cursor) |

KI-Get-Fast-ABS-Handle

| | |
|---|---|
| Inputs | (1) Cursor-Identification (3030 of FIG. 2 and 3800 |
| | of FIG. 6) that identifies the Parent-Identification |
| | (3040 of FIG. 2 and 3200 of FIG. 3) which locates |
| | the Fast-ABS-Handle (4460 of FIG. 9) to be |
| | retrieved. |
| Outputs | The newly found Fast-ABS-Handle. |
| References set up | Parent-Identification: Found through |
| at the start | the Parent-Handle-Port (3820 of FIG. 6) of the |
| | Cursor-Identification of input (1). |
| Generic Behaviour | This method retrieves the Fast-ABS-Handle |
| | of the Parent-Identification. |
| | Step 1: Locate and |
| | return the Fast-ABS-Handle (4460 of FIG. 9) |
| | found within the Parent-Identification-Content |
| | (3225 of FIG. 3 and 4400 of FIG. 9) |
| | of the Parent-Identification. |
| Fields Altered | None |
| Monitors | None |

KI-Get-Fast-ABS-Hashkey

| | |
|---|---|
| Inputs | (1) Cursor-Identification (3030 of FIG. 2 and 3800 |
| | of FIG. 6) that identifies the Parent-Identification |
| | (3040 of FIG. 2 and 3200 of FIG. 3) which locates |
| | the Fast-ABS-Hashkey (4540 of FIG. 9) to be |
| | retrieved. |
| Outputs | The newly found Fast-ABS-Hashkey. |
| References set up | Parent-Identification: Found through the |
| at the start | Parent-Handle-Port (3820 of FIG. 6) of the |
| | Cursor-Identification of input (1). |
| Generic Behaviour | This method retrieves the Fast-ABS-HashKey |
| | of the Parent-Identification. |
| | Step 1: Locate and return the Fast-ABS-HashKey |
| | (4540 of FIG. 9) found within the Parent- |
| | Identification-Content (3225 of FIG. 3 and |
| | 4400 of FIG. 9) of the Parent-Identification. |
| Fields Altered | None |
| Monitors | None |

KI-Get-Float

| | |
|---|---|
| Inputs | (1) Cursor-Identification (3030 of FIG. 2 and 3800 |
| | of FIG. 6) that identifies the Parent-Identification |
| | (3040 of FIG. 2 and 3200 of FIG. 3) which |
| | locates the Float (4450 of FIG. 9) to be retrieved. |
| Outputs | The newly found Float. |
| References set up | Parent-Identification: Found through the |
| at the start | Parent-Handle-Port (3820 of FIG. 6) of the Cursor- |
| | Identification of input (1). |
| Generic Behaviour | This method retrieves the Float |
| | of the Parent-Identification. |
| | Step 1: Locate |
| | and return the Float (4450 of FIG. 9) found |
| | within the Parent-Identification-Content |
| | (3225 of FIG. 3 and 4400 of FIG. 9) |
| | of the Parent-Identification. |
| Fields Altered | None |
| Monitors | None |

KI-Get-Float-Hashkey

| | |
|---|---|
| Inputs | (1) Cursor-Identification (3030 of FIG. 2 and 3800 |
| | of FIG. 6) that identifies the Parent-Identification |
| | (3040 of FIG. 2 and 3200 of FIG. 3), which locates |
| | the Float-Hashkey (4530 of FIG. 9) to be |
| | retrieved. |
| Outputs | The newly found Float-Hashkey. |
| References set up | Parent-Identification: Found through the |
| at the start | Parent-Handle-Port (3820 of FIG. 6) of the |
| | Cursor-Identification of input (1). |
| Generic Behaviour | This method retrieves the Float-HashKey |
| | of the Parent-Identification. |
| | Step 1: Locate and return the Float-HashKey |
| | (4530 of FIG. 9) found within the |
| | Parent-Identification- |
| | Content (3225 of FIG. 3 and 4400 of FIG. 9) |
| | of the Parent-Identification. |
| Fields Altered | None |
| Monitors | None |

KI-Get-Governance-Layer

| | |
|---|---|
| Inputs | None |
| Outputs | (1) The Cursor-Identification (3030 of FIG. 2 and |
| | 3800 of FIG. 6) of the Governance-Layer |
| References set up | None |
| at the start | |
| Generic Behaviour | This method returns a reference to the |
| | Governance-Layer as configured by the |
| | Set-Governance-Layer method. |
| | Step 1: This handle is found indirectly from the |
| | Governance-Layer-Handle (2615d of FIG. 14). |
| | Check for and trigger the |
| | CUI-Monitor-Cursor-Retrieved. |
| Fields Altered | None |
| Monitors | CUI-Monitor-Cursor-Retrieved |
| | (of the retrieved Cursor) |

KI-Get-Index

| | |
|---|---|
| Inputs | (1) Cursor-Identification (3030 of FIG. 2 and 3800 of FIG. 6) for which the index is required, (2) the |
| | polarity that indicates the frame of reference for the index being Left or Right |
| Outputs | (1) The index of the Cursor-Identification input |
| References set up | Parent-Identification: Found through the Parent-Handle-Port (3820 of FIG. 6) of the Cursor- |
| at the start | Identification of input (1). |
| | Parent-Identification-Content: Refers to the Parent-Identification-Content (3225 of FIG. 3 and |
| | 4400 of FIG. 9) of the Parent-Identification. |
| | Current-Child: The Child that the Cursor-Identification (input (1)) is currently pointing to - found |
| | through the Proxy-Child-Handle (3610 of FIG. 5) of the main Proxy-Identification (3010 of FIG. 2 and |
| | 3870 of FIG. 6) found through the Cursor-Proxy-Handle (3810 of FIG. 6) of input (1). |
| Generic Behaviour | This method returns the Left-Index (4220 of FIG. 8) of the Child identified by the Cursor or the |
| | calculated Right-Index, dependent on Polarity (input (2)). |
| | Step 1: Check that the Index-Integrity (4430 of FIG. 9) found in the Parent-Identification-Content is |
| | set to true. |
| | Step 2: If the Polarity (input (2)) is Left then the return value is the Left-Index (4220 of FIG. 8) found |
| | in the Child-Identification-Content (3445 of FIG. 4 and 4200 of FIG. 8) of the Current-Child, |
| | otherwise if the Polarity (input (2)) is Right, then locate the Number-Of-Children (4410 of FIG. 9) |
| | found in the Parent-Identification-Content, and subtract (the Left-Index + 1). Check for and trigger |
| | the CUI-Monitor-Index-Queried. |
| Fields Altered | None |
| Monitors | CUI-Monitor-Index-Queried |
| | Case 1 |
| Occurrence | The Index-Integrity of the Parent-Handle-Port of input (1) is set to false |
| Deviated | Step 1: Locate the Leftmost-Child-Handle (3230 of FIG. 3) of the Parent-Identification and set its |
| Behaviour | Left-Index (4220 of FIG. 8) found in the Child-Identification-Content (3445 of FIG. 4 and 4200 of FIG. |
| | 8) of the Child-Identification to 1. |
| | Step 2: Find the next Child through the Right-Child-Handle (3420 of FIG. 4) of the last Child; |
| | increase the number of the Left-Index (4220 of FIG. 8) and set the next Child's Left-Index. Repeat |
| | Step 2 until all Children have been updated. |
| | Step 3: Once all the Children in the Parent have had the Left-Index (4220 of FIG. 8) set then set the |
| | Index-Integrity (4430 of FIG. 9) found in the Parent-Identification-Content (3225 of FIG. 3 and 4400 |
| | of FIG. 9) to true, check for and trigger the PI-Monitor-Good-Index, and return to Step 2 of the |
| | Generic Behaviour. |
| Fields Altered | Left-Index (of all Children) and Index-Integrity (of Parent-Identification) |
| Monitors | PI-Monitor-Good-Index (for Parent-Identification) |

KI-Get-Number-Children

| | |
|---|---|
| Inputs | (1) A Cursor-Identification (3030 of FIG. 2 and 3800 of FIG. 6) that locates the shared Parent- |
| | Identification (3040 of FIG. 2 and 3200 of FIG. 3) for which the number of Children is requested |
| Outputs | The number of Children for the identified Parent-Identification. |
| References set up | Parent-Identification: Found through the Parent-Handle-Port (3820 of FIG. 6) of the Cursor- |
| at the start | Identification of input (1). |
| Generic Behaviour | This method returns the number of Children that all share the same Parent as input (1). |
| | Step 1: Check for and trigger the PI-Monitor-Number-Children-Queried. Return the Number-Of- |
| | Children (4410 of FIG. 9) found within the Parent-Identification-Content (3225 of FIG. 3 and 4400 of |
| | FIG. 9) of the Parent-Identification. |
| Fields Altered | None |
| Monitors | PI-Monitor-Number-Children-Queried |

KI-Get-Number-Cursors

| | |
|---|---|
| Inputs | (1) A Cursor-Identification (3030 of FIG. 2 and 3800 of FIG. 6) that locates the shared Parent- |
| | Identification (3040 of FIG. 2 and 3200 of FIG. 3) for which the number of Cursor-Identifications is |
| | requested. |
| Outputs | The number of Cursors for the identified Parent-Identification. |
| References set up | Parent-Identification: Found through the Parent-Handle-Port (3820 of FIG. 6) of the Cursor- |
| at the start | Identification of input (1). |
| Generic Behaviour | This method returns the number of Cursors each represented by a unique Cursor-Identification that |
| | all share the same Parent as input (1). |
| | Step 1: Check for and trigger the PI-Monitor-Number-Of-Cursors-Queried. Return the Number-Of- |
| | Cursors (4420 of FIG. 9) found within the Parent-Identification-Content (3225 of FIG. 3 and 4400 of |
| | FIG. 9) of the Parent-Identification. |
| Fields Altered | None |
| Monitors | PI-Monitor-Number-of-Cursors-Queried |

KI-Get-Number-Sharing-Cursor-Identifications

| | |
|---|---|
| Inputs | (1) A Cursor-Identification (3030 of FIG. 2 and 3800 of FIG. 6) that locates the Child-Identification |
| | (3020 of FIG. 2 and 3400 of FIG. 4) for which the number of Cursor-Identifications that share it is |
| | requested. |
| Outputs | The number of shared Cursor-Identifications for the identified Child-Identification. |
| References set up | Proxy-Identification: The main Proxy-Identification (3010 of FIG. 2 and 3870 of FIG. 6) found |
| at the start | through the Cursor-Proxy-Handle (3810 of FIG. 6) of input (1). |
| Generic Behaviour | This method returns the number of Cursors that all share the same Child as input (1). |
| | Step 1: Check for and trigger the CHI-Monitor-Number-Sharing-Cursors-Identifications-Queried. |
| | Return the Proxy-Size (4030 of FIG. 7) found in the Proxy-Identification-Content (3615 of FIG. 5 and |
| | 4020 of FIG. 7) of the Proxy-Identification. |
| Fields Altered | None |
| Monitors | CHI-Monitor-Number-Sharing-Cursors-Identifications-Queried |

KI-Get-Parent-Identification

| | |
|---|---|
| Inputs | (1) A Cursor-Identification (3030 of FIG. 2 and |
| | 3800 of FIG. 6) that is used to Identify the Parent- |
| | Identification. (3040 of FIG. 2 and 3200 of FIG. 3). |
| Outputs | The Parent-Identification of the |
| | Cursor-Identification. |
| References set up | None |
| at the start | |
| Generic Behaviour | This method returns the |
| | Parent-Identification of input |
| | (1) and not the Parent-Set that contains the |
| | Cursor-Identification. |
| | Step 1: Locate and return the Parent-Handle-Port |
| | (3270 of FIG. 3 and 3820 of FIG. 6) of input (1). |
| Fields Altered | None |
| Monitors | None |

KI-Get-Powerset

| | |
|---|---|
| Inputs | None |
| Outputs | Returns the Cursor-Identification for the Powerset |
| References set up | None |
| at the start | |
| Generic Behaviour | The Cursor-Identification (3030 of FIG. 2 and 3800 |
| | of FIG. 6) is retrieved from permanent storage. |
| | Check and trigger the CUI-Monitor-Cursor- |
| | Retrieved |
| Fields Altered | None |
| Monitors | CUI-Monitor-Cursor-Retrieved (of the Cursor- |
| | Identification of the Powerset) |

KI-Get-Slow-ABS-Handle

| | |
|---|---|
| Inputs | (1) Cursor-Identification (3030 of FIG. 2 and 3800 |
| | of FIG. 6) that identifies the Parent-Identification |
| | (3040 of FIG. 2 and 3200 of FIG. 3) which locates the |
| | Slow-ABS-Handle (4470 of FIG. 9) to be retrieved. |
| Outputs | The newly found Slow-ABS-Handle. |
| References set up | Parent-Identification: Found through the |
| at the start | Parent-Handle-Port (3820 of FIG. 6) of the Cursor- |
| | Identification of input (1). |
| Generic | This method retrieves the Slow-ABS-Handle |
| Behaviour | Parent-Identification. |
| | Step 1: Locate and return the Slow-ABS-Handle (4470 |
| | of FIG. 9) found within the Parent- |
| | Identification-Content (3225 of FIG. 3 and 4400 |
| | of FIG. 9) of the Parent-Identification. |
| Fields Altered | None |
| Monitors | None |

KI-Get-Slow-ABS-Hashkey

| | |
|---|---|
| Inputs | (1) Cursor-Identification (3030 of FIG. 2 and 3800 |
| | of FIG. 6) that identifies the Parent-Identification |
| | (3040 of FIG. 2 and 3200 of FIG. 3) which locates |
| | the Slow-ABS-Hashkey (4550 of FIG. 9) to be |
| | retrieved. |
| Outputs | The newly found Slow-ABS-Hashkey. |
| References set up | Parent-Identification: Found through |
| at the start | the Parent-Handle-Port (3820 of FIG. 6) of the Cursor- |
| | Identification of input (1). |
| Generic | This method retrieves the Slow-ABS-HashKey |
| Behaviour | of the Parent-Identification. |
| | Step 1: Locate and return the Slow-ABS-HashKey |
| | (4550 of FIG. 9) - found within the Parent- |
| | Identification-Content (3225 of FIG. 3 and 4400 |
| | of FIG. 9) of the Parent-Identification. |
| Fields Altered | None |
| Monitors | None |

KI-Get-Type

| | |
|---|---|
| Inputs | (1) Cursor-Identification (3030 of FIG. 2 and 3800 of |
| | FIG. 6) that identifies the Parent-Identification |
| | (3040 of FIG. 2 and 3200 of FIG. 3), which locates the |
| | Type (4480 of FIG. 9) to be retrieved. |
| Outputs | The newly found Type. |
| References | Parent-Identification: Found through the Parent-Handle-Port |
| set up at | (3820 of FIG. 6) of the Cursor- |
| the start | Identification of input (1). |
| Generic | This method retrieves the Type of the Parent-Identification. |
| Behaviour | Step 1: Locate and return the Type (4480 of FIG. 9) - found |
| | within the Parent-Identification-Content |
| | (3225 of FIG. 3 and 4400 of FIG. 9) of the Parent- |
| | Identification. |
| Fields | None |
| Altered | |
| Monitors | None |

KI-Get-Whole

| | |
|---|---|
| Inputs | (1) Cursor-Identification (3030 of FIG. 2 and 3800 |
| | of FIG. 6) that identifies the Parent-Identification |
| | (3040 of FIG. 2 and 3200 of FIG. 3), which locates |
| | the Whole (4440 of FIG. 9) to be retrieved. |
| Outputs | The newly found Whole. |
| References set up | Parent-Identification: Found through the |
| at the start | Parent-Handle-Port (3820 of FIG. 6) of the Cursor- |
| | Identification of input (1). |
| Generic Behaviour | This method retrieves the Whole of the Parent- |
| | Identification. |
| | Step 1: Locate and return the Whole (4440 of FIG. |
| | 9) - found within the Parent-Identification- |
| | Content (3225 of FIG. 3 and 4400 of FIG. 9) of the |
| | Parent-Identification. |
| Fields Altered | None |
| Monitors | None |

KI-Get-Whole-Hashkey

| | |
|---|---|
| Inputs | (1) Cursor-Identification (3030 of FIG. 2 and 3800 of |
| | FIG. 6) that identifies the Parent-Identification |
| | (3040 of FIG. 2 and 3200 of FIG. 3), which locates |
| | the Whole-Hashkey (4520 of FIG. 9) to be retrieved. |
| Outputs | The newly found Whole-Hashkey. |
| References set up | Parent-Identification: Found through the |
| at the start | Parent-Handle-Port (3820 of FIG. 6) of the Cursor- |
| | Identification of input (1). |
| Generic | This method retrieves the Whole-HashKey of the |
| Behaviour | Parent-Identification. |
| | Step 1: Locate and return the Whole-HashKey (4520 |
| | of FIG. 9) - found within the Parent-Identification- |
| | Content (3225 of FIG. 3 and 4400 of FIG. 9) of the |
| | Parent-Identification. |
| Fields Altered | None |
| Monitors | None |

KI-Insert-And-Spawn

| | |
|---|---|
| Inputs | (1) The Cursor-Identification (3030 of FIG. 2 and 3800 |
| | of FIG. 6) that identifies the destination |
| | location where the new Child is to be inserted, (2) the |
| | Cursor-Identification that identifies the source |
| | Child to be inserted into the 1^{st} parameter, |
| | (3) Action-Trilarity (4) Lock-Mode |
| Outputs | (1) The handle of the newly formed Cursor-Identification |
| References | None |
| set up at the | |
| start | |
| Generic | This method functionally creates a new Cursor |
| Behaviour | based on the Cursor-Identification of input (1) and |
| | inserts the source Child into the destination location |
| | utilising the newly formed Cursor-Identification. |
| | Step 1: Call the KI-Spawn-Cursor method, with input (1) |
| | used as the method input. |
| | Step 2: Call the KI-Insert-Child method, with the |
| | returned Cursor Identification from Step 1 as the |
| | first method input, and inputs (2-4) as the remaining |
| | method inputs. |
| Fields Altered | All fields that are altered in the KI-Spawn-Cursor |
| | and KI-Insert-Child methods |
| Monitors | All Monitors that are in the KI-Spawn-Cursor and |
| | KI-Insert-Child methods |

KI-Insert-Child

| | |
|---|---|
| Inputs | (1) The Cursor-Identification (3030 of FIG. 2 and 3800 of FIG. 6) that identifies the destination |
| | location where the new Manabars-Set reference is to be inserted, (2) the Cursor-Identification |
| | identifies the source Child to be inserted into the 1^{st} parameter, (3) Action-Trilarity (4) Lock-Mode |
| Outputs | None |
| References set up | Current-Proxy: The main Proxy-Identification (3010 of FIG. 2 and 3870 of FIG. 6) found through the |
| at the start | Cursor-Proxy-Handle (3810 of FIG. 6) of input (1). |
| | Current-Child: The Child that the Cursor-Identification (input (1)) is currently pointing to - found |
| | through the Proxy-Child-Handle (3610 of FIG. 5) of the Current-Proxy. |
| | New-Child: The new Child-Identification (3020 of FIG. 2 and 3400 of FIG. 4) that is created in Step |
| | 1. |
| | Left-Child: (Able to be No-Child) The Child that will be to the Left of the Child to be inserted (New- |
| | Child) if the Action-Trilarity is Neutral or Left then the Left-Child is found through the Left-Child- |
| | Handle (3410 of FIG. 4) of the Current-Child. Otherwise if the Action-Trilarity is Right then the Left- |
| | Child is the same as the Child identified by the Cursor. |
| | Right-Child: (Able to be No-Child) The Child that will be to the right of the Child to be inserted |
| | (New-Child) if the Action-Trilarity is neutral or right then the Right-Child is found through the Right- |
| | Child-Handle (3420 of FIG. 4) of the Current-Child. Otherwise if the Action-Trilarity is Left then the |
| | Right-Child is the same as the Child identified by the Cursor. |
| | Parent-Identification: Found through the Parent-Handle-Port (3820 of FIG. 6) of the Cursor- |
| | Identification (input 1). |
| | Old-Left-Cursor: (Able to be Cursor-Terminator) Found through the Left-Cursor-Handle (3830 of |
| | FIG. 6) of the Cursor-Identification (input (1)). |
| | Old-Right-Cursor: (Able to be Cursor-Terminator) Found through the Right-Cursor-Handle (3840 of |
| | FIG. 6) of the Cursor-Identification (input (1)). |
| Generic Behaviour | This method functionally inserts the source Child into the destination location without modifying the |
| | source Cursor-Identification so that the method replicates a reference. |
| | Step 1: Create a new Child-Identification (3020 of FIG. 2 and 3400 of FIG. 4) and set the Parent- |
| | Handle-Starboard (3440 of FIG. 4) to reference the Cursor-Identification (3030 of FIG. 2 and 3800 of |
| | FIG. 6) of input (2). The CHI-Monitor-Event (4210 of FIG. 8), found in the Child-Identification- |
| | Content (3445 of FIG. 4 and 4200 of FIG. 8) of the New-Child, will be set to No-Monitor-Event. |
| | Step 2: The Left-Index (4220 of FIG. 8) found in the Child-Identification-Content (3445 of FIG. 4 and |
| | 4200 of FIG. 8) of the New-Child will be set to 0. If the Index-Integrity (4430 of FIG. 9) found in the |
| | Parent-Identification-Content (3225 of FIG. 3 and 4400 of FIG. 9) of the Parent-Identification is true |
| | then set it to false and check for the PI-Monitor-Bad-Index for the Parent-Identification. |
| | Step 3: Update the Right-Child-Handle (3420 of FIG. 4) of the New-Child to reference the Right- |
| | Child, and the Left-Child-Handle (3410 of FIG. 4) of the New-Child to reference the Left-Child. |
| | Update the Left-Child-Handle of the Right-Child and the Right-Child-Handle of the Left-Child to |
| | reference the New-Child. Increase the Number-Of-Children (4410 of FIG. 9) found in the Parent- |
| | Identification-Content (3225 of FIG. 3 and 4400 of FIG. 9) of the Parent-Identification. Check for the |
| | CHI-Monitor-Child-Inserts-Left for the Right-Child, CHI-Monitor-Child-Inserts-Right for the Left-Child, |
| | and PI-Monitor-Inserts-Child for the Parent-Identification. |
| | Step 4: Update the Left-Cursor-Handle (3830 of FIG. 6) of the Old-Right-Cursor and the Right- |
| | Cursor-Handle (3840 of FIG. 6) of the Old-Left-Cursor to reference each other. |
| | Step 5a: If the Action-Trilarity (input (3)) is Left: Locate the New-Right-Cursor found through the |
| | Proxy-Leftmost-Cursor-Handle (3630 of FIG. 5) of the Current-Proxy. Locate the New-Left-Cursor |
| | through the Left-Cursor-Handle (3830 of FIG. 6) of the New-Right-Cursor. |
| | Step 5b: If the Action-Trilarity (input (3)) is Right: Locate the New-Left-Cursor found through the |
| | Proxy-Rightmost-Cursor-Handle (3640 of FIG. 5) of the Current-Proxy. Locate the New-Right- |
| | Cursor through the Right-Cursor-Handle (3840 of FIG. 6) of the New-Left-Cursor. |
| | Step 5: Update the Right-Cursor-Handle and the Left-Cursor-Handle of the Cursor-Identification |
| | (input (1)) to reference the New-Left-Cursor and the New-Right-Cursor. Update the Right-Cursor- |
| | Handle (3840 of FIG. 6) of the New-Left-Cursor and the Left-Cursor-Handle (3830 of FIG. 6) of the |
| | New-Right-Cursor to reference the Cursor-Identification (input (1)). |
| | Step 6: Create a new Proxy-Identification (3010 of FIG. 2 and 3600 of FIG. 5) and update the |
| | Cursor-Proxy-Handle (3810 of FIG. 6) of the Cursor-Identification (input (1)) and the Child-Proxy- |
| | Handle (3430 of FIG. 4) of the New-Child to reference the new Proxy-Identification. Update the |
| | Proxy-Child-Handle (3500 of FIG. 4 and 3610 of FIG. 5) of the new Proxy-Identification to reference |
| | the New-Child. Update the Proxy-Handle (3620 of FIG. 5) of the new Proxy-Identification to |
| | reference no-Proxy. Update the Proxy-Leftmost-Cursor-Handle (3630 of FIG. 5) and the Proxy- |
| | Rightmost-Cursor-Handle (3640 of FIG. 5) of the new Proxy-Identification to reference the Cursor- |
| | Identification (input (1)). Update the Proxy-Size (4030 of FIG. 7) found in the Proxy-Identification- |
| | Content (3615 of FIG. 5 and 4020 of FIG. 7) of the new Proxy-Identification to equal 1. Check for |
| | the CHI-Monitor-Cursor-Identification-Shifted-Off-Child for the Current-Child. |
| | Step 7: Calculate and update the new values for the Whole-Hashkey (4520 of FIG. 9), Float- |
| | Hashkey (4530 of FIG. 9), Fast-ABS-Hashkey (4540 of FIG. 9) and Slow-ABS-Hashkey (4550 of |
| | FIG. 9) of the Parent-Identification-Content. |
| Fields Altered | Parent-Handle-Starboard (of the New-Child), Left-Index (of the New-Child), Index-Integrity (of the |
| | Parent-Identification), Right-Child-Handle and the Left-Child-Handle (of the New-Child), Left-Child- |
| | Handle (of the Right-Child) and the Right-Child-Handle of the (Left-Child), Number-Of-Children (of |
| | the Parent-Identification), Left-Cursor-Handle (of the Old-Right-Cursor), Right-Cursor-Handle (of the |
| | Old-Left-Cursor), Right-Cursor-Handle and the Left-Cursor-Handle (of the Cursor-Identification (input |
| | (1))), Right-Cursor-Handle (of the New-Left-Cursor), Left-Cursor-Handle (of the New-Right-Cursor), |
| | Cursor-Proxy-Handle (of the Cursor-Identification (input (1))), Child-Proxy-Handle (of the New-Child), |
| | Proxy-Child-Handle (of the new Proxy-Identification), Proxy-Handle (of the new Proxy-Identification), |
| | Proxy-Leftmost-Cursor-Handle and the Proxy-Rightmost-Cursor-Handle (of the new Proxy- |
| | Identification), Proxy-Size (of the new Proxy-Identification). |
| Monitors | PI-Monitor-Bad-Index (for the Parent-Identification), CHI-Monitor-Child-Inserts-Left (for the Right- |
| | Child), CHI-Monitor-Child-Inserts-Right (for the Left-Child), PI-Monitor-Inserts-Child (for the Parent- |
| | Identification), CHI-Monitor-Cursor-Identification-Shifted-Off-Child (for the Current-Child), |
| | Case 1 |
| Occurrence | There are no previous Children before the insert. |
| Deviated | Step 1: Is the same as in the Generic Behaviour. |
| Behaviour | Step 2: The Left-Index (4220 of FIG. 8) found in the Child-Identification-Content (3445 of FIG. 4 and |
| | 4200 of FIG. 8) of the New-Child will be set to 1. |
| | Step 3: Update the Right-Child-Handle (3420 of FIG. 4) and the Left-Child-Handle (3410 of FIG. 4) |
| | of the New-Child to reference No-Child. Update the Leftmost-Child-Handle (3230 of FIG. 3) and the |
| | Rightmost-Child-Handle (3240 of FIG. 3) of the Parent-Identification to reference the New-Child. |
| | Increase the Number-Of-Children (4410 of FIG. 9) found in the Parent-Identification-Content (3225 |
| | of FIG. 3 and 4400 of FIG. 9) for the Parent-Identification. Check PI-Monitor-Inserts-Child, PI- |
| | Monitor-Has-Child, PI-Monitor-Child-Rightmost and PI-Monitor-Child-Leftmost for the Parent- |
| | Identification. |
| | Steps 4 + 5: Do not happen. |
| | Step 6: Update the Child-Proxy-Handle (3430 of FIG. 4) of the New-Child to reference the Current- |
| | Proxy. Update the Proxy-Child-Handle (3500 of FIG. 4 and 3610 of FIG. 5) of the Current-Proxy to |
| | reference the New-Child. |
| | Step 7: Is the same as in the Generic Behaviour. |
| Fields Altered | Parent-Handle-Starboard (of the New-Child), Left-Index (of the New-Child), Right-Child-Handle and |
| | the Left-Child-Handle (of the New-Child), Leftmost-Child-Handle and the Rightmost-Child-Handle (of |
| | the Parent-Identification), Number-Of-Children (of the Parent-Identification), Child-Proxy-Handle (of |
| | the New-Child), Proxy-Child-Handle (of the Current-Proxy). |
| Monitors | PI-Monitor-Inserts-Child, PI-Monitor-Has-Child, PI-Monitor-Child-Rightmost and PI-Monitor-Child- |
| | Leftmost (for the Parent-Identification). |
| | Case 2 |
| Occurrence | The Lock-Mode (input (4)) is true |
| Deviated | Steps 1-3: Are the same as in the Generic Behaviour. |
| Behaviour | Steps 4-6: Do not Happen |
| | Step 7: Is the same as in the Generic Behaviour. |
| Fields Altered | Parent-Handle-Starboard (of the New-Child), Left-Index (of the New-Child), Index-Integrity (of the |
| | Parent-Identification), Right-Child-Handle and the Left-Child-Handle (of the New-Child), Left-Child- |
| | Handle (of the Right-Child) and the Right-Child-Handle of the (Left-Child), Number-Of-Children (of |
| | the Parent-Identification) |
| Monitors | PI-Monitor-Bad-Index (for the Parent-Identification), CHI-Monitor-Child-Inserts-Left (for the Right- |
| | Child), CHI-Monitor-Child-Inserts-Right (for the Left-Child), PI-Monitor-Inserts-Child (for the Parent- |
| | Identification). |
| | Case 3 |
| Occurrence | The Lock-Mode (input (4)) is false and the Cursor is on the boundary of the Proxy |
| Deviated | Steps 1-3: Are the same as in the Generic Behaviour. |
| Behaviour | Steps 4 + 5: Do not Happen |
| | Step 6a: If there is more than one Cursor, then it is the same as in the Generic Behaviour with the |
| | added behaviour of updating the Proxy-Rightmost-Cursor-Handle (3640 of FIG. 5) of the Current- |
| | Proxy to reference the Old-Left-Cursor or Proxy-Leftmost-Cursor-Handle (3630 of FIG. 5) of the |
| | Current-Proxy to reference the Old-Right-Cursor depending on the Action-Trilarity (input (3)). |
| | Step 6b: If there is only one Cursor in the Proxy, then update the Child-Proxy-Handle (3430 of FIG. |
| | 4) of the New-Child to reference the Current-Proxy and the Child-Proxy-Handle of the Current-Child |
| | to reference No-Proxy. Update the Proxy-Child-Handle (3610 of FIG. 5) of the Current-Proxy to |
| | reference the New-Child. Check for CHI-Monitor-No-Cursor-Identification for the Current-Child. |
| | Step 6: Check for the CHI-Monitor-Cursor-Identification-Shifted-Off-Child for the Current-Child. |
| | Step 7: Is the same as in the Generic Behaviour. |
| Fields Altered | Parent-Handle-Starboard (of the New-Child), Left-Index (of the New-Child), Index-Integrity (of the |
| | Parent-Identification), Right-Child-Handle and the Left-Child-Handle (of the New-Child), Left-Child- |
| | Handle (of the Right-Child) and the Right-Child-Handle of the (Left-Child), Number-Of-Children (of |
| | the Parent-Identification), Proxy-Rightmost-Cursor-Handle or Proxy-Leftmost-Cursor-Handle (of the |
| | Current-Proxy), Child-Proxy-Handle (of the New-Child), [Proxy-Child-Handle (of the new Proxy- |
| | Identification), Proxy-Handle (of the new Proxy-Identification), Proxy-Leftmost-Cursor-Handle and |
| | the Proxy-Rightmost-Cursor-Handle (of the new Proxy-Identification), Proxy-Size (of the new Proxy- |
| | Identification)] or [Child-Proxy-Handle (of the Current-Child), Proxy-Child-Handle (of the Current- |
| | Proxy)]. |
| Monitors | PI-Monitor-Bad-Index (for the Parent-Identification), CHI-Monitor-Child-Inserts-Left (for the Right- |
| | Child), CHI-Monitor-Child-Inserts-Right (for the Left-Child), PI-Monitor-Inserts-Child (for the Parent- |
| | Identification), CHI-Monitor-Cursor-Identification-Shifted-Off-Child (for the Current-Child), CHI- |
| | Monitor-No-Cursor-Identification (for the Current-Child). |
| | Case 4 |
| Occurrence | The Lock-Mode (input (4)) is false and the Cursor is moving to or from the boundary of the Parent |
| Deviated | Steps 1-3: Are the same as in the Generic Behaviour. |
| Behaviour | Step 4: If the Cursor is moving from the boundary: |
| | Step 4a: If the Action-Trilarity (input (3)) is Left: Update the Left-Cursor-Handle (3830 of FIG. 6) of |
| | the Old-Right-Cursor to reference No-Child. Update the Leftmost-Cursor-Handle (3210 of FIG. 3) to |
| | reference the Old-Right-Cursor and check for PI-Monitor-Cursor-Leftmost for the Parent- |
| | Identification. |
| | Step 4b: If the Action-Trilarity (input (3)) is Right: Update the Right-Cursor-Handle (3840 of FIG. 6) |
| | of the Old-Left-Cursor to reference Cursor-Terminator. Update the Rightmost-Cursor-Handle (3220 |
| | of FIG. 3) to reference the Old-Left-Cursor and check for PI-Monitor-Cursor-Rightmost for the |
| | Parent-Identification. |
| | Step 5: If the Cursor is moving to the boundary: |
| | Step 5a: If the Action-Trilarity (input (3)) is Left: Locate the New-Right-Cursor found through the |
| | Proxy-Leftmost-Cursor-Handle (3630 of FIG. 5) of the Current-Proxy. Update the Left-Cursor- |
| | Handle (3830 of FIG. 6) of the New-Right-Cursor and the Right-Cursor-Handle (3840 of FIG. 6) of |
| | the Cursor-Identification (input (1)) to reference each other. Update the Left-Cursor-Handle of the |
| | Cursor-Identification (input (1)) to reference Cursor-Terminator. Update the Leftmost-Cursor-Handle |
| | (3220 of FIG. 3) of the Parent-Identification to reference the Cursor-Identification (input (1)) and |
| | check for PI-Monitor-Cursor-Leftmost for the Parent-Identification. |
| | Step 5b: If the Action-Trilarity (input (3)) is Right: Locate the New-Left-Cursor found through the |
| | Proxy-Rightmost-Cursor-Handle (3640 of FIG. 5) of the Current-Proxy. Update the Right-Cursor- |
| | Handle (3840 of FIG. 6) of the New-Left-Cursor and the Left-Cursor-Handle (3830 of FIG. 6) of the |
| | Cursor-Identification (input (1)) to reference each other. Update the Right-Cursor-Handle of the |
| | Cursor-Identification (input (1)) to reference Cursor-Terminator. Update the Rightmost-Cursor- |
| | Handle (3220 of FIG. 3) of the Parent-Identification to reference the Cursor-Identification (input (1)) |
| | and check for PI-Monitor-Cursor-Rightmost for the Parent-Identification. |
| | Steps 6 and 7: Are the same as the Generic Behaviour. |
| Fields Altered | Parent-Handle-Starboard (of the New-Child), Left-Index (of the New-Child), Index-Integrity (of the |
| | Parent-Identification), Right-Child-Handle and the Left-Child-Handle (of the New-Child), Left-Child- |
| | Handle (of the Right-Child) and the Right-Child-Handle of the (Left-Child), Number-Of-Children (of |
| | the Parent-Identification), Left-Cursor-Handle (of the Old-Right-Cursor) or Right-Cursor-Handle (of |
| | the Old-Left-Cursor), Right-Cursor-Handle and the Left-Cursor-Handle (of the Cursor-Identification |
| | (input (1))), Right-Cursor-Handle (of the New-Left-Cursor) or Left-Cursor-Handle (of the New-Right- |
| | Cursor), Rightmost-Cursor-Handle or Leftmost-Cursor-Handle (for the Parent-Identification), Cursor- |
| | Proxy-Handle (of the Cursor-Identification (input (1))), Child-Proxy-Handle (of the New-Child), Proxy- |
| | Child-Handle (of the new Proxy-Identification), Proxy-Handle (of the new Proxy-Identification), |
| | Proxy-Leftmost-Cursor-Handle and the Proxy-Rightmost-Cursor-Handle (of the new Proxy- |
| | Identification), Proxy-Size (of the new Proxy-Identification). |
| Monitors | PI-Monitor-Bad-Index (for the Parent-Identification), CHI-Monitor-Child-Inserts-Left (for the Right- |
| | Child), CHI-Monitor-Child-Inserts-Right (for the Left-Child), PI-Monitor-Inserts-Child (for the Parent- |
| | Identification), CHI-Monitor-Cursor-Identification-Shifted-Off-Child (for the Current-Child), PI-Monitor- |
| | Cursor-Rightmost or PI-Monitor-Cursor-Leftmost (for the Parent-Identification). |
| | Case 5 |
| Occurrence | The Action-Trilarity (input (3)) is Neutral |
| Deviated | Step 1: Is the same as in the Generic Behaviour. |
| Behaviour | Step 2: Copy the Left-Index (4220 of FIG. 8) found in the Child-Identification-Content (3445 of FIG. |
| | 4 and 4200 of FIG. 8) of the Child identified by the Cursor to the Left-Index of the New-Child. |
| | Step 3: Is the same as in the Generic Behaviour. |
| | Steps 4 + 5: Do not happen. |
| | Step 6: Update the Child-Proxy-Handle (3430 of FIG. 4) of the New-Child to reference the Current- |
| | Proxy and the Child-Proxy-Handle of the Current-Child to reference No-Child. Update the Proxy- |
| | Child-Handle (3610 of FIG. 5) of the Current-Proxy to reference the New-Child. Check for the CHI- |
| | Monitor-Cursor-Identification-Shifted-Off-Child and CHI-Monitor-No-Cursor-Identification for the |
| | Current-Child. Check for the PI-Monitor-Deletes-Child for the Parent-Identification. |
| | Step 7: Is the same as in the Generic Behaviour. |
| Fields Altered | Parent-Handle-Starboard (of the New-Child), Left-Index (of the New-Child, Right-Child-Handle and |
| | the Left-Child-Handle (of the New-Child), Left-Child-Handle (of the Right-Child) and the Right-Child- |
| | Handle of the (Left-Child), Number-Of-Children (of the Parent-Identification), Child-Proxy-Handle (of |
| | the New-Child), Child-Proxy-Handle (of the Current-Child), Proxy-Child-Handle (Current-Proxy) |
| Monitors | CHI-Monitor-Child-Inserts-Left (for the Right-Child), CHI-Monitor-Child-Inserts-Right (for the Left- |
| | Child), PI-Monitor-Inserts-Child and PI-Monitor-Deletes-Child (for the Parent-Identification), CHI- |
| | Monitor-Cursor-Identification-Shifted-Off-Child (for the Current-Child), CHI-Monitor-No-Cursor- |
| | Identification (for the Current-Child). |
| | Case 6 |
| Occurrence | The New-Child is inserted on the Boundary |
| Deviated | Steps 1 + 2: Are the same as in the Generic Behaviour. |
| Behaviour | Step 3a: If the Action-Trilarity (input (3)) is Left: Update the Right-Child-Handle (3420 of FIG. 4) of |
| | the New-Child to reference the Right-Child and the Left-Child-Handle (3410 of FIG. 4) of the New- |
| | Child to reference No-Child. Update the Left-Child-Handle of the Right-Child to reference the New- |
| | Child. Update the Leftmost-Child-Handle (3230 of FIG. 3) for the Parent-Identification. Check for |
| | the CHI-Monitor-Child-Inserts-Left and CHI-Monitor-Child-Links-Left for the Right-Child, PI-Monitor- |
| | Child-Leftmost for the Parent-Identification. |
| | Step 3b: If the Action-Trilarity (input (3)) is Right: Update the Left-Child-Handle (3410 of FIG. 4) of |
| | the New-Child to reference the Left-Child and the Right-Child-Handle (3420 of FIG. 4) of the New- |
| | Child to reference No-Child. Update the Right-Child-Handle of the Left-Child to reference the New- |
| | Child. Update the Rightmost-Child-Handle (3240 of FIG. 3) for the Parent-Identification. Check for |
| | the CHI-Monitor-Child-Inserts-Right and CHI-Monitor-Child-Links-Right for the Right-Child, PI- |
| | Monitor-Child-Rightmost for the Parent-Identification. |
| | Step 3: Increase the Number-Of-Children (4410 of FIG. 9) found in the Parent-Identification-Content |
| | (3225 of FIG. 3 and 4400 of FIG. 9) of the Parent-Identification. Check for PI-Monitor-Inserts-Child |
| | for the Parent-Identification. |
| | Steps 4-7: Are the same as in the Generic Behaviour. |
| Fields Altered | Parent-Handle-Starboard (of the New-Child), Left-Index (of the New-Child), Index-Integrity (of the |
| | Parent-Identification), Right-Child-Handle and the Left-Child-Handle (of the New-Child), Left-Child- |
| | Handle (of the Right-Child) or the Right-Child-Handle of the (Left-Child), Leftmost-Cursor-Handle or |
| | the Rightmost-Cursor-Handle (of the Parent-Identification), Number-Of-Children (of the Parent- |
| | Identification), Left-Cursor-Handle (of the Old-Right-Cursor), Right-Cursor-Handle (of the Old-Left- |
| | Cursor), Right-Cursor-Handle and the Left-Cursor-Handle (of the Cursor-Identification (input (1))), |
| | Right-Cursor-Handle (of the New-Left-Cursor), Left-Cursor-Handle (of the New-Right-Cursor), |
| | Cursor-Proxy-Handle (of the Cursor-Identification (input (1))), Child-Proxy-Handle (of the New- |
| | Child), Proxy-Child-Handle (of the new Proxy-Identification), Proxy-Handle (of the new Proxy- |
| | Identification), Proxy-Leftmost-Cursor-Handle and the Proxy-Rightmost-Cursor-Handle (of the new |
| | Proxy-Identification), Proxy-Size (of the new Proxy-Identification). |
| Monitors | PI-Monitor-Bad-Index (for the Parent-Identification), [CHI-Monitor-Child-Inserts-Left and CHI- |
| | Monitor-Child-Links-Left (for the Right-Child), PI-Monitor-Child-Leftmost for the Parent-Identification)] |
| | or [CHI-Monitor-Child-Inserts-Right and CHI-Monitor-Child-Links-Right (for the Left-Child), PI- |
| | Monitor-Child-Rightmost for the Parent-Identification)], PI-Monitor-Inserts-Child (for the Parent- |
| | Identification), CHI-Monitor-Cursor-Identification-Shifted-Off-Child (for the Current-Child). |

KI-New-Child

| | |
|---|---|
| Inputs | (1) The Cursor-Identification (3030 of FIG. 2 and 3800 of FIG. 6) that identifies the destination |
| | location for this insert (2) Action-Trilarity (3) Lock-Mode (4) A Type (4480 of FIG. 9) for the newly |
| | created Manabars-Set (3000 of FIG. 2) to be inserted into the 1^{st} parameter. |
| Outputs | The newly created Cursor-Identification. |
| References set up | None |
| at the start | |
| Generic Behaviour | This method functionally creates a new Manabars-Set (3000 of FIG. 2) and inserts it into another |
| | Manabars-Set. |
| | Step 1: Create a new Parent-Identification (3040 of FIG. 2 and 3200 of FIG. 3), a new Cursor- |
| | Identification (3030 of FIG. 2 and 3800 of FIG. 6), and a new Proxy-Identification (3010 of FIG. 2 |
| | and 3600 of FIG. 5). |
| | Step 2: Update the following fields for the new Parent-Identification (3200 of FIG. 3): Leftmost- |
| | Cursor-Handle (3210 of FIG. 3) and Rightmost-Cursor-Handle (3220 of FIG. 3) to reference new |
| | Cursor-Identification, Leftmost-Child-Handle (3230 of FIG. 3) and Rightmost-Child-Handle (3240 of |
| | FIG. 3) to reference No-Child. Update the following fields for the Parent-Identification-Content (3225 |
| | of FIG. 3 and 4400 of FIG. 9): Number-Of-Children (4410 of FIG. 9) to equal 0, Number-Of-Cursors |
| | (4420 of FIG. 9) to equal 0, Index-Integrity (4430 of FIG. 9) to equal true, Reset-Index (4500 of FIG. |
| | 9) to equal true, PI-Monitor-Event (4490 of FIG. 9) to reference No-Monitor-Event, Whole (4440 of |
| | FIG. 9), Float (4450 of FIG. 9), Fast-ABS-Handle (4460 of FIG. 9) and Slow-ABS-Handle (4470 of |
| | FIG. 9) to equal 0, Type (4480 of FIG. 9) to equal input (4). |
| | Step 3: Update the following fields for the new Cursor-Identification (3800 of FIG. 6): Cursor-Proxy- |
| | Handle (3810 of FIG. 6) to reference new Proxy-Identification, Parent-Handle-Port (3820 of FIG. 6) |
| | to reference new Parent-Identification (3200 of FIG. 3), Left-Cursor-Handle (3830 of FIG. 6) and |
| | Right-Cursor-Handle (3840 of FIG. 6) to reference Cursor-Terminator. Update the CUI-Monitor- |
| | Event (4010 of FIG. 7) found in the Cursor-Identification-Content (3890 of FIG. 6 and 4000 of FIG. 7) |
| | to reference No-Monitor-Event. |
| | Step 4: Update the following fields for the new Proxy-Identification (3600 of FIG. 5): Proxy-Child- |
| | Handle (3610 of FIG. 5) to reference No-Child, Proxy-Handle (3620 of FIG. 5) to reference No- |
| | Proxy, Proxy-Leftmost-Cursor-Handle (3630 of FIG. 5) and Proxy-Rightmost-Cursor-Handle (3640 of |
| | FIG. 5) to reference new Cursor-Identification (3800 of FIG. 6), Proxy-Size (4030 of FIG. 7) found in |
| | the Proxy-Identification-Content (3615 of FIG. 5 and 4020 of FIG. 7) to equal 1. |
| | Step 5: Do everything exactly the same as insert (including allowing for all cases) using the newly |
| | created Cursor-Identification (3800 of FIG. 6) as the Source-Child to be inserted into input (1). |
| | If the Action-Trilarity (input (2)) is Neutral, then the newly created Manabars-Set (3000 of FIG. 2) |
| | replaces the Manabars-Set pointed to by the Cursor of the destination location from parameter (1). |
| Fields Altered | Parent-Identification (New): Number-Of-Children, Number-Of-Cursors, Index-Integrity, PI-Monitor- |
| | Event, Leftmost-Cursor-Handle, Rightmost-Cursor-Handle, Leftmost-Child-Handle, Rightmost-Child- |
| | Handle, Whole, Float, Fast-ABS-Handle, Slow-ABS-Handle, and Type. |
| | Cursor-Identification (New): Cursor-Proxy-Handle, Parent-Handle-Port, Left-Cursor-Handle, Right- |
| | Cursor-Handle, CUI-Monitor-Event, and Child-Handle. |
| | Proxy-Identification (New): Proxy-Child-Handle, Proxy-Handle, Proxy-Leftmost-Cursor-Handle, |
| | Proxy-Rightmost-Cursor-Handle, and Proxy-Size. |
| Monitors | All monitors that are in the insert method |

KI-Remove-Monitor

| | |
|---|---|
| Inputs | (1) The Cursor-Identification (3030 of FIG. 2 and 3800 |
| | of FIG. 6) created by the KI-Add-Monitor |
| | method call as the Key to locate the Monitor-Event inside |
| | the Indexing-Mechanism. |
| Outputs | None |
| References | None |
| set up | |
| at the start | |
| Generic | This Method deletes a Monitor from a Monitor-Event. |
| Behaviour | Step 1: Retrieve the Cursor-Identification inside the |
| | Indexing-Mechanism utilising the Key (input |
| | (1)). This Cursor-Identification is a spawned Cursor of |
| | the Monitor-Event that is currently pointing to the |
| | Monitor to be deleted. |
| | Step 2: Delete the Monitor from the Monitor-Event using |
| | the retrieved spawned Monitor-Event. |
| | Remove the spawned Cursor of the Monitor-Event from |
| | the Indexing-Mechanism so that it cannot be used to |
| | delete other Monitors. |
| Fields Altered | None |
| Monitors | None |

KI-Reset

| | |
|---|---|
| Inputs | None |
| Outputs | None |
| References set up | None |
| at the start | |
| Generic Behaviour | Resets the Kernel-Image (480 of FIG. 3, 2600 |
| | of FIG. 14) to an empty state where there is only |
| | one Manabars-Set of Type Type-Powerset accessible |
| | via Get-Powerset KI-Interface method. |
| Fields Altered | None |
| Monitors | None |

KI-Set-Fast-ABS-Handle

| | |
|---|---|
| Inputs | (1) Cursor-Identification (3030 of FIG. 2 and 3800 of |
| | FIG. 6) that identifies the Parent-Identification (3040 of |
| | FIG. 2 and 3200 of FIG. 3) to undergo the |
| | Fast-ABS-Handle (4460 of FIG. 9) replacement. |
| | (2) The Fast-ABS-Handle. |
| Outputs | None |
| References | Parent-Identification: Found through the |
| set up at the | Parent-Handle-Port (3820 of FIG. 6) of the Cursor- |
| start | Identification (input 1). |
| Generic | This method sets the Fast-ABS-Handle (4460 of |
| Behaviour | FIG. 9) of input (1). |
| | Step 1: Locate and set the Fast-ABS-Handle (4460 of |
| | FIG. 9), found within the Parent-Identification- |
| | Content (3040 of FIG. 2 and 3200 of FIG. 3) of the |
| | Parent-Identification, to equal input (2). Check |
| | for PI-Monitor-Fast-ABS-Changed. |
| Fields Altered | Fast-ABS-Handle (of the Parent-Identification) |
| Monitors | PI-Monitor-Fast-ABS-Changed (for the Parent- |
| | Identification) |

KI-Set-Float

| | |
|---|---|
| Inputs | (1) Cursor-Identification (3030 of FIG. 2 and 3800 of |
| | FIG. 6) that identifies the Parent-Identification |
| | (3040 of FIG. 2 and 3200 of FIG. 3) to undergo the Float |
| | (4450 of FIG. 9) replacement. |
| | (2) Value to be set. |
| Outputs | None |
| References | Parent-Identification: Found through the |
| set up at | Parent-Handle-Port (3820 of FIG. 6) of the |
| the start | Cursor-Identification (input 1). |
| Generic | This method sets the Float found within the Content of |
| Behaviour | input (1). |
| | Step 1: Locate and set the Float (4450 of FIG. 9), found |
| | within the Parent-Identification-Content |
| | (3225 of FIG. 3 and 4400 of FIG. 9) of the Parent- |
| | Identification to equal input (2). Check for the PI- |
| | Monitor-Float-Changed for the Parent-Identification. |
| Fields Altered | Float (of the Parent-Identification). |
| Monitors | PI-Monitor-Float-Changed (for the Parent-Identification) |

KI-Set-Governance-Layer

| | |
|---|---|
| Inputs | (1) The Cursor-Identification of the Governance-Layer |
| Outputs | None |
| References set up | None |
| at the start | |
| Generic | This method sets the Governance-Layer reference. |
| Behaviour | |
| Fields Altered | None |
| Monitors | None |

KI-Set-Slow-ABS-Handle

| | |
|---|---|
| Inputs | (1) Cursor-Identification (3030 of FIG. 2 and 3800 of |
| | FIG. 6) that identifies the Parent-Identification |
| | (3040 of FIG. 2 and 3200 of FIG. 3) to undergo the |
| | Slow-ABS-Handle (4470 of FIG. 9) replacement. |
| | (2) Slow-ABS-Handle. |
| Outputs | None |
| References set up | Parent-Identification: Found through the |
| at the start | Parent-Handle-Port (3820 of FIG. 6) of the Cursor- |
| | Identification (input 1). |
| Generic | This method sets the Slow-ABS-Handle found |
| Behaviour | within the Parent-Identification-Content of input (1). |
| | Step 1: Locate and set the Slow-ABS-Handle (4470 |
| | of FIG. 9), found within the Parent- |
| | Identification-Content (3040 of FIG. 2 and 3200 of |
| | FIG. 3) of the Parent-Identification, to equal input |
| | (2). Check for the PI-Monitor-Slow-ABS-Changed for |
| | the Parent-Identification. |
| Fields Altered | Slow-ABS-Handle (of the Parent-Identification) |
| Monitors | PI-Monitor-Slow-ABS-Changed (for the Parent- |
| | Identification) |

KI-Set-Type

| | |
|---|---|
| Inputs | (1) Cursor-Identification (3030 of FIG. 2 and 3800 of |
| | FIG. 6) that identifies the Parent-Identification |
| | (3040 of FIG. 2 and 3200 of FIG. 3) to undergo the |
| | Type (4480 of FIG. 9) replacement. |
| | (2) A 64-Bit-Whole-Number that represents the Type. |
| Outputs | None |
| References | Parent-Identification: Found through the |
| set up at the | Parent-Handle-Port (3820 of FIG. 6) of the Cursor- |
| start | Identification (input 1). |
| Generic | This method sets the Type found within the |
| Behaviour | Parent-Identification-Content of the Parent-Identification. |
| | Step 1: Locate and set the Type (4480 of FIG. 9), found |
| | within the Parent-Identification-Content |
| | (3040 of FIG. 2 and 3200 of FIG. 3) of the |
| | Parent-Identification, to equal input (2). Check for the PI- |
| | Monitor-Type-Changed for the Parent-Identification. |
| Fields Altered | Type (of the Parent-Identification). |
| Monitors | PI-Monitor-Type-Changed (for the Parent-Identification) |

KI-Set-Whole

| | |
|---|---|
| Inputs | (1) Cursor-Identification (3030 of FIG. 2 and 3800 of |
| | FIG. 6) that identifies the Parent-Identification |
| | (3040 of FIG. 2 and 3200 of FIG. 3) to undergo the |
| | Whole (4440 of FIG. 9) replacement. |
| | (2) A 64-Bit-Whole-Number that represents the |
| | Whole. |
| Outputs | None |
| References set up | Parent-Identification: Found through the |
| at the start | Parent-Handle-Port (3820 of FIG. 6) of the Cursor- |
| | Identification (input 1). |
| Generic | This method sets the Whole found within the |
| Behaviour | Parent-Identification-Content of input (1). |
| | Step 1: Locate and set the Whole (4440 of FIG. 9), |
| | found within the Parent-Identification-Content |
| | (3040 of FIG. 2 and 3200 of FIG. 3) of the Parent- |
| | Identification, to equal input (2). Check for the PI- |
| | Monitor-Whole-Changed for the Parent-Identification. |
| Fields Altered | Whole (of the Parent-Identification) |
| Monitors | PI-Monitor-Whole-Changed (for the Parent- |
| | Identification) |

KI-Shift-Cursor

| | |
|---|---|
| Inputs | (1) The Cursor-Identification (3030 of FIG. 2 and 3800 of FIG. 6) for this shift (2) Action-Polarity. |
| Outputs | A Boolean that specifies whether or not the Cursor has shifted. |
| References set up | Parent-Identification: Found through the Parent-Handle-Port (3820 of FIG. 6) of the Cursor- |
| at the start | Identification (input 1). |
| | Current-Proxy: The main Proxy-Identification (3010 of FIG. 2 and 3870 of FIG. 6) found through the |
| | Cursor-Proxy-Handle (3810 of FIG. 6) of input (1). |
| | Current-Child: The Child that the Cursor-Identification (input (1)) is currently pointing to - found |
| | through the Proxy-Child-Handle (3610 of FIG. 5) of the Current-Proxy. |
| | Next-Child: The Child-Identification (3020 of FIG. 2 and 3400 of FIG. 4) that the Cursor- |
| | Identification will be shifted to. Found through the Left-Child-Handle (3410 of FIG. 4) or the Right- |
| | Child-Handle (3420 of FIG. 4) of the Cursor-Identification (input (1)) depending on the Action- |
| | Polarity (input (2)). |
| | Next-Proxy: (Able to be No-Proxy) The Proxy-Identification that the Next-Child references. Found |
| | through the Child-Proxy-Handle (3430 of FIG. 4) of the Next-Child. |
| | Old-Left-Cursor: (Able to be Cursor-Terminator) Found through the Left-Cursor-Handle (3830 of |
| | FIG. 6) of the Cursor-Identification (input (1)). |
| | Old-Right-Cursor: (Able to be Cursor-Terminator) Found through the Right-Cursor-Handle (3840 of |
| | FIG. 6) of the Cursor-Identification (input (1)). |
| Generic Behaviour | Functionally, this method moves the Cursor in the direction indicated by the Action-Polarity (input |
| | (2)). To do this, the integrity of the Linked List of Cursor-Identifications as represented by the Left- |
| | Cursor-Handle and Right-Cursor-Handle needs to be preserved. |
| | Step 1: Update the Left-Cursor-Handle (3830 of FIG. 6) of the Old-Right-Cursor and the Right- |
| | Cursor-Handle (3840 of FIG. 6) of the Old-Left-Cursor to reference each other. |
| | Step 2a: If the Action-Trilarity (input (3)) is Left: Locate the New-Right-Cursor found through the |
| | Proxy-Leftmost-Cursor-Handle (3630 of FIG. 5) of the Current-Proxy. Locate the New-Left-Cursor |
| | through the Left-Cursor-Handle (3830 of FIG. 6) of the New-Right-Cursor. |
| | Step 2b: If the Action-Trilarity (input (3)) is Right: Locate the New-Left-Cursor found through the |
| | Proxy-Rightmost-Cursor-Handle (3640 of FIG. 5) of the Current-Proxy. Locate the New-Right- |
| | Cursor through the Right-Cursor-Handle (3840 of FIG. 6) of the New-Left-Cursor. |
| | Step 2: Update the Right-Cursor-Handle (3840 of FIG. 6) and the Left-Cursor-Handle (3830 of FIG. |
| | 6) of the Cursor-Identification (input (1)) to reference the New-Left-Cursor and the New-Right- |
| | Cursor. Update the Right-Cursor-Handle (3840 of FIG. 6) of the New-Left-Cursor and the Left- |
| | Cursor-Handle (3830 of FIG. 6) of the New-Right-Cursor to reference the Cursor-Identification (input |
| | (1)). |
| | Step 3a: If there is no Next-Proxy create a new Proxy-Identification (3010 of FIG. 2 and 3600 of |
| | FIG. 5) as the Next-Proxy. Update the Proxy-Child-Handle (3610 of FIG. 5) of the Next-Proxy to |
| | reference the Next-Child. Update the Proxy-Handle (3620 of FIG. 5) to point to No-Proxy and the |
| | Proxy-Size (4030 of FIG. 7), found in the Proxy-Identification-Content (3615 of FIG. 5 and 4020 of |
| | FIG. 7) of the Next-Proxy, to equal 0. If the Action-Polarity (input (2)) is Left then update the Proxy- |
| | Leftmost-Cursor-Handle (3630 of FIG. 5) of the Next-Proxy to reference input (1), otherwise update |
| | the Proxy-Rightmost-Cursor-Handle (3640 of FIG. 5) of the Next-Proxy to reference input (1). |
| | Update the Child-Proxy-Handle (3430 of FIG. 4) of the Next-Child to reference the Next-Proxy. |
| | Step 3: Update the Cursor-Proxy-Handle (3810 of FIG. 6) of the Cursor-Identification (input (1)) to |
| | reference the Next-Proxy. Update the Proxy-Leftmost-Cursor-Handle (3630 of FIG. 5) (if the Action- |
| | Polarity (input (2)) is Right) or the Proxy-Rightmost-Cursor-Handle (3640 of FIG. 5) (if the Action- |
| | Polarity (input (2)) is Left) of the Next-Proxy to reference the Cursor-Identification (input (1)). If |
| | either the Proxy-Leftmost-Cursor-Handle or the Proxy-Rightmost-Cursor-Handle of the Next-Proxy is |
| | referencing Cursor-Terminator then also update them to reference the Cursor-Identification (input |
| | (1)). Increase the Proxy-Size (4030 of FIG. 7) found in the Proxy-Identification-Content (3615 of |
| | FIG. 5 and 4020 of FIG. 7) of the Next-Proxy, by 1. Decrease the Proxy-Size found in the Proxy- |
| | Identification-Content of the Current-Proxy by 1. |
| | Step 3b: If the Proxy-Leftmost-Cursor-Handle (3630 of FIG. 5) of the Current-Proxy references the |
| | Cursor-Identification (input (1)) and the Action-Polarity is Right then update the Proxy-Leftmost- |
| | Cursor-Handle of the Current-Proxy to reference the Old-Right-Cursor. |
| | Step 3c: If the Proxy-Rightmost-Cursor-Handle (3640 of FIG. 5) of the Current-Proxy references the |
| | Cursor-Identification (input (1)) and the Action-Polarity is Left then update the Proxy-Rightmost- |
| | Cursor-Handle of the Current-Proxy to reference the Old-Left-Cursor. |
| | Step 4: Check for the CHI-Monitor-Cursor-Identification-Shifted-Off-Child for the Current-Child, CHI- |
| | Monitor-Cursor-Identification-Shifted-Onto-Child for the Next-Child, If the Cursor has been moved to |
| | the leftmost or rightmost Child-Identification (3400 of FIG. 4) in the Parent-Identification (3450 of |
| | FIG. 4 and 3200 of FIG. 3) then check for CUI-Monitor-Cursor-At-Boundary (for input (1)) and CUI- |
| | Monitor-Cursor-At-Leftmost or CUI-Monitor-Cursor-At-Rightmost for input (1). |
| Fields Altered | Left-Cursor-Handle (of the Old-Right-Cursor), Right-Cursor-Handle (of the Old-Left-Cursor), Right- |
| | Cursor-Handle and the Left-Cursor-Handle (of the Cursor-Identification (input (1))), Right-Cursor- |
| | Handle (of the New-Left-Cursor), Left-Cursor-Handle (of the New-Right-Cursor), Cursor-Proxy- |
| | Handle (of the Cursor-Identification (input (1))), Proxy-Leftmost-Cursor-Handle (if the Action-Polarity |
| | (input (2)) is Right) or the Proxy-Rightmost-Cursor-Handle (if the Action-Polarity (input (2)) is Left) (of |
| | the Next-Proxy), Proxy-Size (of the Next-Proxy), Proxy-Size (of the Current-Proxy), Proxy-Leftmost- |
| | Cursor-Handle or Proxy-Rightmost-Cursor-Handle (of the Current-Proxy). |
| Monitors | CHI-Monitor-Cursor-Identification-Shifted-Off-Child (for the Current-Child), CHI-Monitor-Cursor- |
| | Identification-Shifted-Onto-Child (for the Next-Child), CUI-Monitor-Cursor-At-Boundary (for input (1)), |
| | CUI-Monitor-Cursor-At-Leftmost or CUI-Monitor-Cursor-At-Rightmost (for input (1)). |
| | Case 1 |
| Occurrence | The Child-Handle of input (1) is on the Child boundary in the direction of Action-Polarity (input (2)) |
| Deviated | Nothing Happens |
| Behaviour | |
| Fields Altered | None |
| Monitors | None |
| | Case 2 |
| Occurrence | There is only one Cursor in the Main Proxy |
| Deviated | Steps 1 + 2: Do not Happen |
| Behaviour | Step 3a: If there is no Next-Proxy: Update the Child-Proxy-Handle (3430 of FIG. 4) of the Next-Child |
| | to reference the Current-Proxy, update the Proxy-Child-Handle (3500 of FIG. 4 and 3610 of FIG. 5) |
| | of the Current-Proxy to reference the Next-Child. Update the Child-Proxy-Handle (3430 of FIG. 4) of |
| | the Current-Child to reference No-Proxy. |
| | Step 3b: If there is a Next-Proxy: Update the Cursor-Proxy-Handle (3660 of FIG. 5) of the Cursor- |
| | Identification (input (1)) to reference the Next-Proxy. Update the Proxy-Leftmost-Cursor-Handle |
| | (3630 of FIG. 5) (if the Action-Polarity (input (2)) is Right) or the Proxy-Rightmost-Cursor-Handle |
| | (3640 of FIG. 5) (if the Action-Polarity (input (2)) is Left) of the Next-Proxy to reference the Cursor- |
| | Identification (input (1)). Increase the Proxy-Size (4030 of FIG. 7) found in the Proxy-Identification- |
| | Content (3615 of FIG. 5 and 4020 of FIG. 7) of the Next-Proxy, by 1. Update the Proxy-Leftmost- |
| | Cursor-Handle (3630 of FIG. 5) and the Proxy-RightmostCursor (3640 of FIG. 5) to reference |
| | Cursor-Terminator and decrease the Proxy-Size (4030 of FIG. 7) of the Current-Proxy by 1. |
| | Step 3: Check for CHI-Monitor-No-Cursor-Identification for the Current-Child. |
| | Step 4: Is the same as in Generic Behaviour. |
| Fields Altered | [Child-Proxy-Handle (of the Next-Child), Proxy-Child-Handle (of the Current-Proxy)] or [Cursor- |
| | Proxy-Handle (of the Cursor-Identification (input (1))), Proxy-Leftmost-Cursor-Handle (if the Action- |
| | Polarity (input (2)) is Right) or the Proxy-Rightmost-(if the Action-Polarity (input (2)) is Left) (of the |
| | Next-Proxy), Proxy-Size (of the Next-Proxy)], Child-Proxy-Handle (of the Current-Child). |
| Monitors | CHI-Monitor-Cursor-Identification-Shifted-Off-Child (for the Current-Child), CHI-Monitor-Cursor- |
| | Identification-Shifted-Onto-Child (for the Next-Child), CHI-Monitor-No-Cursor-Identification (for the |
| | Current-Child), CUI-Monitor-Cursor-At-Boundary (for input (1)), CUI-Monitor-Cursor-At-Leftmost or |
| | CUI-Monitor-Cursor-At-Rightmost (for input (1)). |
| | Case 3 |
| Occurrence | The Cursor is on the boundary of the Proxy |
| Deviated | Steps 1 + 2: Do not Happen |
| Behaviour | Step 3: Is the same as in the Generic Behaviour with the addition of updating the Proxy-Leftmost- |
| | Cursor-Handle (3630 of FIG. 5) of the Current-Proxy to reference the Old-Right-Cursor if the Action- |
| | Polarity (input (2)) is Left or updating the Proxy-Rightmost-Cursor-Handle (3640 of FIG. 5) of the |
| | Current-Proxy to reference the Old-Left-Cursor if the Action-Polarity (input (2)) is Right |
| | Step 4: Is the same as in the Generic Behaviour. |
| Fields Altered | Cursor-Proxy-Handle (of the Cursor-Identification (input (1))), Proxy-Leftmost-Cursor-Handle (if the |
| | Action-Polarity (input (2)) is Right) or the Proxy-Rightmost-Cursor-Handle (if the Action-Polarity |
| | (input (2)) is Left) (of the Next-Proxy), Proxy-Size (of the Next-Proxy), Proxy-Size (of the Current- |
| | Proxy), Proxy-Leftmost-Cursor-Handle or Proxy-Rightmost-Cursor-Handle (of the Current-Proxy) |
| Monitors | CHI-Monitor-Cursor-Identification-Shifted-Off-Child (for the Current-Child), CHI-Monitor-Cursor- |
| | Identification-Shifted-Onto-Child (for the Next-Child), CHI-Monitor-No-Cursor-Identification (for the |
| | Current-Child), CUI-Monitor-Cursor-At-Boundary (for input (1)), CUI-Monitor-Cursor-At-Leftmost or |
| | CUI-Monitor-Cursor-At-Rightmost (for input (1)). |
| | Case 4 |
| Occurrence | The Cursor is moving to or from the boundary cursor of the Parent |
| Deviated | If the Cursor is moving from the boundary of the Parent-Identification then Step 2 is the same as in |
| Behaviour | the Generic Behaviour otherwise if the Cursor is moving to the boundary of the Parent-Identification |
| | then step 1 is the same as the Generic Behaviour. |
| | Step 1a: If the Action-Polarity is Left: Update the Left-Cursor-Handle (3830 of FIG. 6) of the Old- |
| | Right-Cursor to reference Cursor-Terminator. Update the Leftmost-Cursor-Handle (3210 of FIG. 3) |
| | of the Parent-Identification (3040 of FIG. 2 and 3200 of FIG. 3) to reference the Old-Right-Cursor, |
| | Check for the PI-Monitor-Cursor-Leftmost for the Parent-Identification. |
| | Step 1b: If the Action-Polarity is Right: Update the Right-Cursor-Handle (3840 of FIG. 6) of the Old- |
| | Left-Cursor to reference Cursor-Terminator. Update the Rightmost-Cursor-Handle (3220 of FIG. 3) |
| | of the Parent-Identification (3040 of FIG. 2 and 3200 of FIG. 3) to reference the Old-Left-Cursor, |
| | Check for the PI-Monitor-Cursor-Rightmost for the Parent-Identification. |
| | Step 2a: If the Action-Trilarity (input (3)) is Left: Update the Right-Cursor-Handle (3840 of FIG. 6) of |
| | the Cursor-Identification (input (1)) and the Left-Cursor-Handle (3830 of FIG. 6) of the Proxy- |
| | Leftmost-Cursor-Handle (3630 of FIG. 5) of the Current-Proxy to reference each other. Update the |
| | Left-Cursor-Handle of the Cursor-Identification (input (1)) to reference Cursor-Terminator. Update |
| | the Leftmost-Cursor-Handle (3210 of FIG. 3) of the Parent-Identification (3040 of FIG. 2 and 3200 of |
| | FIG. 3) to reference the Cursor-Identification (input (1)), Check for the PI-Monitor-Cursor-Leftmost |
| | for the Parent-Identification. |
| | Step 2b: If the Action-Trilarity (input (3)) is Right: Update the Left-Cursor-Handle (3830 of FIG. 6) of |
| | the Cursor-Identification (input (1)) and the Right-Cursor-Handle (3840 of FIG. 6) of the Proxy- |
| | Rightmost-Cursor-Handle (3640 of FIG. 5) of the Current-Proxy to reference each other. Update the |
| | Right-Cursor-Handle of the Cursor-Identification (input (1)) to reference Cursor-Terminator. Update |
| | the Rightmost-Cursor-Handle (3220 of FIG. 3) of the Parent-Identification (3040 of FIG. 2 and 3200 |
| | of FIG. 3) to reference the Cursor-Identification (input (1)), Check for the PI-Monitor-Cursor- |
| | Rightmost for the Parent-Identification. |
| | Step 3 + 4: Are the same as in the Generic Behaviour. |
| Fields Altered | Left-Cursor-Handle (of the Old-Right-Cursor) or Right-Cursor-Handle (of the Old-Left-Cursor), Right- |
| | Cursor-Handle and the Left-Cursor-Handle (of the Cursor-Identification (input (1))), Right-Cursor- |
| | Handle (of the Proxy-Rightmost-Cursor-Handle of the Current-Proxy) or Left-Cursor-Handle (of the |
| | Proxy-Leftmost-Cursor-Handle of the Current-Proxy), Rightmost-Cursor-Handle or Leftmost-Cursor- |
| | Handle (of the Parent-Identification), Cursor-Proxy-Handle (of the Cursor-Identification (input (1))), |
| | Proxy-Leftmost-Cursor-Handle (if the Action-Polarity (input (2)) is Right) or the Proxy-Rightmost- |
| | Cursor-Handle (if the Action-Polarity (input (2)) is Left) (of the Next-Proxy), Proxy-Size (of the Next- |
| | Proxy), Proxy-Size (of the Current-Proxy), Proxy-Leftmost-Cursor-Handle or Proxy-Rightmost- |
| | Cursor-Handle (of the Current-Proxy). |
| Monitors | CHI-Monitor-Cursor-Identification-Shifted-Off-Child (for the Current-Child), CHI-Monitor-Cursor- |
| | Identification-Shifted-Onto-Child (for the Next-Child), CUI-Monitor-Cursor-At-Boundary (for input (1)), |
| | CUI-Monitor-Cursor-At-Leftmost or CUI-Monitor-Cursor-At-Rightmost (for input (1)), PI-Monitor- |
| | Cursor-Leftmost or PI-Monitor-Cursor-Rightmost (for the Parent-Identification). |

KI-Shift-Cursor-To-Boundary

| | |
|---|---|
| Inputs | (1) The Cursor-Identification (3030 of FIG. 2 and 3800 of FIG. 6) for this shift (2) Action-Polarity |
| Outputs | None |
| References set up | Parent-Identification: Found through the Parent-Handle-Port (3820 of FIG. 6) of the Cursor- |
| at the start | Identification (input 1). |
| | Current-Proxy: The main Proxy-Identification (3010 of FIG. 2 and 3870 of FIG. 6) found through the |
| | Cursor-Proxy-Handle (3810 of FIG. 6) of input (1). |
| | Current-Child: The Child that the Cursor-Identification (input (1)) is currently pointing to - found |
| | through the Proxy-Child-Handle (3610 of FIG. 5) of the Current-Proxy. |
| | New-Child: The Child-Identification (3020 of FIG. 2 and 3400 of FIG. 4) that the Cursor- |
| | Identification will be shifted to. Found through the Leftmost-Child-Handle (3230 of FIG. 3) or the |
| | Rightmost-Child-Handle (3240 of FIG. 3) of the Parent-Identification depending on the Action- |
| | Polarity (input (2)). |
| | New-Proxy: (Able to be No-Proxy) The Proxy-Identification that the New-Child references. Found |
| | through the Child-Proxy-Handle (3430 of FIG. 4) of the New-Child. |
| | Old-Left-Cursor: (Able to be Cursor-Terminator) Found through the Left-Cursor-Handle (3830 of |
| | FIG. 6) of the Cursor-Identification (input (1)). |
| | Old-Right-Cursor: (Able to be Cursor-Terminator) Found through the Right-Cursor-Handle (3840 of |
| | FIG. 6) of the Cursor-Identification (input (1)). |
| | Leftmost-Child: Found through the Leftmost-Child-Handle (3230 of FIG. 3) of the Parent- |
| | Identification. |
| | Rightmost-Child: Found through the Rightmost-Child-Handle (3240 of FIG. 3) of the Parent- |
| | Identification. |
| Generic Behaviour | Functionally, this method moves the Cursor to the Leftmost or Rightmost location as indicated by the |
| | Action-Polarity. |
| | Step 1: Locate the Left-Cursor-Handle (3830 of FIG. 6) of the Old-Right-Cursor and the Right- |
| | Cursor-Handle (3840 of FIG. 6) of the Old-Left-Cursor and update them to reference each other. |
| | Step 2a: Update the Left-Cursor-Handle (3830 of FIG. 6) of the Leftmost-Cursor-Handle (3210 of |
| | FIG. 3) of the Parent-Identification and the Right-Cursor-Handle (3840 of FIG. 6) of the Cursor- |
| | Identification (input (1)) to reference each other. Update the Left-Cursor-Handle of the Cursor- |
| | Identification (input (1)) to reference Cursor-Terminator. Update Leftmost-Cursor-Handle of the |
| | Parent-Identification to reference Cursor-Identification (input (1)). Check for the PI-Monitor-Cursor- |
| | Leftmost for the Parent-Identification. |
| | Step 2b: Update the Right-Cursor-Handle (3840 of FIG. 6) of the Rightmost-Cursor-Handle (3220 of |
| | FIG. 3) of the Parent-Identification and the Left-Cursor-Handle (3830 of FIG. 6) of the Cursor- |
| | Identification (input (1)) to reference each other. Update the Right-Cursor-Handle of the Cursor- |
| | Identification (input (1)) to reference Cursor-Terminator. Update Rightmost-Cursor-Handle of the |
| | Parent-Identification to reference Cursor-Identification (input (1)). Check for the PI-Monitor-Cursor- |
| | Rightmost for the Parent-Identification. |
| | Step 3a: If there is no New-Proxy create a new Proxy-Identification (3010 of FIG. 2 and 3600 of FIG. |
| | 5) as the New-Proxy. Update the Proxy-Child-Handle (3610 of FIG. 5) of the New-Proxy to |
| | reference the New-Child. Update the Proxy-Handle (3620 of FIG. 5) to point to No-Proxy and the |
| | Proxy-Size (4030 of FIG. 7), found in the Proxy-Identification-Content (3615 of FIG. 5 and 4020 of |
| | FIG. 7) of the New-Proxy, to equal 0. If the Action-Polarity (input (2)) is Left then update the Proxy- |
| | Rightmost-Cursor-Handle (3640 of FIG. 5) of the New-Proxy to reference input (1), otherwise update |
| | the Proxy-Leftmost-Cursor-Handle (3630 of FIG. 5) of the New-Proxy to reference input (1). Update |
| | the Child-Proxy-Handle (3430 of FIG. 4) of the New-Child to reference the New-Proxy. |
| | Step 3: Increase the Proxy-Size (4030 of FIG. 7), found within the Proxy-Identification-Content |
| | (3615 of FIG. 5 and 4020 of FIG. 7) of the New-Proxy, by 1 and decrease the Proxy-Size, found |
| | within the Proxy-Identification-Content of the Current-Proxy, by 1. Update the Cursor-Proxy-Handle |
| | (3810 of FIG. 6) of the Cursor-Identification (input (1)) to reference the New-Proxy. Update the |
| | Proxy-Leftmost-Cursor-Handle (3630 of FIG. 5) (if the Action-Polarity (input (2)) is Left) or the Proxy- |
| | Rightmost-Cursor-Handle (3640 of FIG. 5) (if the Action-Polarity (input (2)) is Right) of the New- |
| | Proxy to reference the Cursor-Identification (input (1)). If either the Proxy-Leftmost-Cursor-Handle |
| | or the Proxy-Rightmost-Cursor-Handle of the Next-Proxy is referencing Cursor-Terminator then also |
| | update them to reference the Cursor-Identification (input (1)). If the Proxy-Rightmost-Cursor-Handle |
| | (3640 of FIG. 5) of the Current-Proxy is the same as the Cursor-Identification (input (1)) then update |
| | the Proxy-Rightmost-Cursor-Handle to reference the Old-Left-Cursor. Otherwise if the Proxy- |
| | Leftmost-Cursor-Handle (3630 of FIG. 5) of the Current-Proxy is the same as the Cursor- |
| | Identification (input (1)) then update the Proxy-Leftmost-Cursor-Handle to reference the Old-Right- |
| | Cursor. |
| | Step 4: Check for the CHI-Monitor-Cursor-Identification-Shifted-Off-Child for the Current-Child, CHI- |
| | Monitor-Cursor-Identification-Shifted-Onto-Child for the New-Child. Lastly check for the CUI- |
| | Monitor-Cursor-At-Boundary and the CUI-Monitor-Cursor-At-Leftmost or CUI-Monitor-Cursor-At- |
| | Rightmost for input (1). |
| Fields Altered | Left-Cursor-Handle (of the Old-Right-Cursor), Right-Cursor-Handle (of the Old-Left-Cursor), [Left- |
| | Cursor-Handle (of the Leftmost-Cursor-Identification of the Parent-Identification), Leftmost-Cursor- |
| | Handle (of the Parent-Identification)] or [Right-Cursor-Handle (of the Rightmost-Cursor-Identification |
| | of the Parent-Identification), Rightmost-Cursor-Handle (of the Parent-Identification)], Left-Cursor- |
| | Handle and Right-Cursor-Handle (of the Cursor-Identification (input (1))), Proxy-Child-Handle (of the |
| | New-Proxy), Child-Proxy-Handle (of the Leftmost-Child or the Rightmost-Proxy - depending on |
| | Action-polarity (input (2))), Proxy-Size (of the New-Proxy), Proxy-Size (of the Current-Proxy), Cursor- |
| | Proxy-Handle (of the Cursor-Identification (input (1))), |
| | Proxy-Leftmost-Cursor-Handle or Proxy-Rightmost-Cursor-Handle (of the New-Proxy), Proxy- |
| | Leftmost-Cursor-Handle or Proxy-Rightmost-Cursor-Handle (of the Current-Proxy). |
| Monitors | PI-Monitor-Cursor-Leftmost or PI-Monitor-Cursor-Rightmost (for the Parent-Identification), CHI- |
| | Monitor-Cursor-Identification-Shifted-Off-Child for the Current-Child, CHI-Monitor-Cursor- |
| | Identification-Shifted-Onto-Child for the New-Child, CUI-Monitor-Cursor-At-Boundary, CUI-Monitor- |
| | Cursor-At-Leftmost or CUI-Monitor-Cursor-At-Rightmost for input (1). |
| | Case 1 |
| Occurrence | The Cursor is already on the Boundary Child |
| Deviated | Nothing happens |
| Behaviour | |
| Fields Altered | None |
| Monitors | None |
| | Case 2 |
| Occurrence | The Cursor is the boundary Cursor in the direction of the Action-Polarity (input (1) |
| Deviated | Steps 1 + 2: Do not occur |
| Behaviour | Steps 3 + 4: Are the same as in Generic Behaviour. |
| Fields Altered | Proxy-Child-Handle (of the New-Proxy), Child-Proxy-Handle (of the Leftmost-Child or the Rightmost- |
| | Proxy - depending on Action-polarity (input (2))), Proxy-Size (of the New-Proxy), Proxy-Size (of the |
| | Current-Proxy), Cursor-Proxy-Handle (of the Cursor-Identification (input (1))), |
| | Proxy-Leftmost-Cursor-Handle or Proxy-Rightmost-Cursor-Handle (of the New-Proxy), Proxy- |
| | Leftmost-Cursor-Handle or Proxy-Rightmost-Cursor-Handle (of the Current-Proxy). |
| Monitors | CHI-Monitor-Cursor-Identification-Shifted-Off-Child for the Current-Child, CHI-Monitor-Cursor- |
| | Identification-Shifted-Onto-Child for the New-Child, CUI-Monitor-Cursor-At-Boundary, CUI-Monitor- |
| | Cursor-At-Leftmost or CUI-Monitor-Cursor-At-Rightmost for input (1). |
| | Case 3 |
| Occurrence | There is only one Cursor in the Current-Proxy |
| Deviated | Steps 1 + 2: Are the same as in Generic Behaviour. |
| Behaviour | Step 3a: If there is no New-Proxy update the Child-Proxy-Handle (3430 of FIG. 4) of the New-Child |
| | to reference the Current-Proxy, update the Proxy-Child-Handle (3610 of FIG. 5) of the Current-Proxy |
| | to reference the New-Child. Update the Child-Proxy-Handle (3430 of FIG. 4) of the Current-Child to |
| | reference No-Proxy. |
| | Step 3b: Increase the Proxy-Size (4030 of FIG. 7), found within the Proxy-Identification-Content |
| | (3615 of FIG. 5 and 4020 of FIG. 7) of the New-Proxy, by 1. Update the Cursor-Proxy-Handle (3810 |
| | of FIG. 6) of the Cursor-Identification (input (1)) to reference the New-Proxy. Update the Proxy- |
| | Leftmost-Cursor-Handle (3630 of FIG. 5) (if the Action-Polarity (input (2)) is Left) or the Proxy- |
| | Rightmost-Cursor-Handle (3640 of FIG. 5) (if the Action-Polarity (input (2)) is Right) of the New- |
| | Proxy to reference the Cursor-Identification (input (1)). Update the Proxy-Leftmost-Cursor-Handle |
| | (3630 of FIG. 5) and the Proxy-Rightmost-Cursor (3640 of FIG. 5) to reference Cursor-Terminator |
| | and decrease the Proxy-Size (4030 of FIG. 7) of the Current-Proxy by 1. |
| | Step 4: Check for the CHI-Monitor-No-Cursor-Identification for the Current-Child, CHI-Monitor- |
| | Cursor-Identification-Shifted-Off-Child for the Current-Child, and CHI-Monitor-Cursor-Identification- |
| | Shifted-Onto-Child for the New-Child. Lastly check for the CUI-Monitor-Cursor-At-Boundary and the |
| | CUI-Monitor-Cursor-At-Leftmost or CUI-Monitor-Cursor-At-Rightmost for input (1). |
| Fields Altered | Left-Cursor-Handle (of the Old-Right-Cursor), Right-Cursor-Handle (of the Old-Left-Cursor), [Left- |
| | Cursor-Handle (of the Leftmost-Cursor-Identification of the Parent-Identification), Leftmost-Cursor- |
| | Handle (of the Parent-Identification)] or [Right-Cursor-Handle (of the Rightmost-Cursor-Identification |
| | of the Parent-Identification), Rightmost-Cursor-Handle (of the Parent-Identification)], Left-Cursor- |
| | Handle and Right-Cursor-Handle (of the Cursor-Identification (input (1))), |
| | [Child-Proxy-Handle (f the New-Child), Proxy-Child-Handle (of the Current-Proxy)] or [Proxy-Size (of |
| | the New-Proxy), Cursor-Proxy-Handle (of the Cursor-Identification (input (1))), Proxy-Leftmost- |
| | Cursor-Handle or Proxy-Rightmost-Cursor-Handle (of the New-Proxy)], Child-Proxy-Handle of the |
| | Current-Child. |
| Monitors | PI-Monitor-Cursor-Leftmost or PI-Monitor-Cursor-Rightmost (for the Parent-Identification), CHI- |
| | Monitor-No-Cursor-Identification (for the Current-Child), CHI-Monitor-Cursor-Identification-Shifted- |
| | Off-Child for the Current-Child, CHI-Monitor-Cursor-Identification-Shifted-Onto-Child for the New- |
| | Child, CUI-Monitor-Cursor-At-Boundary, CUI-Monitor-Cursor-At-Leftmost or CUI-Monitor-Cursor-At- |
| | Rightmost for input (1). |

KI-Spawn-Cursor-Identification

| | |
|---|---|
| Inputs | (1) Cursor-Identification (3030 of FIG. 2 and 3800 of FIG. 6) that is the template for the newly |
| | spawned Cursor-Identification. |
| Outputs | (1) The handle of the newly formed Cursor-Identification |
| References set up | Parent-Identification: Found through the Parent-Handle-Port (3820 of FIG. 6) of the Cursor- |
| at the start | Identification (input 1). |
| | Current-Proxy: The main Proxy-Identification (3010 of FIG. 2 and 3870 of FIG. 6) found through the |
| | Cursor-Proxy-Handle (3810 of FIG. 6) of input (1). |
| | Current-Child: The Child that the Cursor-Identification (input (1)) is currently pointing to - found |
| | through the Proxy-Child-Handle (3610 of FIG. 5) of the Current-Proxy. |
| | New-Cursor: Will be set in Step 1. |
| | Right-Cursor: (Able to be Cursor-Terminator) Found through the Right-Cursor-Handle (3840 of |
| | FIG. 6) of the Cursor-Identification (input (1)). |
| Generic Behaviour | This method creates a new Cursor based on the Cursor-Identification of input (1) and places it to the |
| | right of input (1). |
| | Step 1: Create a new Cursor-Identification (3030 of FIG. 2 and 3800 of FIG. 6) for the New-Cursor |
| | and copy the Cursor-Proxy-Handle (3810 of FIG. 6) and Parent-Handle-Port (3820 of FIG. 6), |
| | references of the Cursor-Identification (input (1)). Increase the Number-Of-Cursors (4420 of FIG. 9), |
| | found through the Parent-Identification-Content (3225 of FIG. 3 and 4400 of FIG. 9) of the Parent- |
| | Identification, by 1. Update the CUI-Monitor-Event (4010 of FIG. 7), found through the Cursor- |
| | Identification-Content (3890 of FIG. 6 and 4000 of FIG. 7) of the New-Cursor to reference No- |
| | Monitor-Event. Update the Right-Cursor-Handle (3840 of FIG. 6) of the Cursor-Identification (input |
| | (1)) and the Left-Cursor-Handle (3830 of FIG. 6) of the New-Cursor to reference each other. |
| | Step 2: Update the Right-Cursor-Handle (3840 of FIG. 6) of the New-Cursor and the Left-Cursor- |
| | Handle (3830 of FIG. 6) of the Right-Cursor to reference each other. |
| | Step 3: Increase the Proxy-Size (4030 of FIG. 7), found in the Proxy-Identification-Content (3615 of |
| | FIG. 5 and 4020 of FIG. 7) of the Current-Proxy, by 1. If the Cursor-Identification (input (1)) is the |
| | same as the Proxy-Rightmost-Cursor-Handle (3640 of FIG. 5) of the Current-Proxy then update the |
| | Proxy-Rightmost-Cursor-Handle to reference the New-Cursor. |
| | Step 4: Check for the following monitors: CHI-Monitor-Cursor-Identification-Shifted-Onto-Child for |
| | the Current-Child, PI-Cursor-Identification-Inserted-Into-Parent for the Parent-Identification. |
| Fields Altered | Cursor-Proxy-Handle, Parent-Handle-Port, CUI-Monitor-Event, Right-Cursor-Handle and Left- |
| | Cursor-Handle (of the New-Cursor), Number-Of-Cursors (of the Parent-Identification), Right-Cursor- |
| | Handle (of the Cursor-Identification (input (1))), Left-Cursor-Handle (of the Right-Cursor), Proxy-Size |
| | (of the Current-Proxy) and possibly Proxy-Rightmost-Cursor-Handle (of the Current-Proxy). |
| Monitors | CHI-Monitor-Cursor-Identification-Shifted-Onto-Child (for the Current-Child), PI-Cursor-Identification- |
| | Inserted-Into-Parent (for the Parent-Identification). |
| | Case 1 |
| Occurrence | The Cursor-Identification (input (1)) is the boundary Cursor on the right |
| Deviated | Step 1: Is the same as in the Generic Behaviour |
| Behaviour | Step 2: Update the Right-Cursor-Handle (3840 of FIG. 6) of the New-Cursor to reference Cursor- |
| | Terminator and the Rightmost-Cursor-Handle (3220 of FIG. 3) of the Parent-Identification to |
| | reference the New-Cursor. Check for the PI-Monitor-Cursor-Rightmost for the Parent-Identification. |
| | Steps 3 + 4: Are the same as in the Generic Behaviour |
| Fields Altered | Cursor-Proxy-Handle, Parent-Handle-Port, CUI-Monitor-Event, Right-Cursor-Handle and Left- |
| | Cursor-Handle (of the New-Cursor), Number-Of-Cursors (of the Parent-Identification), Right-Cursor- |
| | Handle (of the Cursor-Identification (input (1))), Rightmost-Cursor-Handle (of the Parent- |
| | Identification), Proxy-Size (of the Current-Proxy) and possibly Proxy-Rightmost-Cursor-Handle (of |
| | the Current-Proxy). |
| Monitors | CHI-Monitor-Cursor-Identification-Shifted-Onto-Child (for the Current-Child), PI-Cursor-Identification- |
| | Inserted-Into-Parent and PI-Monitor-Cursor-Rightmost (for the Parent-Identification). |

### APPENDIX B

Monitors

The parameters of the Monitor reflect the changes made to the Manabars-Set involved. The parameters include such things as:
A Parent, which is a spawned Cursor of the original Cursor-Identification. Some parameters include a Parent before and a Parent after. Both of these Parents are spawned Cursor-Identifications which reflect the state of the original Cursor-Identification before and after the event occurred.
A Child, which is the Cursor-Identification of the Child involved in the KI-Interface call. This Child may be the Child that the original Cursor-Identification is pointing to or the Child to the Right or the Left of the Child that the original Cursor-Identification is pointing to. The Child may also be the Child that was inserted or deleted from the Parent.
A Cursor-Identification, which is the original Cursor-identification.

The original Cursor-Identification is the Cursor-Identification that was involved in the KI-Interface method call that triggered the Monitor.

These parameters are found through the MG-Capture-Instance of the UPT-Monitor-Generator.

Child-Identification-Monitors

| Type | Name | Description | Parameters |
|---|---|---|---|
| 101 | CHI-Monitor-Child-Delete | Event occurs when the Child being monitored is | (1) The Parent. |
| | | deleted from its Parent-Identification. | |
| 102 | CHI-Monitor-Child-Terminate- | Event occurs when the adjacent Child to the | (1) The Parent. |
| | Right | Right of the Child being monitored is deleted so | (2) The adjacent Child to the |
| | | that the Child being monitored now terminates | Child being monitored. |
| | | the linked list at the Right. | |
| 103 | CHI-Monitor-Child-Terminate- | Event occurs when the adjacent Child to the Left | (1) The Parent. |
| | Left | of the Child being monitored is deleted so that | (2) The adjacent Child to the |
| | | this Child now terminates the linked list at the | Child being monitored. |
| | | Left. | |
| 104 | CHI-Monitor-Child-Links-Right | Event occurs when the Child being monitored | (1) The Parent before. |
| | | previously terminated the link list at the Right, | (2) The Parent after. |
| | | but is now linked to another Child-Identification. | (3) The newly inserted Child. |
| 105 | CHI-Monitor-Child-Links-Left | Event occurs when the Child being monitored | (1) The Parent before. |
| | | previously terminated the link list at the Left, but | (2) The Parent after. |
| | | is now linked to another Child-Identification. | (3) The newly inserted Child. |
| 106 | CHI-Monitor-Child-Inserts-Left | Event occurs when a new Child-Identification is | (1) The Parent before. |
| | | bound to the Left adjacent position of the Child | (2) The Parent after. |
| | | being monitored. | (3) The original Left bound |
| | | | Child. |
| | | | (4) The new Left bound |
| | | | Child. |
| 107 | CHI-Monitor-Child-Inserts- | Event occurs when a new Child-Identification is | (1) The Parent before. |
| | Right | bound to the Right adjacent position of the Child | (2) The Parent after. |
| | | being monitored. | (3) The original Right bound |
| | | | Child. |
| | | | (4) The new Right bound |
| | | | Child. |
| 108 | CHI-Monitor-Child-Deletes-Left | Event occurs when a Child-Identification is | (1) The Parent. |
| | | deleted from the Left adjacent position of the | (2) The deleted Child¹. |
| | | Child being monitored. | (3) The new Child in the |
| | | | adjacent position². |
| 109 | CHI-Monitor-Child-Deletes- | Event occurs when a Child-Identification is | (1) The Parent. |
| | Right | deleted from the Right adjacent position of the | (2) The deleted Child³. |
| | | Child being monitored. | (3) The new Child in the |
| | | | adjacent position⁴. |
| 110 | CHI-Monitor-Cursor- | Event occurs when a Cursor-Identification | (1) The Cursor-Identification |
| | Identification-Shifted-Onto- | moves its Cursor to the Child being monitored. | that moved. |
| | Child | The event does not occur during the moving of | |
| | | multiple Cursor-Identifications incurred during | |
| | | the deletion of a Child or insertion in the Neutral | |
| | | position. | |
| 111 | CHI-Monitor-Cursor- | Event occurs when a Cursor-Identification that | (1) The Cursor-Identification |
| | Identification-Shifted-Off-Child | was previously at the Child being monitored no | that moved. |
| | | longer points to that Child. The event does not | |
| | | occur during the moving of multiple Cursor- | |
| | | Identifications incurred during the deletion of a | |
| | | Child or insertion in the Neutral position. | |
| 112 | CHI-Monitor-No-Cursor- | Event occurs when previously there was 1 or | (1) The Cursor-Identification |
| | Identification | more Cursors pointing to the Child being | that was last to move. |
| | | monitored and now there is zero. | |
| 113 | CHI-Monitor-Number-Sharing- | Event occurs when the field Proxy-Size has its | (1) The Parent. |
| | Cursor-Identifications-Queried | size attribute queried by an Emulator- | |
| | | Component through the KI-Interface (2810 of | |
| | | FIG. 1) method Get-Number-Sharing-Cursor- | |
| | | Identifications. | |

¹Use Type Type-No-Child if Manabars-Set previously empty.
²Same as above.
³Same as above
⁴Same as above

Parent-Identification-Monitors

| Type | Name | Description | Parameters |
|---|---|---|---|
| 131 | PI-Monitor-Cursor- | Event occurs when a new Cursor-Identification | (1) The newly inserted |
| | Identification-Inserted-Into- | shares the Parent-Identification being | Cursor-Identification. |
| | Parent | monitored. | |
| 132 | PI-Monitor-No-Child | Event occurs when the Parent-Identification | (1) The Parent. |
| | | being monitored previously had 1 or more | (2) The last Child to be |
| | | Children, but now has none. | deleted. |
| 133 | PI-Monitor-Has-Child | Event occurs when the Parent-Identification | (1) The Parent. |
| | | being monitored previously had no Children, but | (2) The newly inserted Child. |
| | | now has 1. | |
| 134 | PI-Monitor-Inserts-Child | Event occurs when a new Child is inserted into | (1) The Parent before. |
| | | the Parent-Identification being monitored. | (2) The Parent after. |
| | | | (3) The newly inserted Child. |
| 135 | PI-Monitor-Deletes-Child | Event occurs when a Child is deleted from the | (1) The Parent. |
| | | Parent-Identification being monitored. | (2) The deleted Child. |
| 136 | PI-Monitor-Bad-Index | Event occurs when the Index-Integrity (4430 of | (1) The Parent. |
| | | FIG. 9) of the Parent-Identification being | |
| | | monitored was previously True, but now is | |
| | | False. | |
| 137 | PI-Monitor-Good-Index | Event occurs when the Index-Integrity (4430 of | (1) The Parent. |
| | | FIG. 9) of the Parent-Identification being | |
| | | monitored was previously False, but now is | |
| | | True. | |
| 138 | PI-Monitor-Cursor-Leftmost | Event occurs when there is a change of Cursor- | (1) New Cursor- |
| | | Identification in the Leftmost Cursor for the | Identification. |
| | | Parent-Identification being monitored. | (2) Old Cursor-Identification. |
| 139 | PI-Monitor-Cursor-Rightmost | Event occurs when there is a change of Cursor- | (1) New Cursor- |
| | | Identification in the Rightmost Cursor for the | Identification. |
| | | Parent-Identification being monitored. | (2) Old Cursor-Identification. |
| 140 | PI-Monitor-Child-Leftmost | Event occurs when there is a change of Child- | (1) The Parent before. |
| | | Identification for the Leftmost Child for the | (2) The Parent after. |
| | | Parent-Identification being monitored. | (3) The new Child⁵. |
| | | | (4) The old Child. |
| 141 | PI-Monitor-Child-Rightmost | Event occurs when there is a change of Child- | (1) The Parent before. |
| | | Identification for the Rightmost Child for the | (2) The Parent after. |
| | | Parent-Identification being monitored. | (3) The new Child⁶. |
| | | | (4) The old Child. |
| 143 | PI-Monitor-Number-Children- | Event occurs when the field Number-of-Children | (1) The Parent. |
| | Queried | is requested by an Emulator-Component through | |
| | | the KI-Interface (2810 of FIG. 1) method Get- | |
| | | Number-Children | |
| 144 | PI-Monitor-Number-of- | Event occurs when the field Number-of-Cursors | (1) The Parent. |
| | Cursors-Queried | is requested by an Emulator-Component through | |
| | | the KI-Interface (2810 of FIG. 1) method Get- | |
| | | Number-Cursors. | |
| 146 | PI-Monitor-Type-Changed | Event occurs when the field Type is utilised by | (1) The Parent. |
| | | an Emulator-Component through the KI-Interface | |
| | | (2810 of FIG. 1) method Set-Type. | |
| 147 | PI-Monitor-Float-Changed | Event occurs when the field Float is utilised by | (1) The Parent. |
| | | an Emulator-Component through the KI-Interface | |
| | | (2810 of FIG. 1) method Set-Float. | |
| 148 | PI-Monitor-Whole-Changed | Event occurs when the field Whole is utilised by | (1) The Parent. |
| | | an Emulator-Component through the KI-Interface | |
| | | (2810 of FIG. 1) method Set-Whole. | |
| 149 | PI-Monitor-Fast-ABS-Changed | Event occurs when the field Fast-ABS-Handle is | (1) The Parent. |
| | | utilised by an Emulator-Component through the | |
| | | KI-Interface (2810 of FIG. 1) method Set-Fast- | |
| | | ABS. | |
| 150 | PI-Monitor-Slow-ABS- | Event occurs when the field Slow-ABS-Handle is | (1) The Parent. |
| | Changed | utilised by an Emulator-Component through the | |
| | | KI-Interface (2810 of FIG. 1) method Set-Slow- | |
| | | ABS. | |

⁵Use Type Type-No-Child if Manabars-Set previously empty.
⁶Use Type Type-No-Child if Manabars-Set previously empty.

Cursor-Identification-Monitors

| Type | Name | Description | Parameters |
|---|---|---|---|
| 163 | CUI-Monitor-Cursor-At- | Event occurs when the Cursor-Identification | (1) The Parent before. |
| | Boundary | being monitored is moved to the Leftmost or | (2) The Parent after. |
| | | Rightmost Child of its Parent-Identification. The | (3) The original Child pointed |
| | | event is not triggered if the Cursor was already | to by the Cursor- |
| | | at the boundary, the boundary Child is deleted | Identification. |
| | | or during the moving of multiple Cursor- | (4) The new Child pointed to |
| | | Identifications incurred during the deletion of a | by the Cursor-Identification. |
| | | Child or insertion in the Neutral position. | |
| 164 | CUI-Monitor-Cursor-At- | Event occurs when the Cursor-Identification | (1) The Parent before. |
| | Leftmost | being monitored is moved to the Leftmost Child | (2) The Parent after. |
| | | of its Parent-Identification. The event is not | (3) The previous Child. |
| | | triggered if the Cursor was already at the | (4) The new Child. |
| | | boundary, the boundary Child is deleted or | |
| | | during the moving of multiple Cursor- | |
| | | Identifications incurred during the deletion of a | |
| | | Child or insertion in the Neutral position. | |
| 165 | CUI-Monitor-Cursor-At- | Event occurs when the Cursor-Identification | (1) The Parent before. |
| | Rightmost | being monitored is moved to the Rightmost Child | (2) The Parent after. |
| | | of its Parent-Identification. The event is not | (3) The previous Child. |
| | | triggered if the Cursor was already at the | (4) The new Child. |
| | | boundary, the boundary Child is deleted or | |
| | | during the moving of multiple Cursor- | |
| | | Identifications incurred during the deletion of a | |
| | | Child or insertion in the Neutral position. | |
| 169 | CUI-Monitor-Cursor-Retrieved | Event occurs when the handle of the Cursor- | (1) The Parent. |
| | | Identification being monitored is requested by an | |
| | | Emulator-Component through the KI-Interface | |
| | | (2810 of FIG. 1). | |
| 170 | CUI-Monitor-Index-Queried | Event occurs when the Cursor-Identification | (1) The Parent. |
| | | being monitored has either the Left-Index (4220 | |
| | | of FIG. 8) or Right-Index queried by an | |
| | | Emulator-Component through the KI-Interface | |
| | | (2810 of FIG. 1) method Get-Index. | |

### APPENDIX C

| | Child-Identification-Monitors |
|---|---|
| 101 | Type-CHI-Monitor-Child-Delete |
| 102 | Type-CHI-Monitor-Child-Terminate-Right |
| 103 | Type-CHI-Monitor-Child-Terminate-Left |
| 104 | Type-CHI-Monitor-Child-Links-Right |
| 105 | Type-CHI-Monitor-Child-Links-Left |
| 106 | Type-CHI-Monitor-Child-Inserts-Left |
| 107 | Type-CHI-Monitor-Child-Inserts-Right |
| 108 | Type-CHI-Monitor-Child-Deletes-Left |
| 109 | Type-CHI-Monitor-Child-Deletes-Right |
| 110 | Type-CHI-Monitor-Cursor-Identification-Shifted-Onto-Child |
| 111 | Type-CHI-Monitor-Cursor-Identification-Shifted-Off-Child |
| 112 | Type-CHI-Monitor-No-Cursor-Identification |
| 113 | Type-CHI-Monitor-Number-Sharing-Cursor- |
| | Identifications-Queried |

| | Parent-Identification-Monitors |
|---|---|
| 131 | Type-PI-Monitor-Cursor-Identification-Inserted-Into-Parent |
| 132 | Type-PI-Monitor-No-Child |
| 133 | Type-PI-Monitor-Has-Child |
| 134 | Type-PI-Monitor-Inserts-Child |
| 135 | Type-PI-Monitor-Deletes-Child |
| 136 | Type-PI-Monitor-Bad-Index |
| 137 | Type-PI-Monitor-Good-Index |
| 138 | Type-PI-Monitor-Cursor-Leftmost |
| 139 | Type-PI-Monitor-Cursor-Rightmost |
| 140 | Type-PI-Monitor-Child-Leftmost |
| 141 | Type-PI-Monitor-Child-Rightmost |
| 143 | Type-PI-Monitor-Number-Children-Queried |
| 144 | Type-PI-Monitor-Number-of-Cursors-Queried |
| 146 | Type-PI-Monitor-Type-Changed |
| 147 | Type-PI-Monitor-Float-Changed |
| 148 | Type-PI-Monitor-Whole-Changed |
| 149 | Type-PI-Monitor-Fast-ABS-Changed |
| 150 | Type-PI-Monitor-Slow-ABS-Changed |

| | Cursor-Identification-Monitors |
|---|---|
| 163 | Type-CUI-Monitor-Cursor-At-Boundary |
| 164 | Type-CUI-Monitor-Cursor-At-Leftmost |
| 165 | Type-CUI-Monitor-Cursor-At-Rightmost |
| 169 | Type-CUI-Monitor-Cursor-Retrieved |
| 170 | Type-CUI-Monitor-Index-Queried |

### APPENDIX D

Conventions in Figures

Real Versus Virtual Entities

[image]

The components in the invention that are constituted directly from the host platform are known as real entities and are represented with rectangles with unbroken lines. Real entities can be either simulated in software or constructed directly in hardware as this represents all design behaviour directly attributable to the implementation platform. All rounded rectangles represent Manabars-Sets that operate as virtual entities.

Expansion

[image]

Some entities require further expansion within a single figure. An equivalent label (Minor 224b) and joining perspective lines are used to highlight the expanded diagram.

Cursor-Identification Reference

[image]

A single Cursor-Identification reference can be represented with an arrow that identifies the Child to which the Cursor points.

Parent-Identification Reference

[image]

A single Parent-Identification reference can be represented with multiple arrows that identify all Cursor-Identifications within the Manabars-Set. The dark arrow represents the Cursor-Identification that was used to identify this Parent-Identification, while white arrows represent other Cursor-Identifications present for the shared Parent-Identification.

Fields and Values

[image]

Some Manabars-Sets are used as Fields that hold Values. In some instances, this Value data may not be present and is equivalent to Null in C. Value data is symbolized with a dashed line, which distinguishes it from the context or Set superstructure.

Ordering

[image]

Children are represented from left to right or from up to down. The resulting order is the same as the symmetry of the Manabars-Set from Left to Right in the above diagrams, both Parent 1 and Parent 2 are symbolically identical.

Masked Detail

[image]

To reduce visual complexity, any item may be left out if it is deemed not to be relevant to the element being represented. The only requirements are that the scope is preserved, but any number of sets may be ignored. If A contains B and B contains C, then visually Parent A may contain Child C, but Parent C cannot contain Child A—not unless C contains something that contains A. In this case, the object explicitly repeats its scope and it is likely to be represented by the Repeated Scope method below.

Repeated Scope

[image]

Lines join the Manabars-Sets where the scope has repeated. These are important for understanding security constraints, as the Manabars-Set only allows for introspective access. A Manabars-Set that re-introduces a distant Parent as a Child converts all the Manabars-Sets between the scopes of the 2 identical repeats into a single security access zone.

Plurality

[image]

Any 3 identical repeating Children represent a list of any number (×N) of identical structures.

Naming

[image]

Label names are joined by dashes so that the object name can be clearly identified in a sentence such as Governance-Layer-Interface. Not all labels are objects, some are phrases that start with a Capital letter, contain no full stop and preserve the capitalization of names. For example—Partner Node—does not use a dash as this is a phrase starting with a capital (Partner), and a capital for a name (Node). When using a name in another name, only the acronym should be used for the referenced name, for example, Governance-Layer-Interface-Instance becomes GLI-Instance. Names retain their capitalization through minor word changes imposed by language such as plurals in Child and Children.

Type Identification

[image]

In some views, the Type information is highlighted at the bottom right of the Manabars-Set.

Interface Connectivity

[image]

Communication occurring across an interface is declared with a box with a dashed line where the name ends is ‘Interface’. The polarity of the interface is indicated with a (+) and (−) depending on the symmetry required. A reversed polarity means that components implement opposite calls on the interface.

We claim:

1. A computational device including a data manipulation and/or storage structure representing a plurality of sets of data storage locations, each set having a parent set identifier and containing a linked list of one or more child storage locations wherein each parent set identifier references a child storage locations in the set, and wherein each child storage location can reference its parent storage location.

2. A computational device as claimed in claim 1 wherein each parent set identifier references a plurality of markers that each reference a single child storage location.

3. A computational device as claimed in claim 1 including an interface that can manipulate data storage locations by means of a marker.

4. A computational device as claimed in claim 2 including an interface that can manipulate data storage locations by means of a marker.

5. A computational device as claimed in claim 1 where each parent set identifier is capable of attaching primitive data structures or files.

6. A computational device as claimed in claim 2 where each parent set identifier is capable of attaching primitive data structures or files.

7. A computational device as claimed in claim 3 where each parent set identifier is capable of attaching primitive data structures or files.

8. A computational device as claimed in claim 4 including an interface that can manipulate data storage locations by means of a marker.

9. A computational device as claimed in claim 3 wherein the data manipulation can trigger events.

10. A computational device as claimed in claim 4 wherein the data manipulation can trigger events.

11. A data structure representing a plurality of sets of data storage locations, each set having a parent set identifier and containing a linked list of one or more child storage locations wherein each parent set identifier references a child storage locations in the set, and wherein each child storage location can reference its parent storage location.

12. A data structure as claimed in claim 11 wherein each parent set identifier references a plurality of markers that each reference a single child storage location.
